(19) United States
(12) Patent Application Publication
(10) Pub. No.: US 2026/0184993 A1
(43) Pub. Date: Jul. 2, 2026

(54) LIQUID CRYSTAL COMPOSITION COMPRISING DIBENZOTHIOPHENE COMPOUND AND USE THEREOF

(71) Applicant: BEIJING BAYI SPACE LCD TECHNOLOGY CO., LTD., Beijing (CN)

(72) Inventors: Chenghe LI, Beijing (CN); Yanran ZHANG, Beijing (CN); Maoxian CHEN, Beijing (CN); Yunpeng GUO, Beijing (CN); Youran LIU, Beijing (CN); Jie REN, Beijing (CN); Yuxing YE, Beijing (CN)

(21) Appl. No.: 19/326,140

(22) Filed: Sep. 11, 2025

Related U.S. Application Data
(63) Continuation of application No. PCT/CN2024/086958, filed on Apr. 10, 2024.

(30) Foreign Application Priority Data
Apr. 21, 2023 (CN) 202310435240.3

(51) Int. Cl. C09K 19/34; C09K 19/12; C09K 19/30

(52) U.S. Cl. CPC C09K 19/3491; C09K 19/12; C09K 19/3003; C09K 2019/122; C09K 2019/123; C09K 2019/3004; C09K 2019/3009; C09K 2019/301; C09K 2019/3016

(57) ABSTRACT

A liquid crystal composition includes at least one or more compounds of general formula I, one or more compounds of general formula II, and one or more compounds of general formula III, wherein in general formula I, R₁ represents an alkyl group having 1-7 carbon atoms or an alkenyl group having 2-7 carbon atoms, and n represents 0, 1 or 2; in general formula II, R₂ and R₃ each independently represent an alkyl group having 1-7 carbon atoms, an alkoxy group having 1-7 carbon atoms or an alkenyl group having 2-7 carbon atoms; and in general formula III, R₄ and R₅ each independently represent an alkyl group having 1-7 carbon atoms, an alkoxy group having 1-7 carbon atoms or an alkenyl group having 2-7 carbon atoms, n represents 1 or 2, and

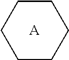

represents one or more of

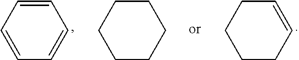

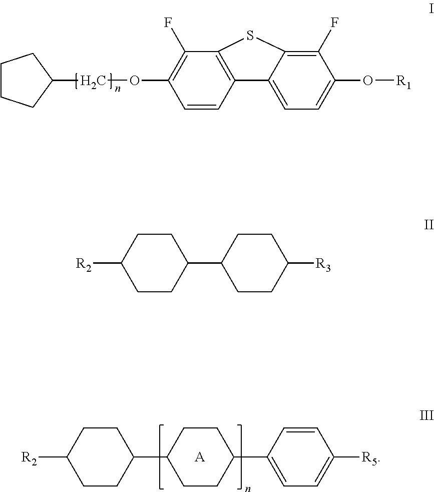

### CROSS-REFERENCES

The present application claims priority to Chinese Patent Application No. 202310435240.3, filed on Apr. 21, 2023 and entitled “LIQUID CRYSTAL COMPOSITION COMPRISING DIBENZOTHIOPHENE COMPOUND AND USE THEREOF”, the entire disclosure of which is incorporated herein by reference in its entirety.

### TECHNICAL FIELD

The present disclosure relates to a liquid crystal material and the application field thereof, and in particular to a liquid crystal composition comprising a dibenzothiophene compound and use thereof.

### BACKGROUND ART

With the advancement of the information age, the development of liquid crystal display technology, as a liquid crystal application field for information display, is also making continuous progress. The growing demand for better performance of liquid crystal displays has spurred research interests in liquid crystal materials, making liquid crystal technology a hot topic and driving its continuous advancement.

Currently, liquid crystal displays are advancing toward larger sizes, wider viewing angles, higher contrast ratios, and faster responses, and the properties of negative liquid crystals play a vital role. Particularly, IPS and FFS mode displays are widely used in mobile phones, laptops, tablet computers, computer monitors, televisions and so on due to their distinctive hard-screen characteristics and exceptionally wide viewing angles.

Due to their unique in-plane liquid crystal alignment, IPS and FFS display modes are prone to light leakage when the display panel is in the dark state, resulting in significantly inferior contrast ratio performance compared to VA-type (MVA, PVA, UV2A and PSVA) displays. Research has revealed that during the initial arrangement of liquid crystal molecules, the alignment defects on the surface of the alignment layer material will lead to disordered arrangement of liquid crystal molecules, resulting in light leakage in the dark state. Therefore, how to improve the disordered arrangement of liquid crystals has become an important topic for improving IPS and FFS mode displays. Research has found that increasing the elastic constant of liquid crystals is helpful to improve the arrangement of liquid crystal molecules.

For IPS and FFS modes, either a positive liquid crystal or a negative liquid crystal can be used. Since negative liquid crystal molecules align perpendicular to the direction of the electric field lines under the action of an electric field, unlike positive liquid crystal molecules which align parallel to the direction of the electric field lines under the action of the electric field, using a negative liquid crystal avoids the problems of transmittance loss and flicker caused by bent electric fields in IPS and FFS modes, thereby improving the transmittance and flicker of the liquid crystal displays.

In the prior art, the contrast ratio of a liquid crystal display is generally increased by increasing the elastic constant of a liquid crystal composition, so as to make the liquid crystal arrangement more orderly and effectively improve the problem of light leakage. Currently, a method for increasing the elastic constant of the liquid crystal composition is to increase the clearing point of the liquid crystal composition. However, a higher clearing point causes an increase in the rotary viscosity of the liquid crystal composition, which in turn leads to a slower response speed of the liquid crystal display.

### SUMMARY OF THE INVENTION

An object of the present disclosure is to provide a liquid crystal composition containing a dibenzothiophene compound, which can overcome the drawbacks of the prior art and enable a liquid crystal display to have not only a significantly improved contrast ratio but also a fast response speed.

The specific technical solutions of the present disclosure are as follows:

The present disclosure firstly provides a liquid crystal composition, comprising at least one or more compounds represented by general formula I, one or more compounds represented by general formula II, and one or more compounds represented by general formula III;
the compound represented by general formula I has the following structure:

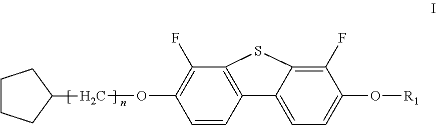

wherein in the general formula I, R₁ represents an alkyl group having 1-7 carbon atoms, or an alkenyl group having 2-7 carbon atoms, and n represents 0, 1 or 2;
the compound represented by general formula II has the following structure:

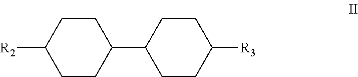

wherein in the general formula II, R₂ and R₃ each independently represent an alkyl group having 1-7 carbon atoms, an alkoxy group having 1-7 carbon atoms, or an alkenyl group having 2-7 carbon atoms; and
the compound represented by general formula III has the following structure:

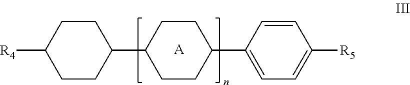

wherein in the general formula III, R₄ and R₅ each independently represent an alkyl group having 1-7 carbon atoms, an alkoxy group having 1-7 carbon atoms, or an alkenyl group having 2-7 carbon atoms, n represents 1 or 2, and

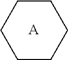

represents one or more of

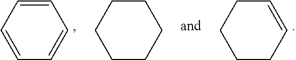

It is well known in the art that increasing the clearing point of the liquid crystal composition can achieve the purpose of increasing the elastic constant. However, elevation of the clearing point leads to increased rotary viscosity of the liquid crystal composition, consequently resulting in slower response time of the liquid crystal display. In the present disclosure, it is found that when the compound represented by general formula I works synergistically with the compound represented by general formula II and the compound represented by general formula III, the provided liquid crystal composition has a high elastic constant on the one hand and a low rotary viscosity on the other hand, so as to effectively improve the response time of the liquid crystal display while improving the liquid crystal display.

The compound represented by general formula I provided by the present disclosure is a compound containing dibenzothiophene, which has a high dielectric constant and a low rotary viscosity.

Preferably, the compound represented by general formula I is selected from one or more of the compounds represented by formulas IA1-IA10 and IB1-IB10:

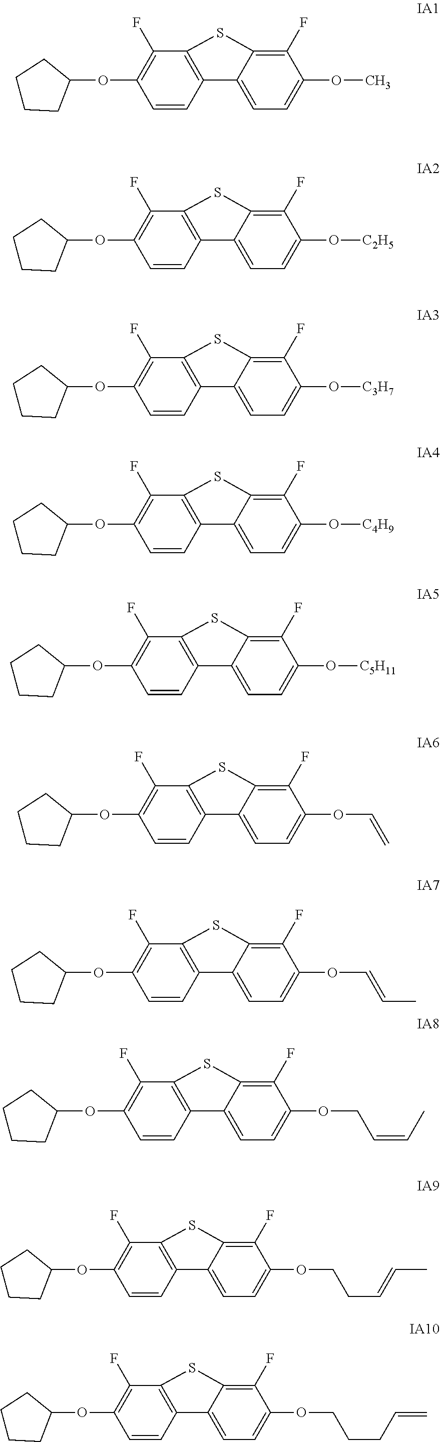

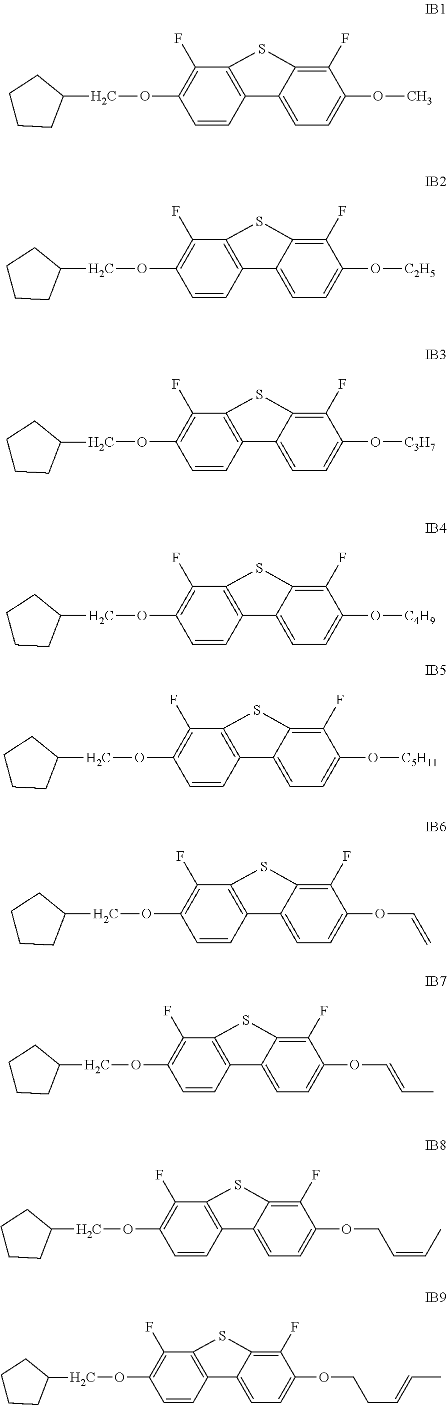

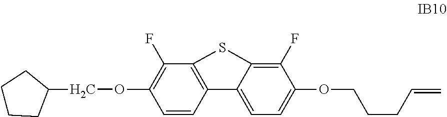

The compound represented by general formula II provided by the present disclosure is a compound containing bicyclohexane, which has a good low-temperature solubility.

Preferably, the compound represented by general formula II is selected from one or more of the compounds represented by IIA1-IIA12, IIB1-IIB14 and IIC1-IIC4:

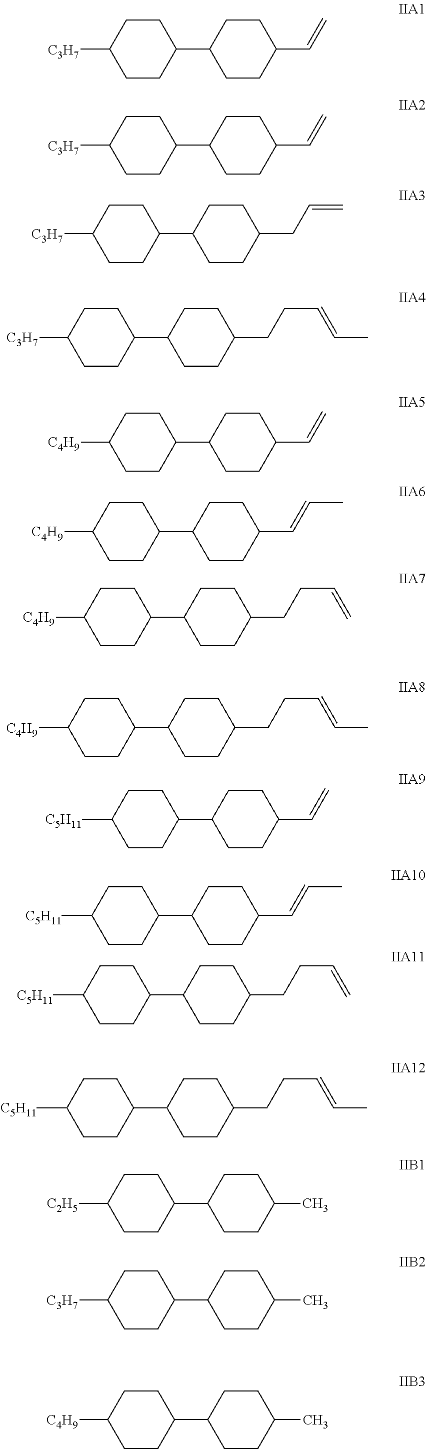

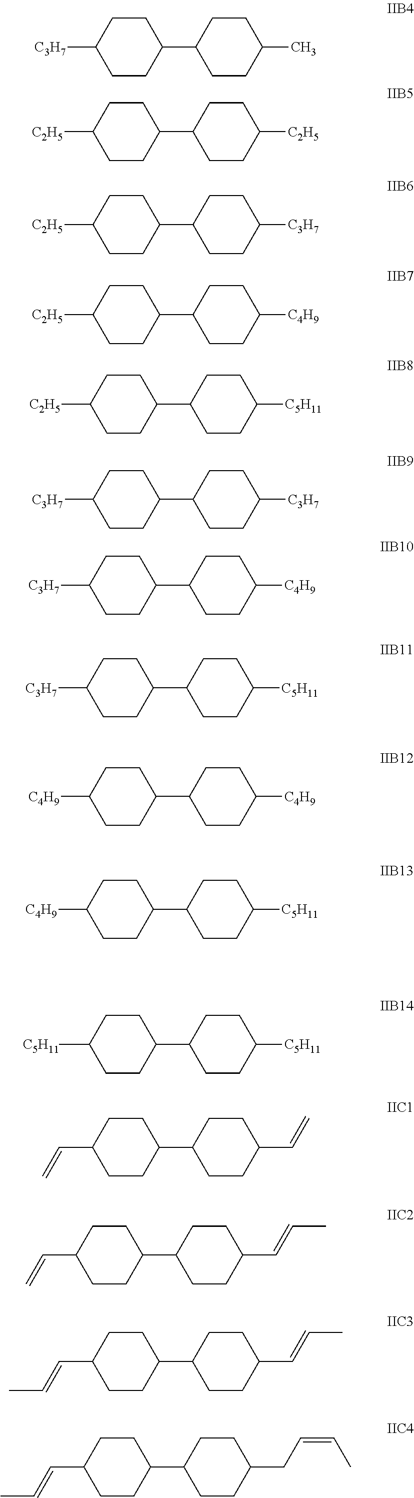

The compound represented by general formula III provided by the present disclosure is a tricyclic neutral compound, which has a high clearing point and a good low-temperature solubility.

Preferably, the compound represented by general formula III is selected from one or more of the compounds represented by IIIA1-IIIA48, IIIB1-IIIB48, and IIIC1-IIIC48:

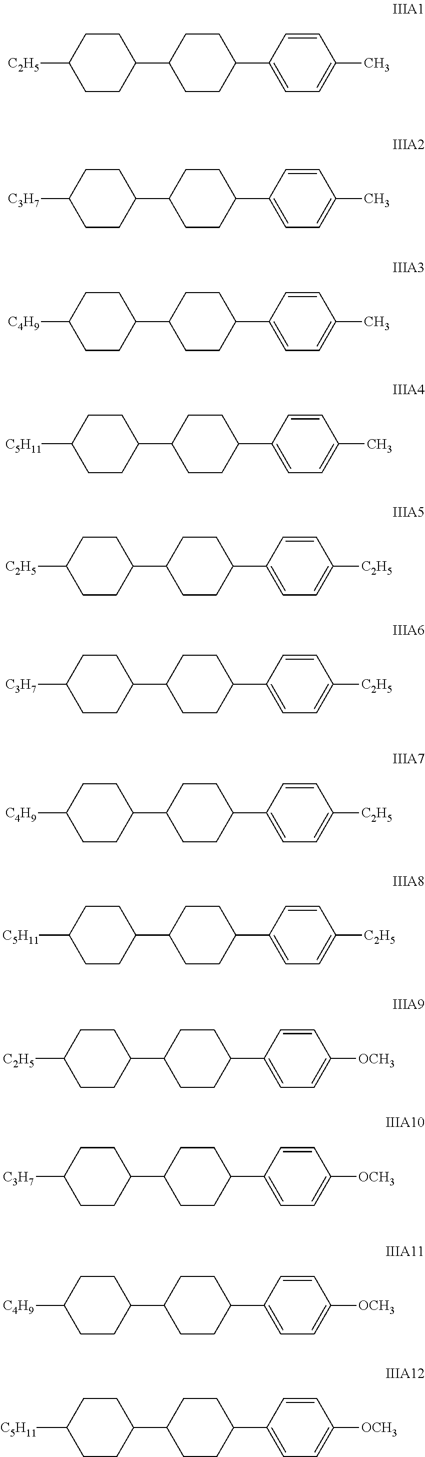

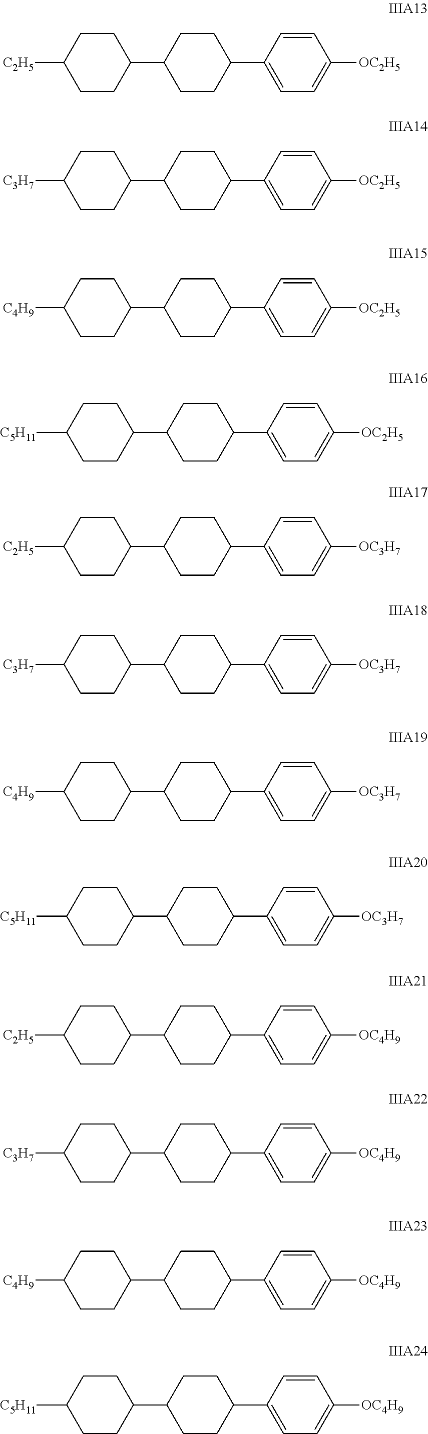

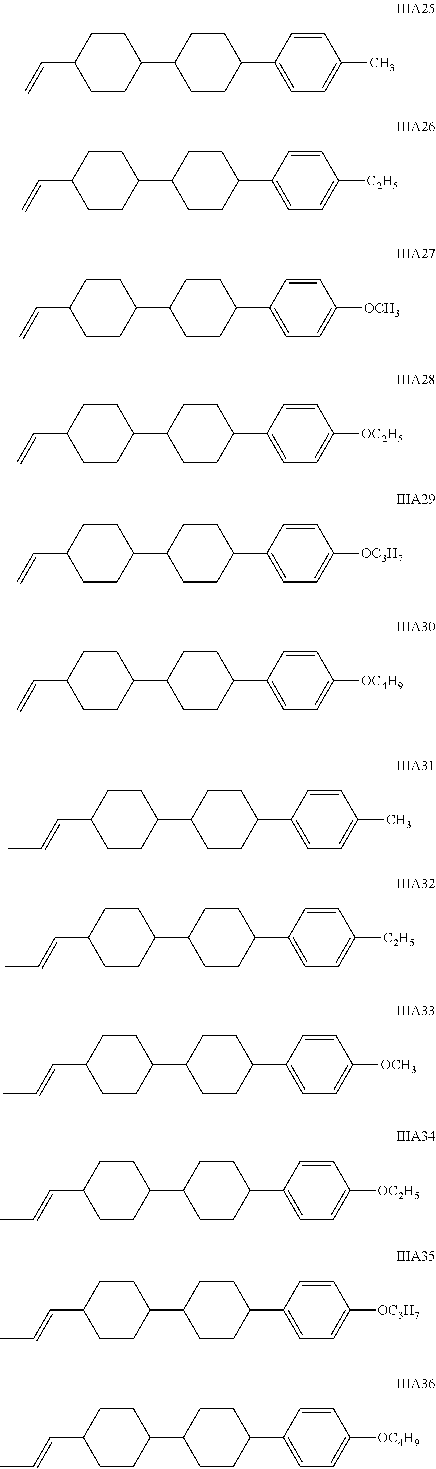

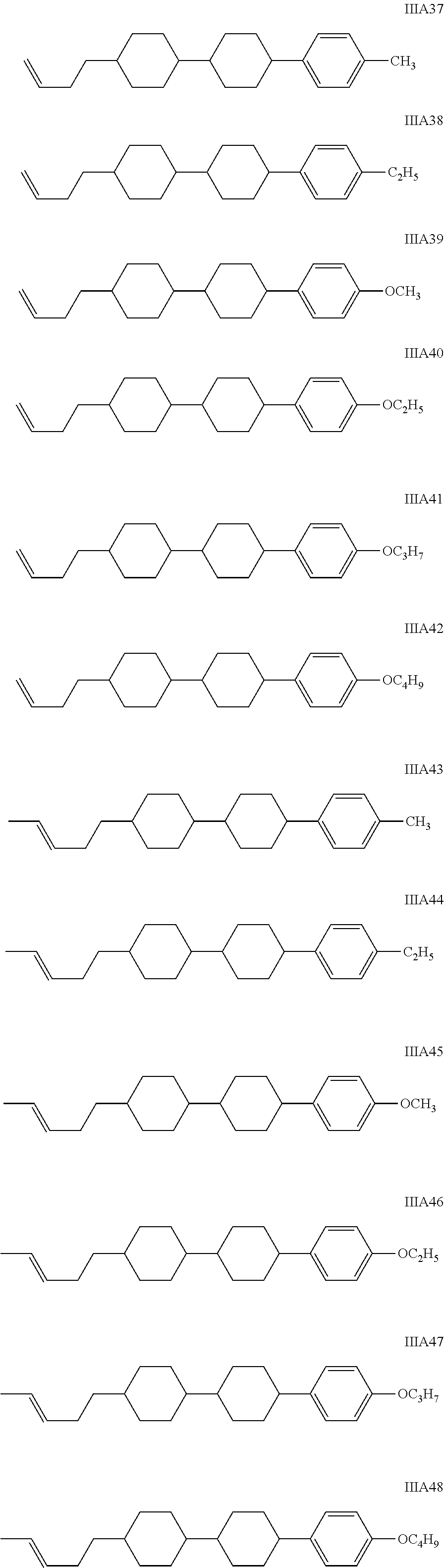

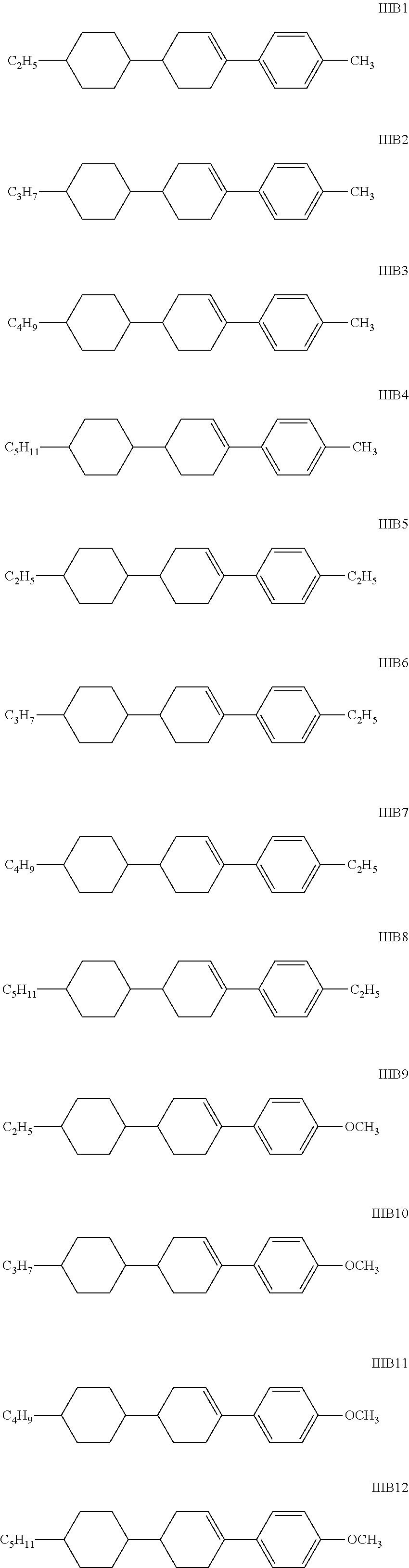

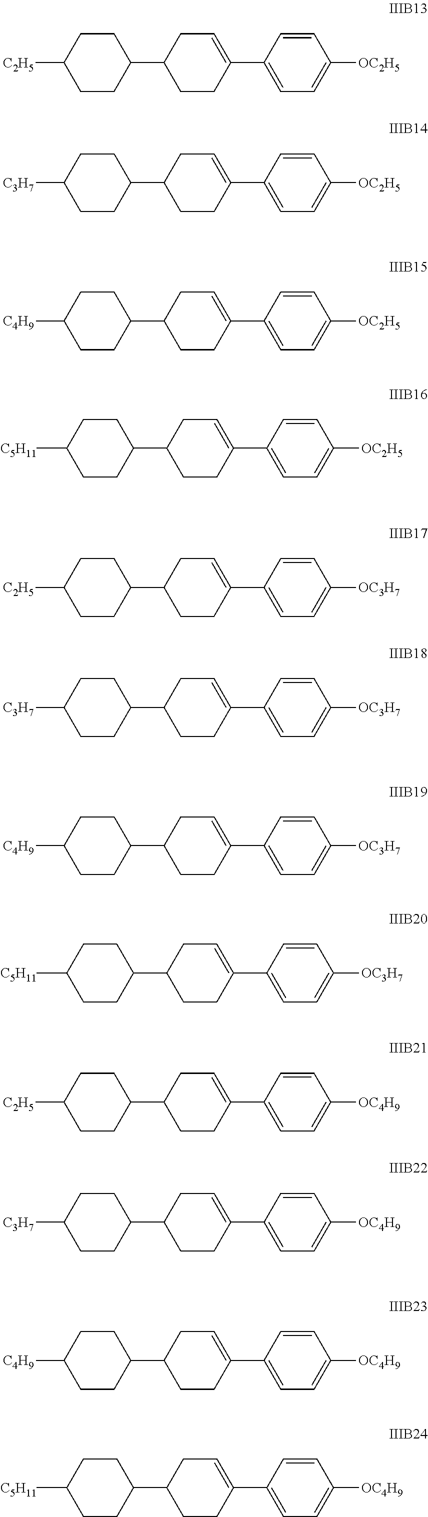

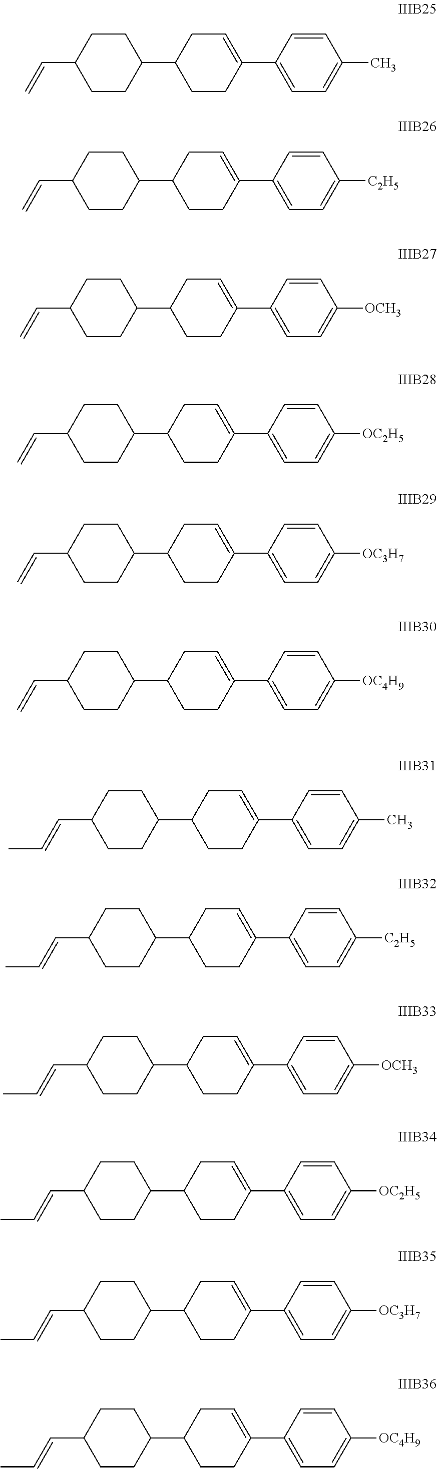

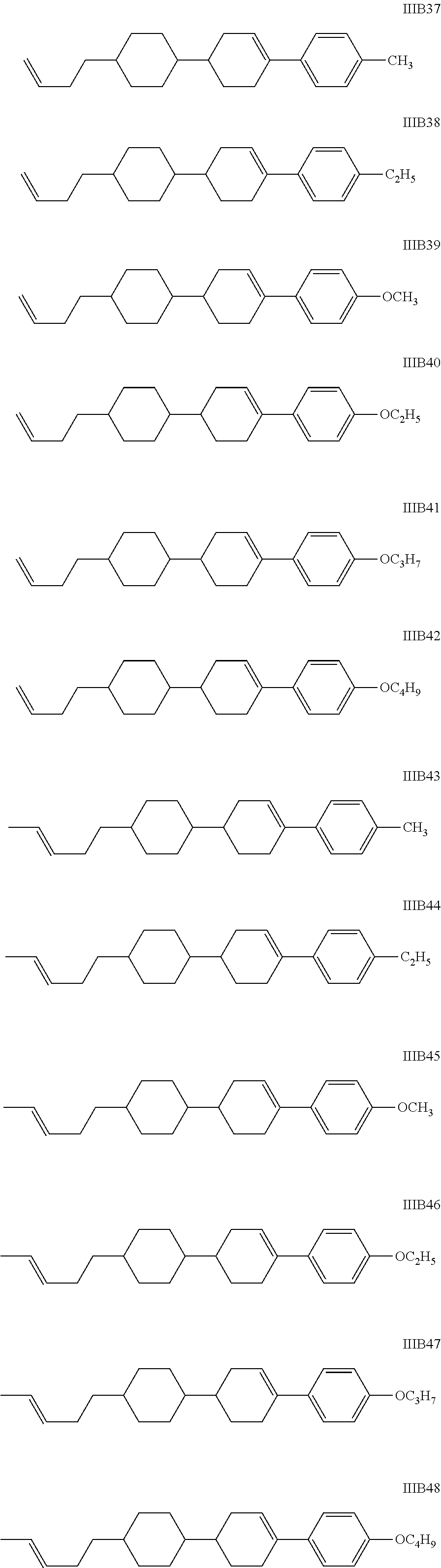

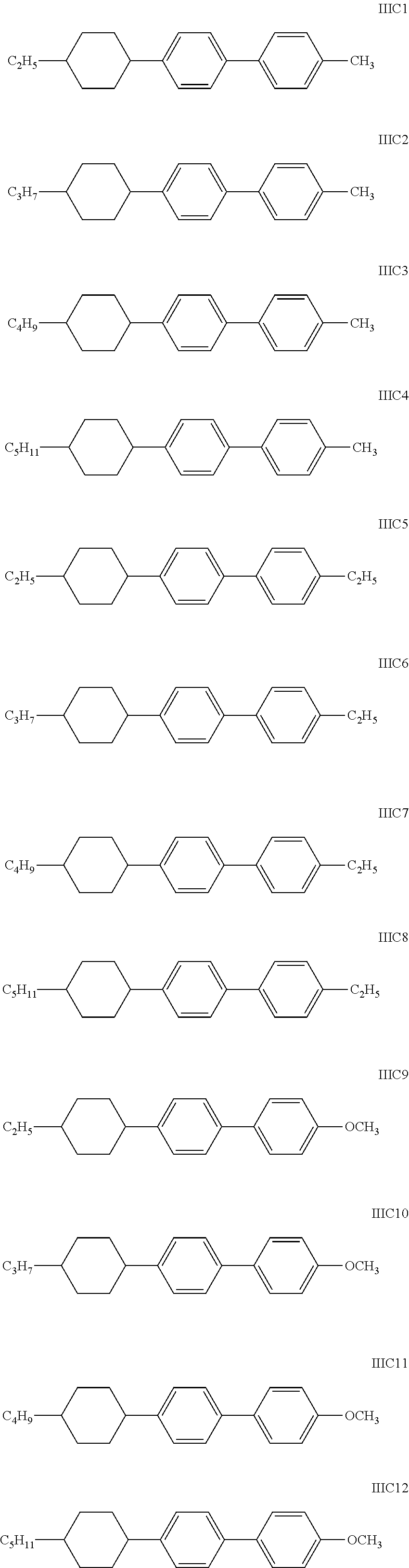

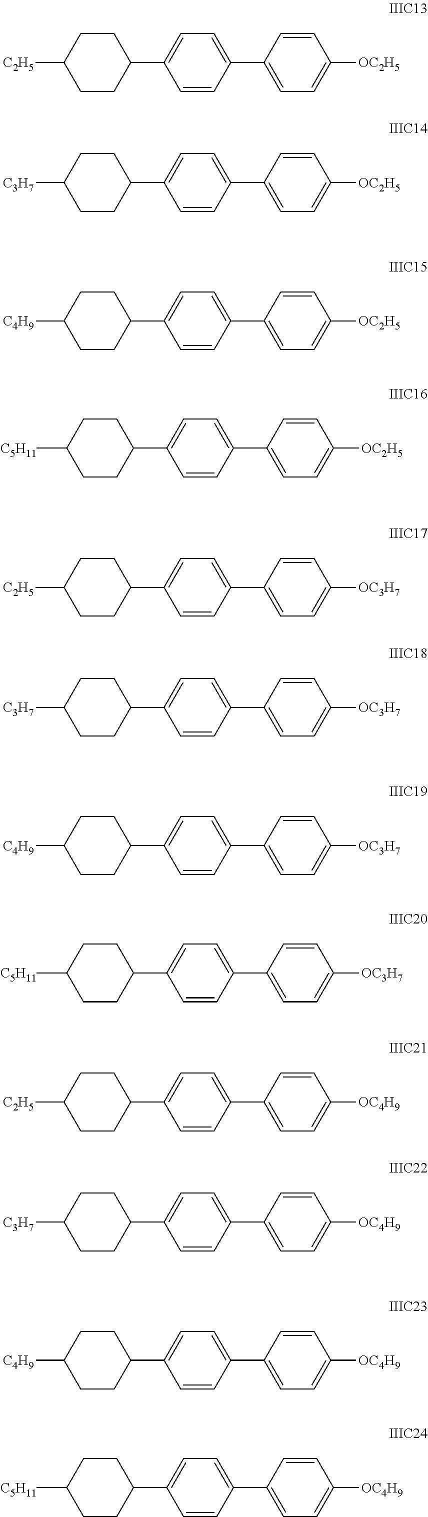

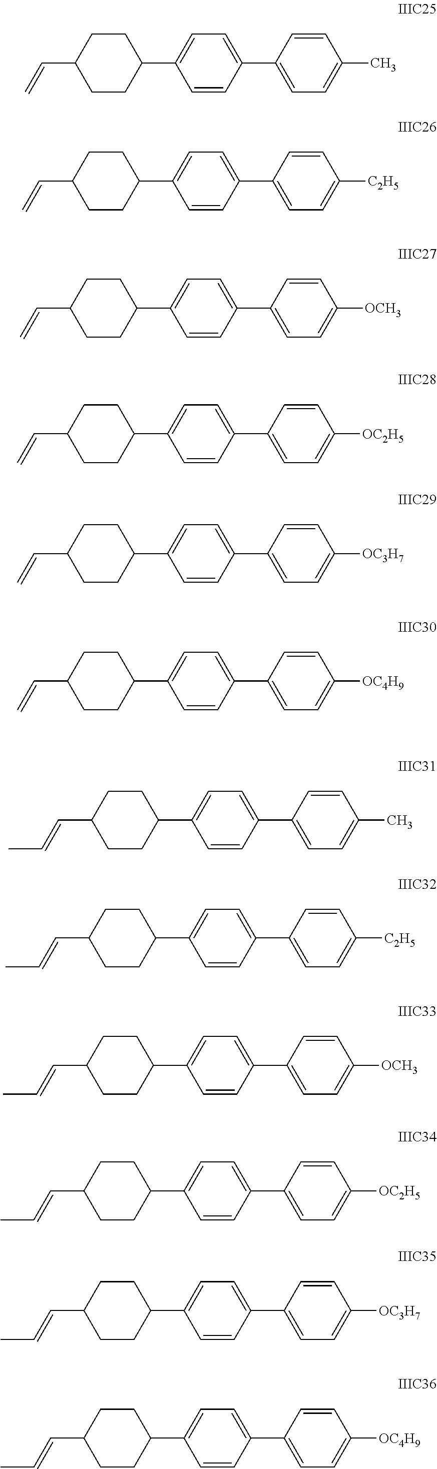

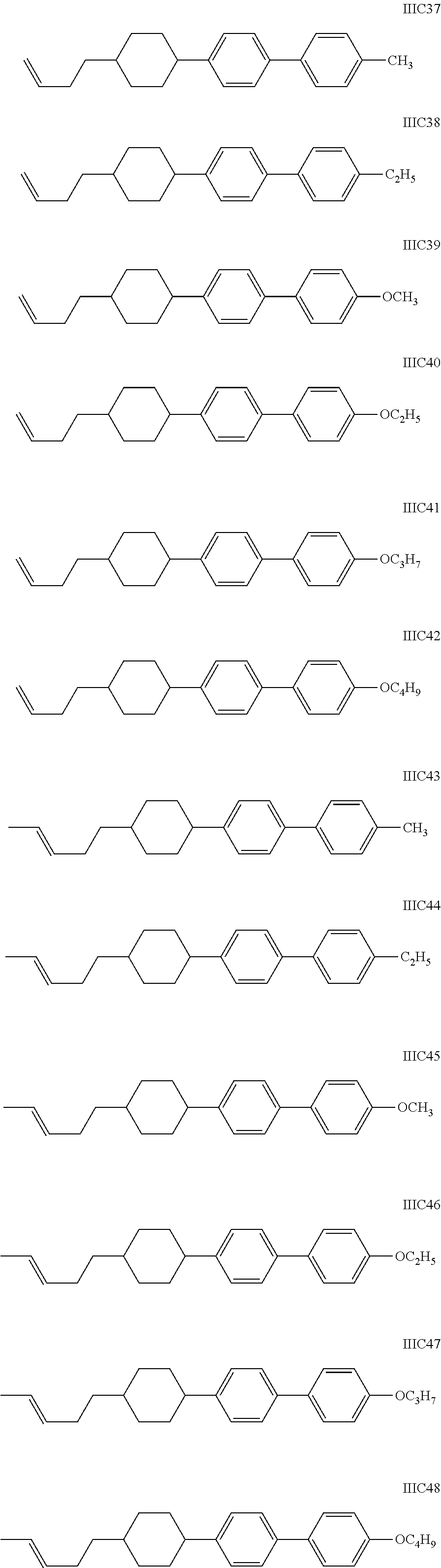

Preferably, the liquid crystal composition further comprises a compound represented by general formula IV:

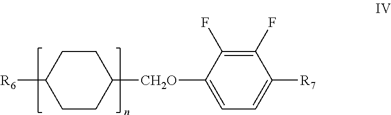

in the general formula IV, R₆ and R₇ each independently represent an alkyl group having 1-7 carbon atoms, an alkoxy group having 1-7 carbon atoms, or an alkenyl group having 2-7 carbon atoms, and n represents 1 or 2.

The compound represented by general formula IV provided by the present disclosure is a compound containing a methoxy bridge; when added to the liquid crystal composition, the compound is helpful to cooperate with the compounds represented by general formulas I-III of the present disclosure and can further improve the dielectric anisotropy of the liquid crystal composition.

More preferably, the compound represented by general formula IV is selected from one or more of the compounds represented by IVA1-IVA12, IVB1-IVB12, IVC1-IVC12, and IVD1-IVD12:

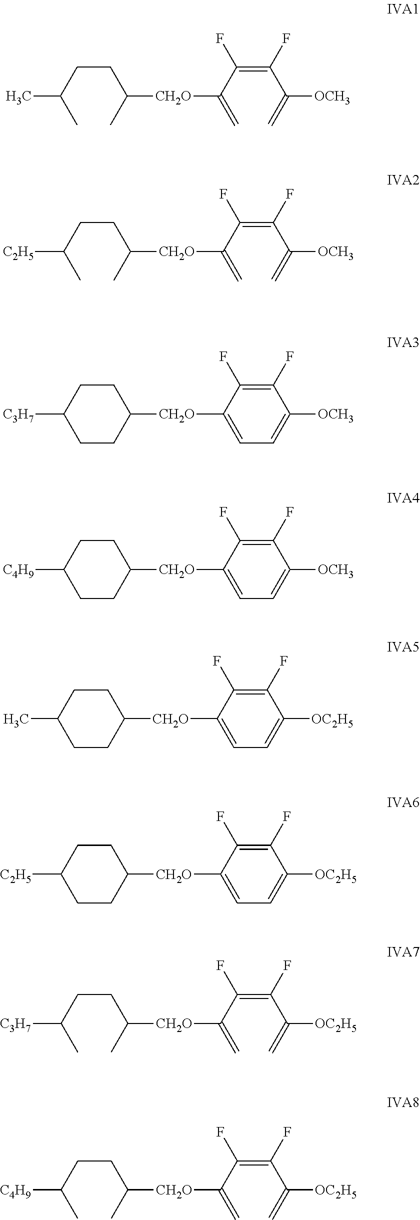

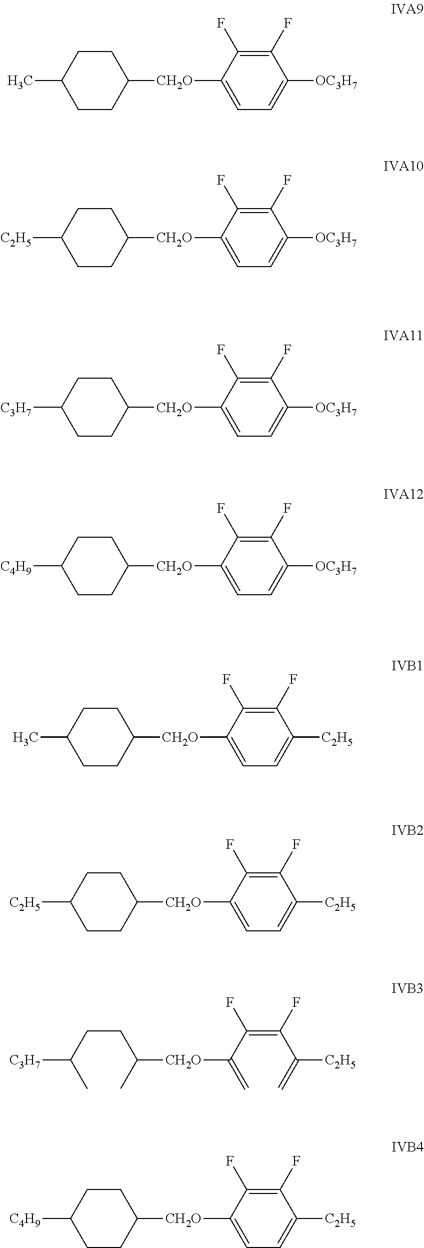

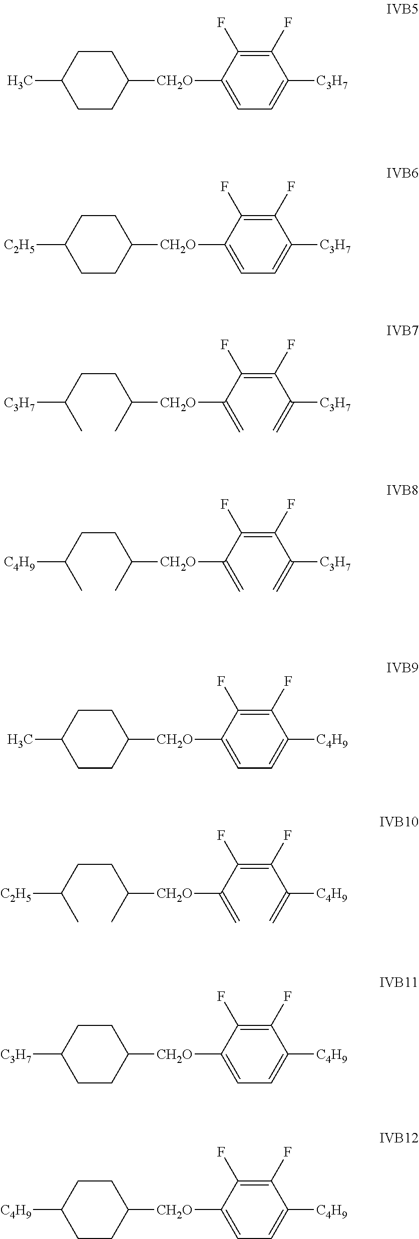

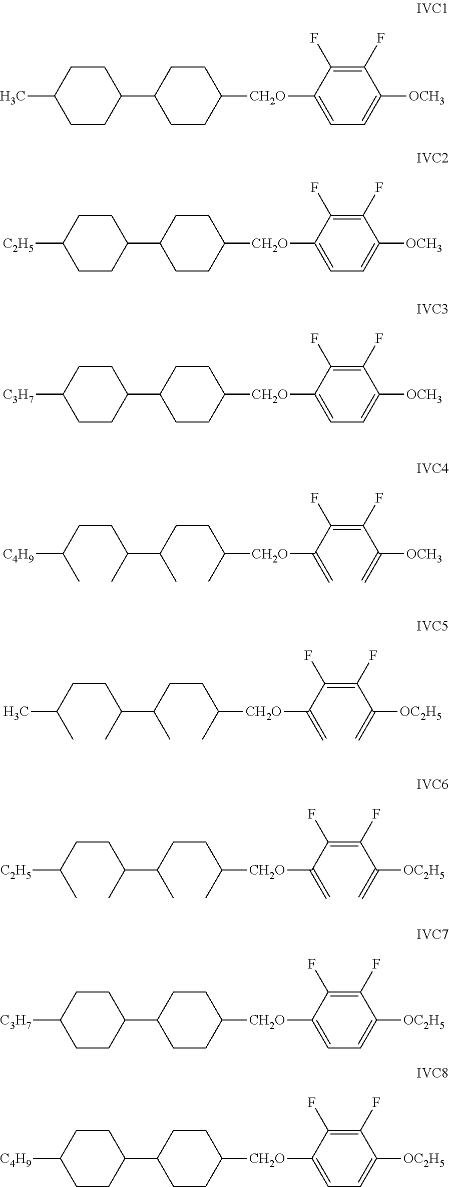

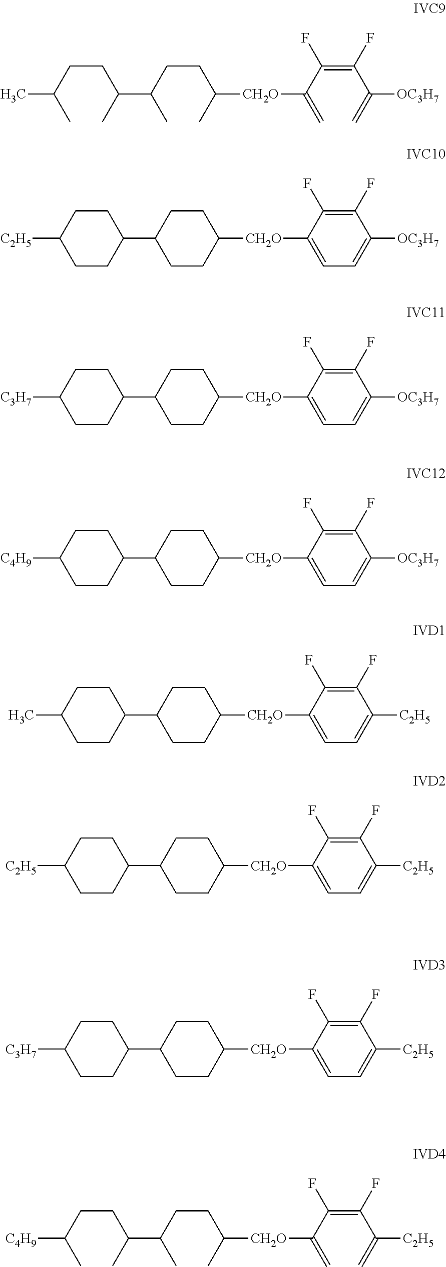

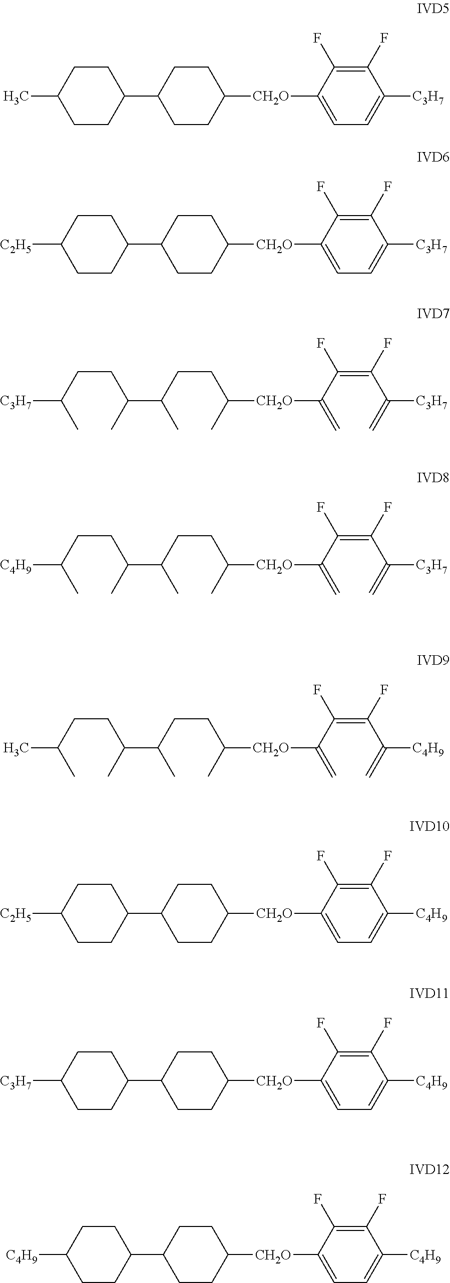

Preferably, the liquid crystal composition further comprises a compound represented by general formula V, and the compound represented by general formula V is a compound with negative dielectric anisotropy.

More preferably, the compound represented by general formula V is selected from one or more of the compounds represented by formulas VA1-VA48, VB1-VB48, VC1-VC48, VD1-VD48, VE1-VE48, and VF1-VF48

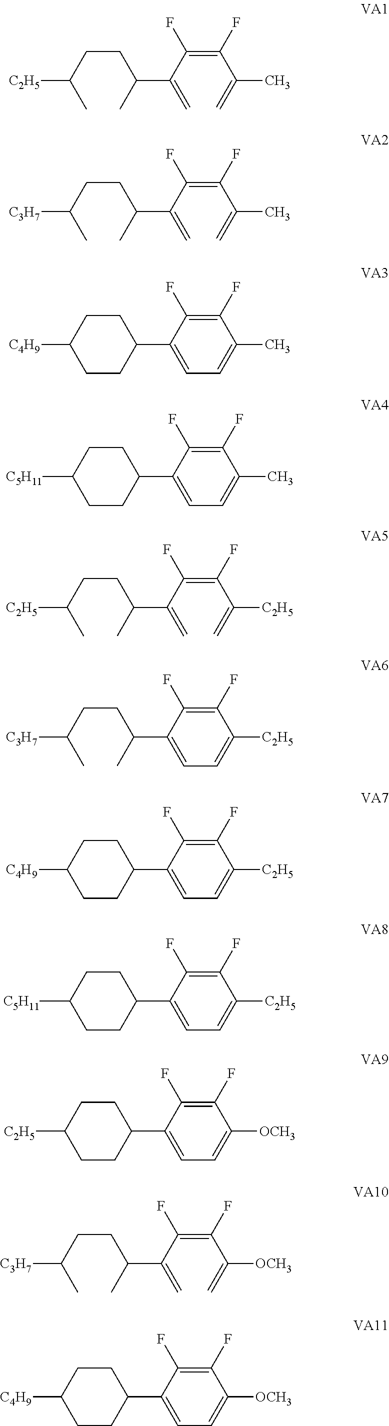

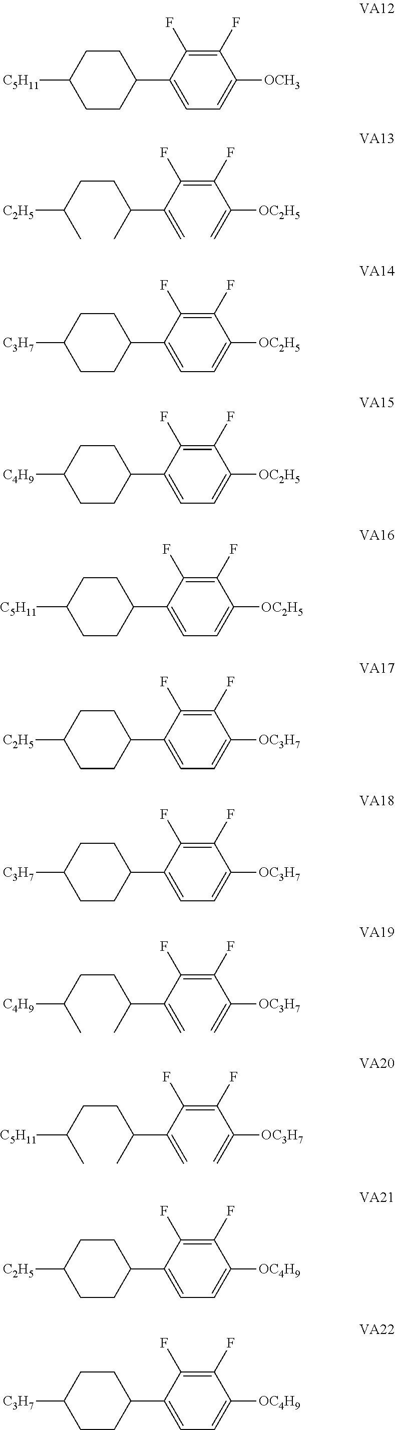

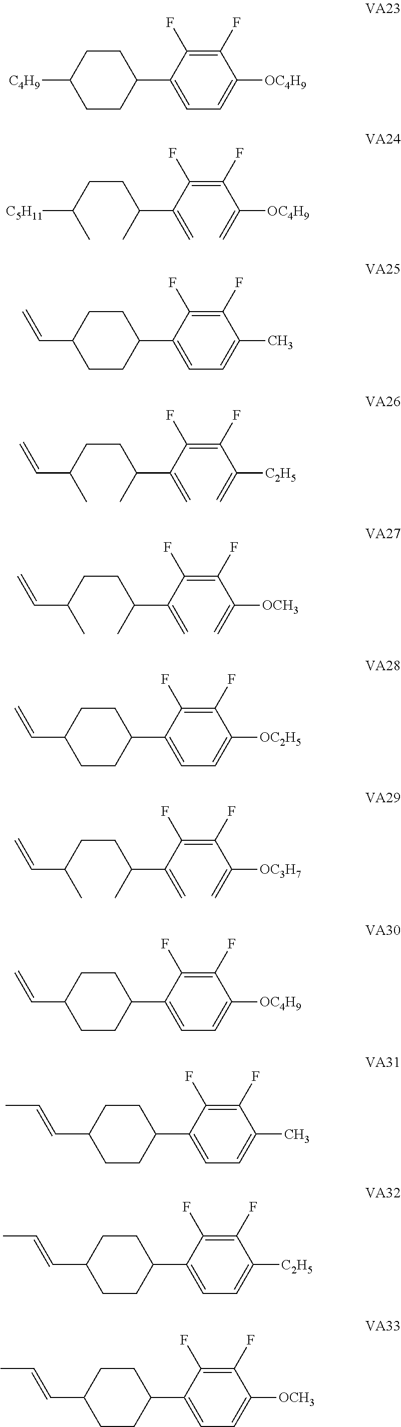

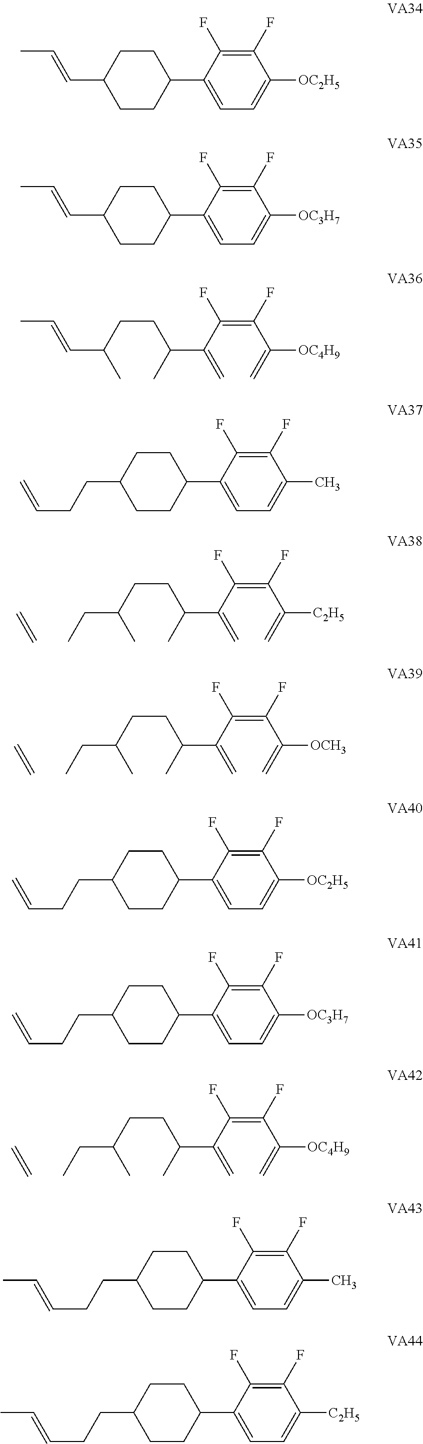

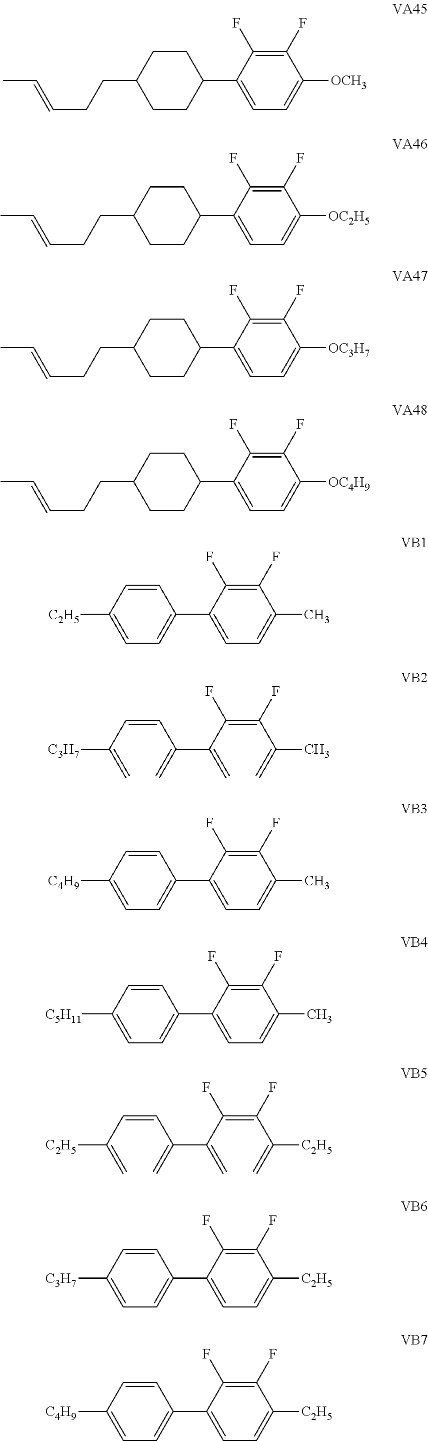

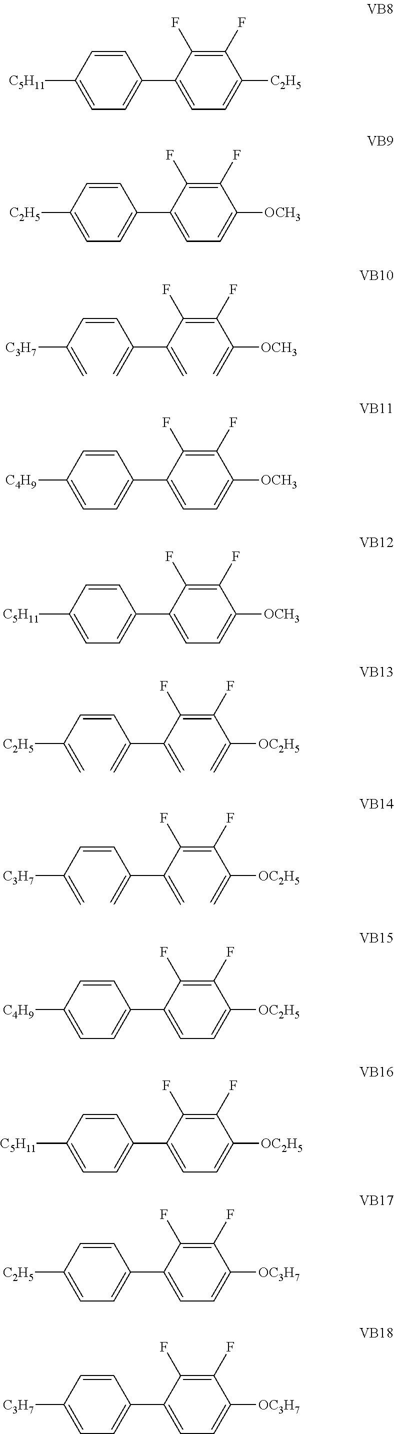

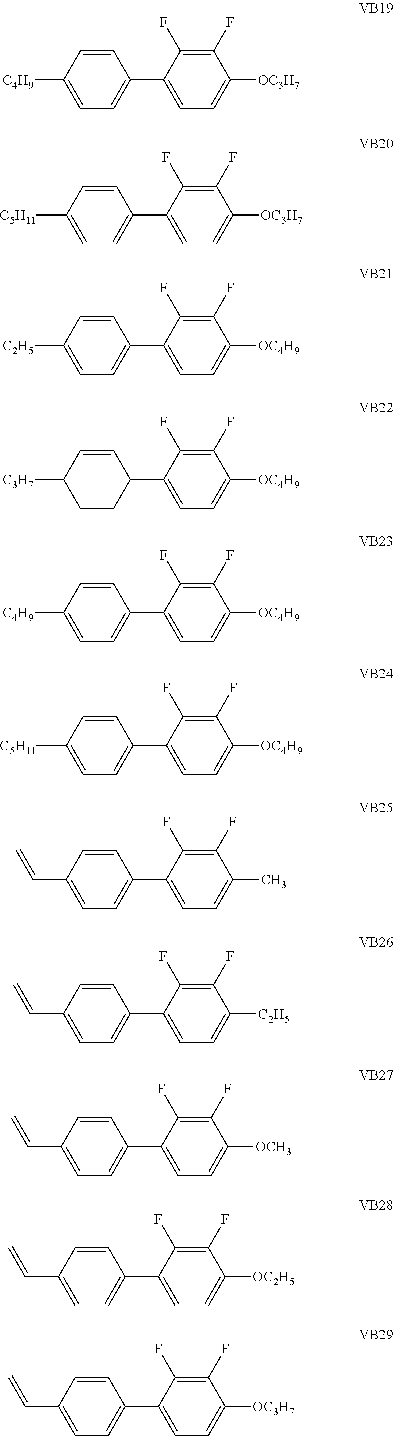

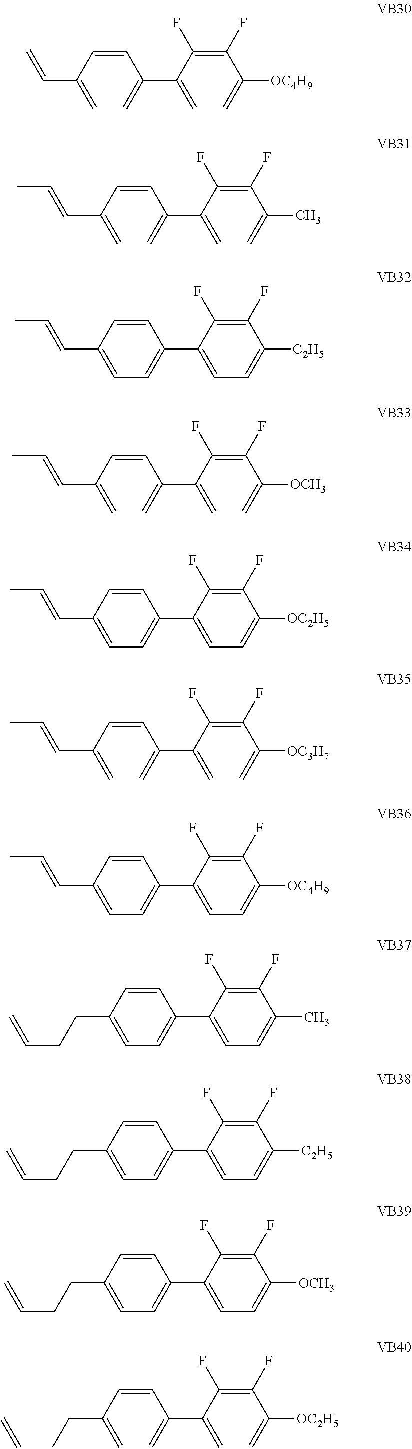

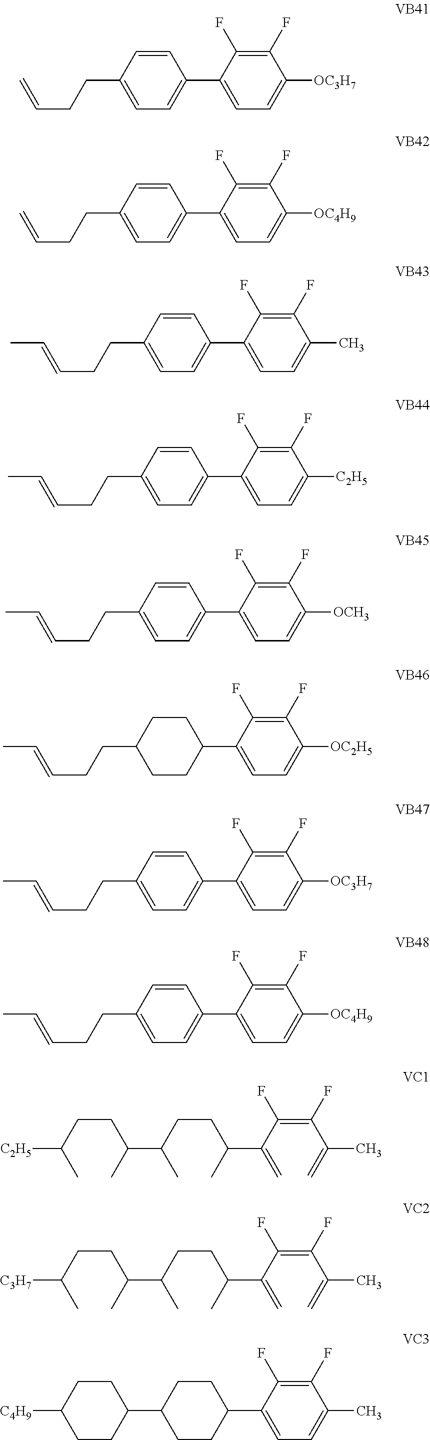

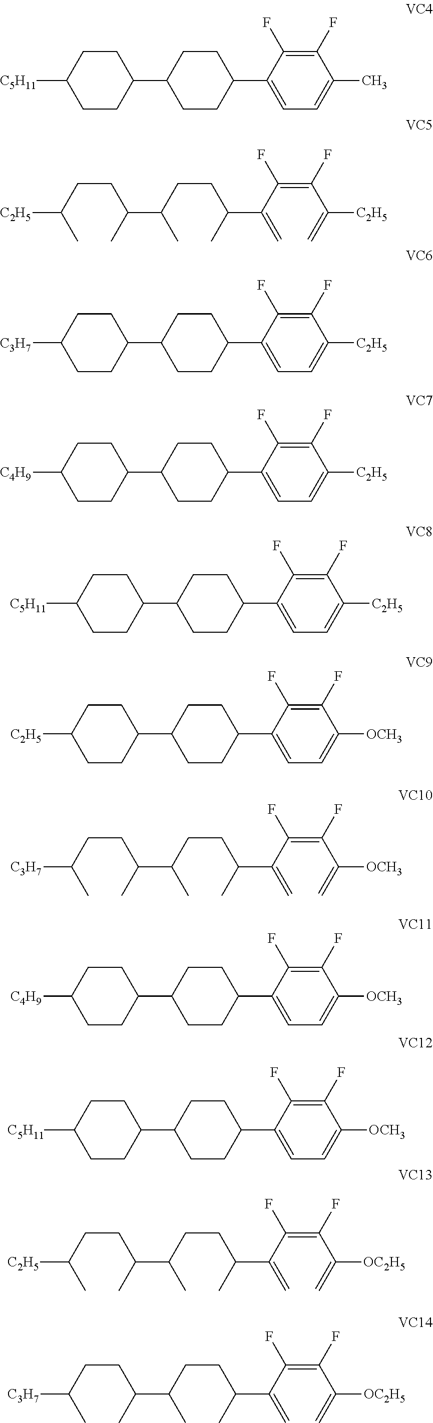

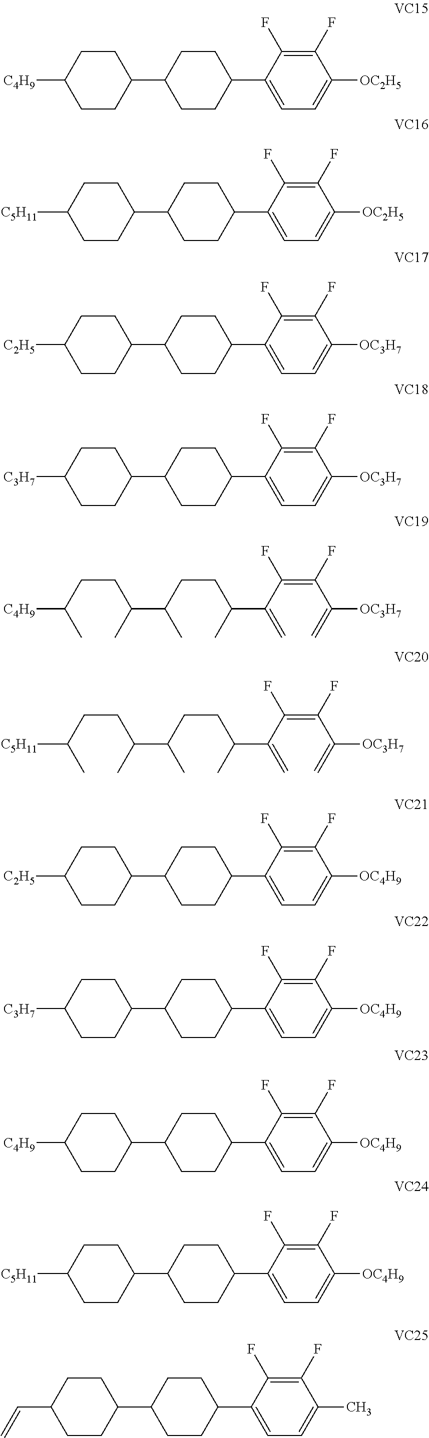

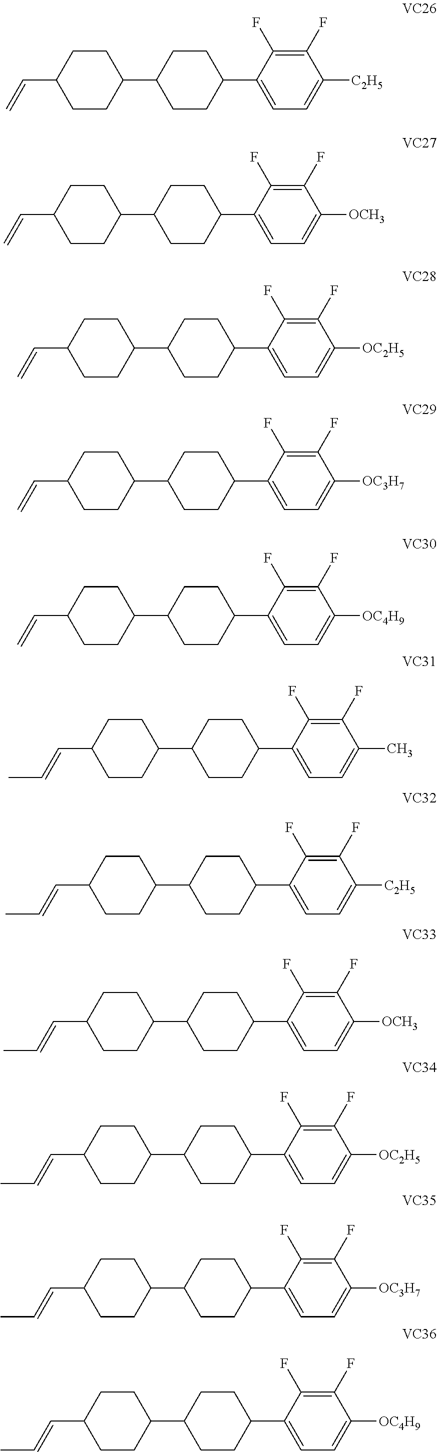

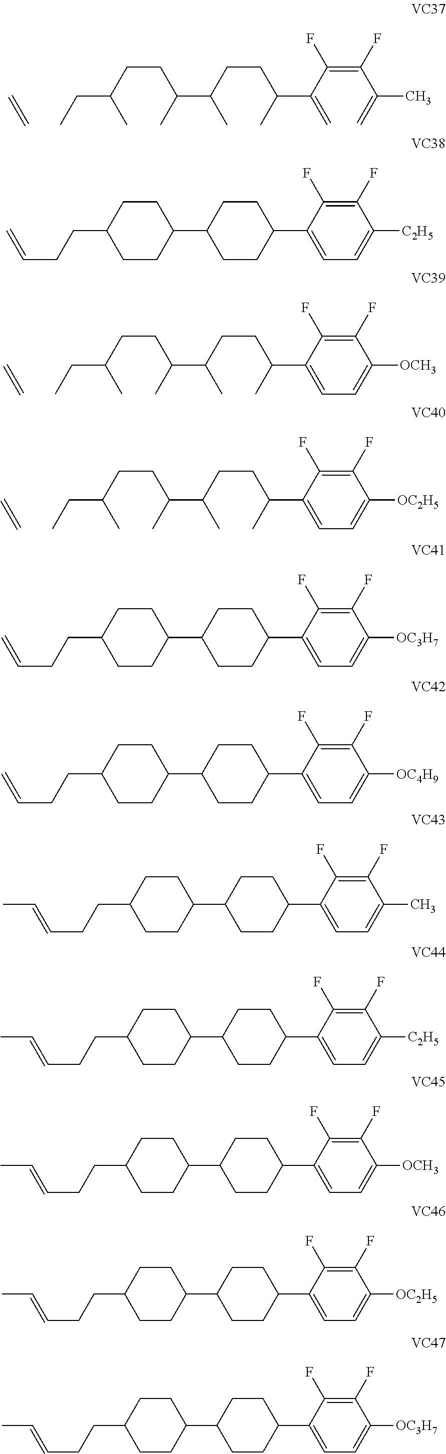

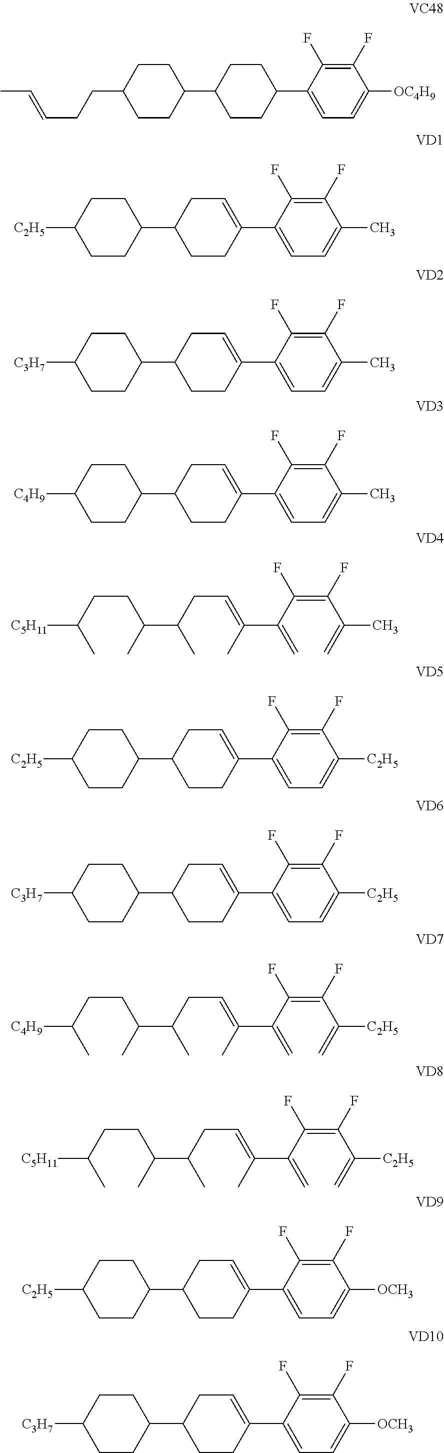

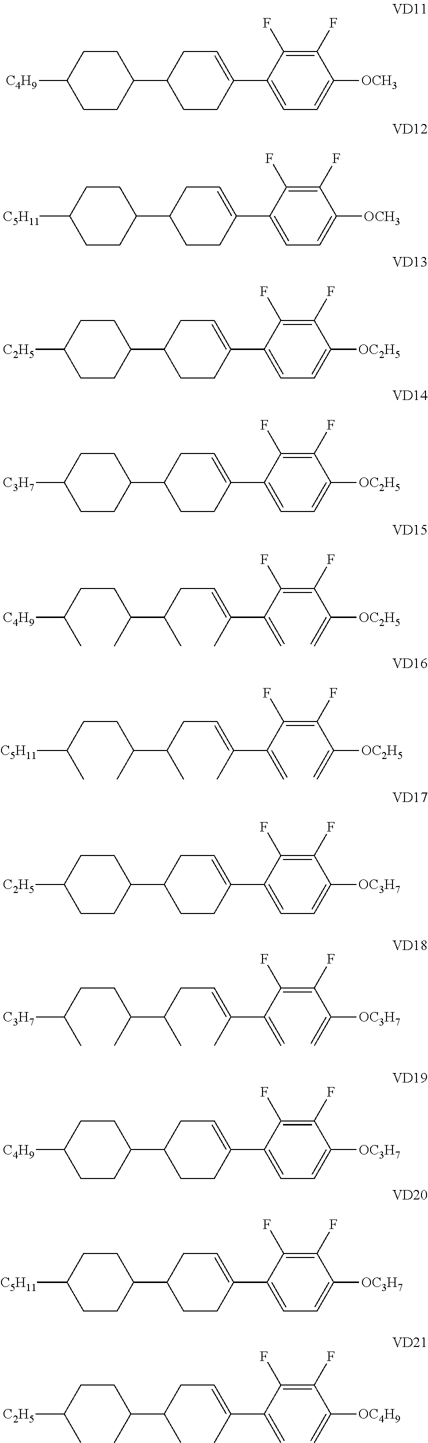

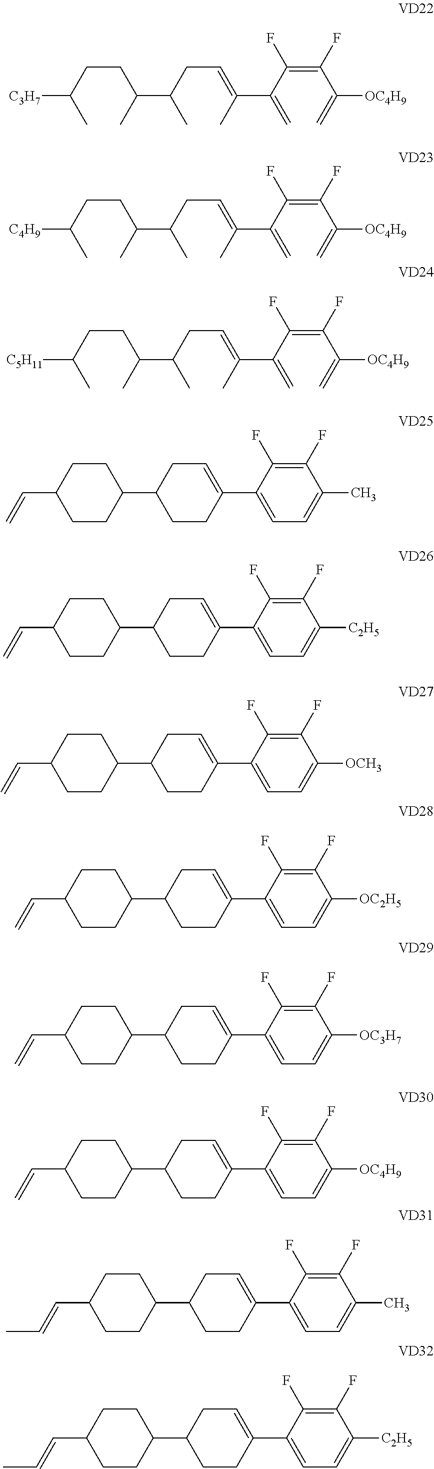

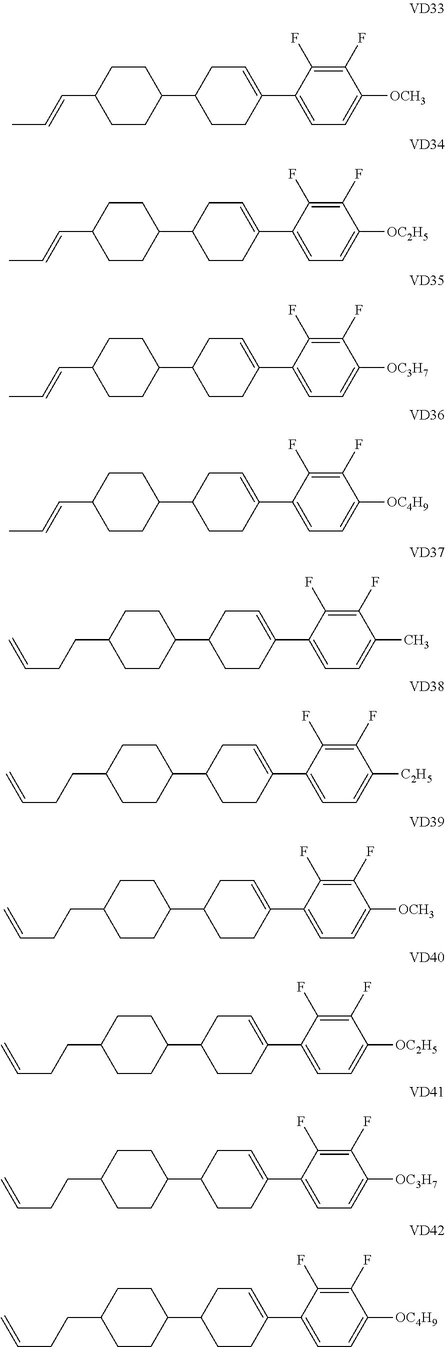

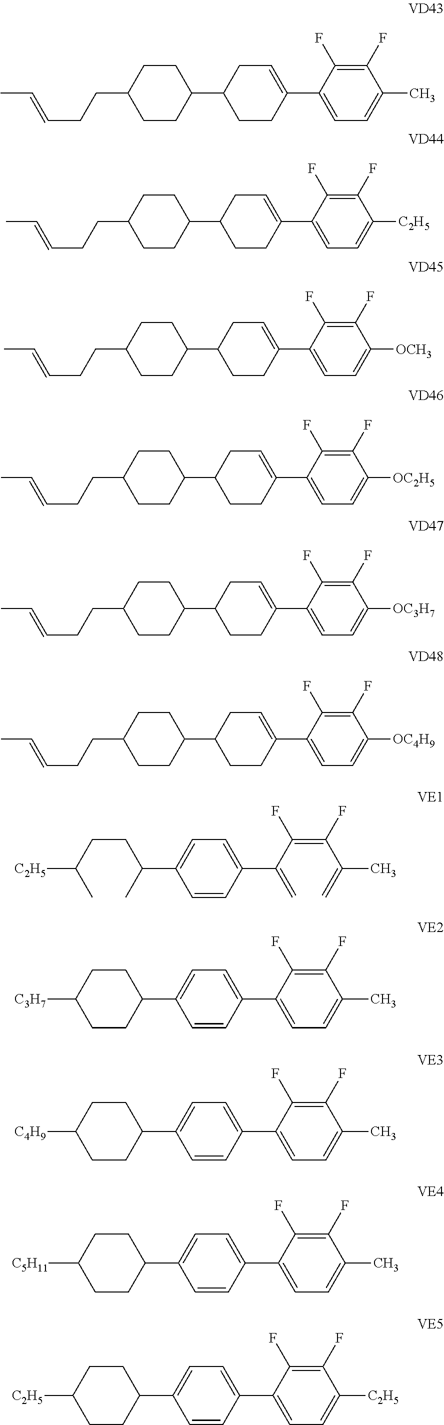

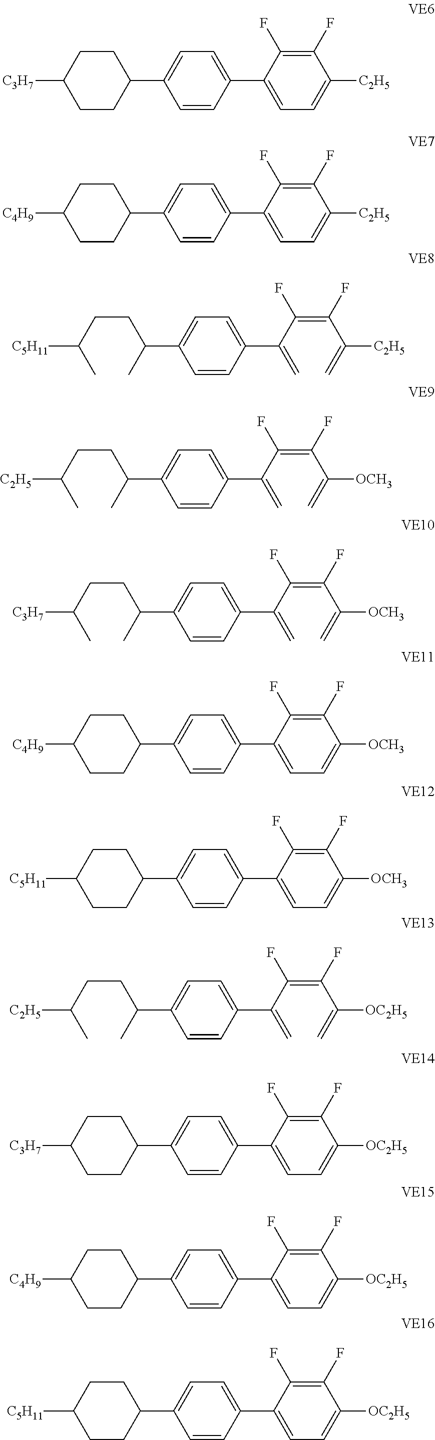

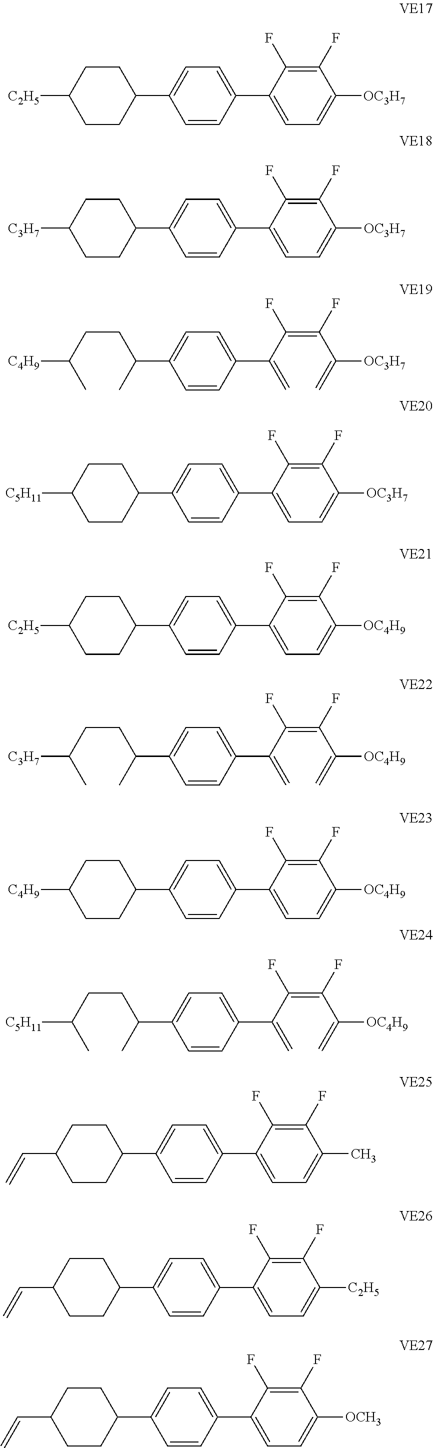

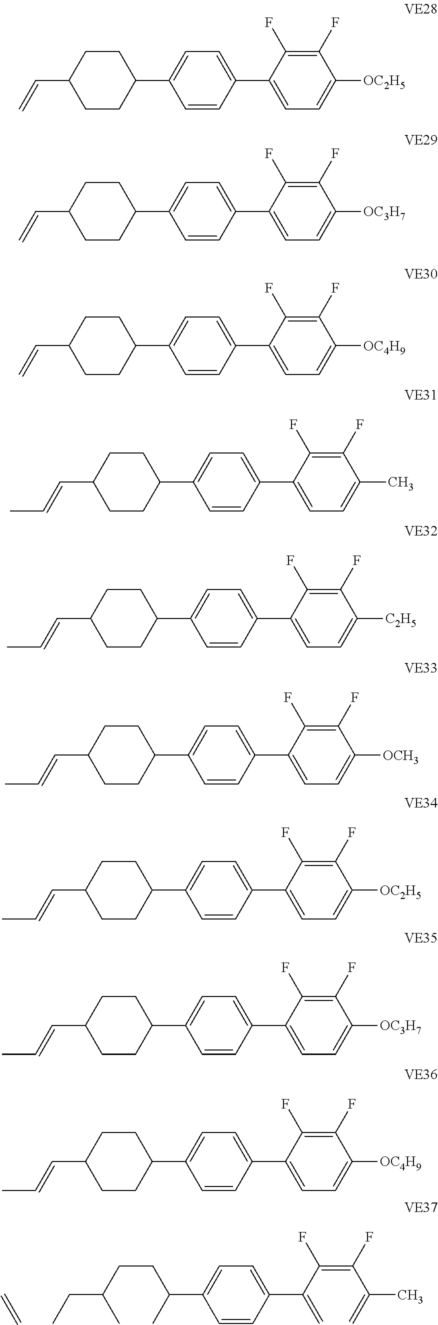

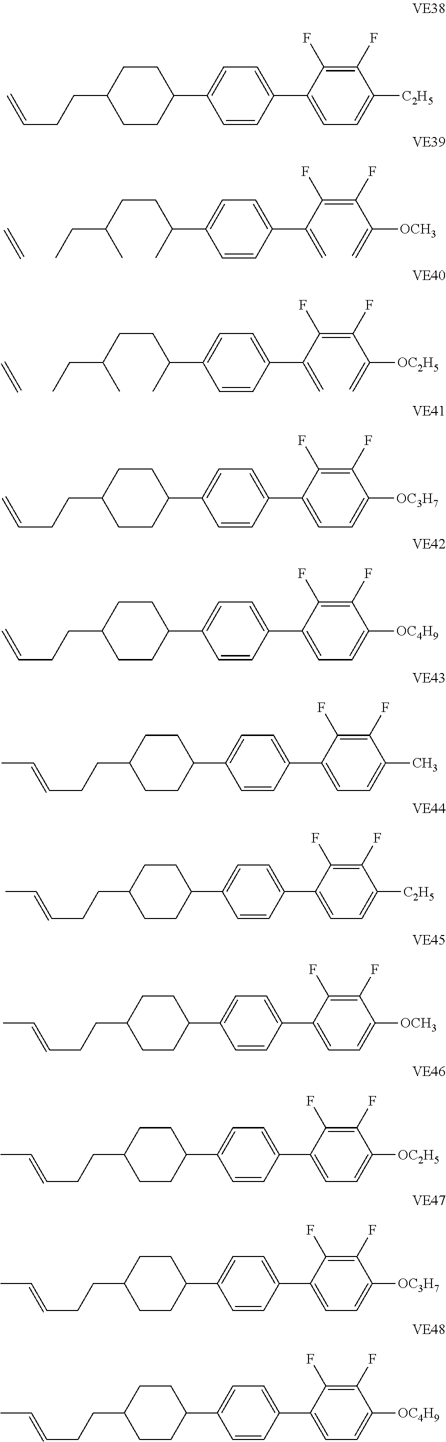

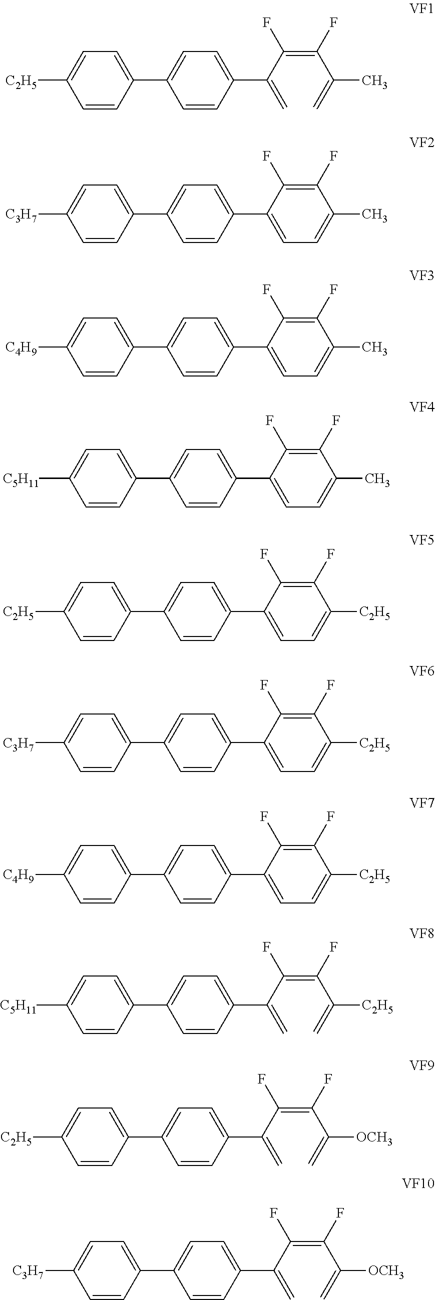

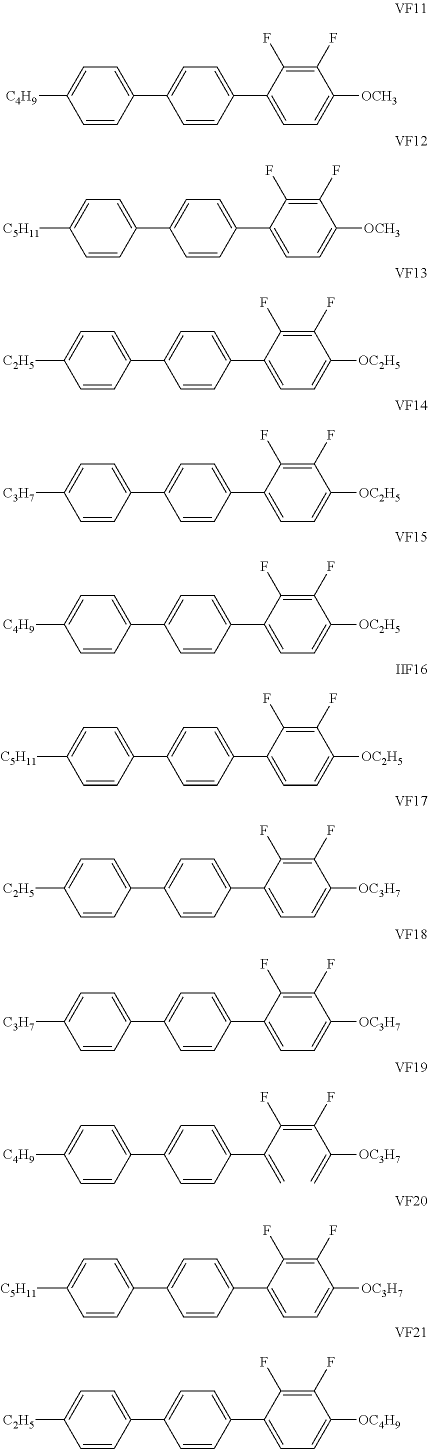

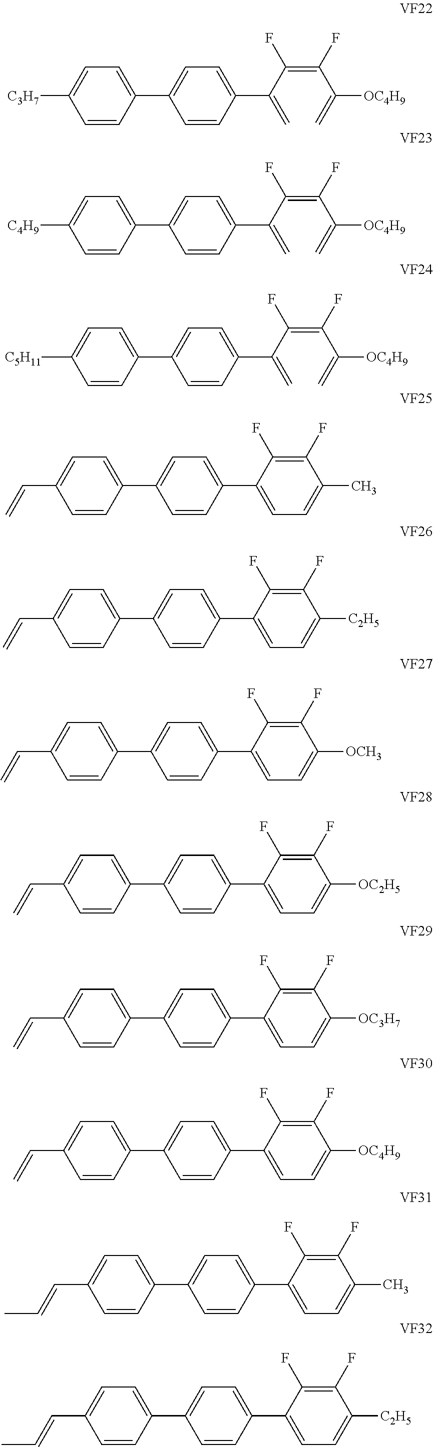

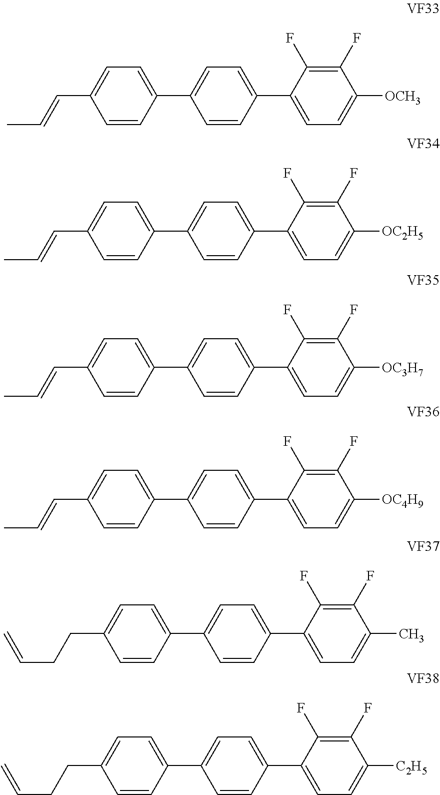

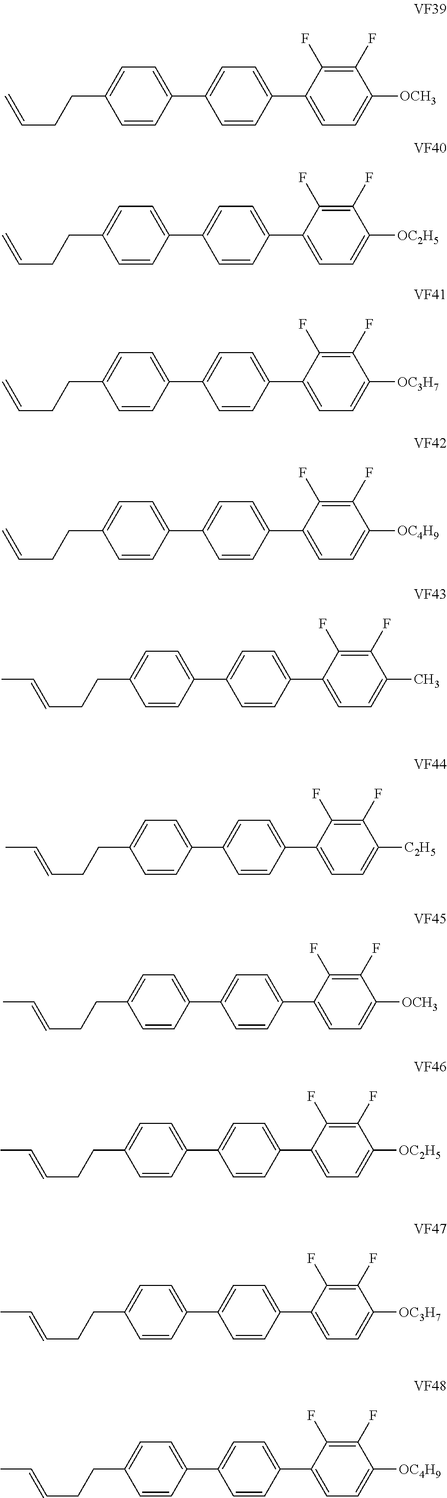

In the liquid crystal composition provided by the present disclosure, e compound represented by general formula I is a compound containing dibenzothiophene, which has a high dielectric constant and a low rotary viscosity; the compound represented by general formula II is a bicyclohexane compound, which has a low rotary viscosity and excellent miscibility characteristics, and is an essential component for a fast-response liquid crystal display; the compound of general formula III is a tricyclic neutral compound, which has a high clearing point and can effectively increase the clearing point of the liquid crystal composition; the compound represented by general formula IV is a methoxy-bridged dielectric anisotropic compound, which has large dielectric anisotropy and can effectively reduce the driving voltage of the liquid crystal panel; and the compound of general formula V is a negative compound; when added to the liquid crystal composition, the compound is helpful to cooperate with the compounds represented by general formulas I-IV of the present disclosure and can further improve the dielectric anisotropy of the liquid crystal composition.

To achieve a more significant synergistic effect among the components in the composition of the present disclosure, thereby effectively improving the comprehensive application performance of the liquid crystal material, the present disclosure further optimizes the amounts of the components in the liquid crystal material.

Preferably, the liquid crystal composition comprises the following components in percentage by mass:
(1) 1-30% of the compound represented by general formula I,
(2) 1-50% of the compound represented by general formula II,
(3) 1-30% of the compound represented by general formula III,
(4) 1-25% of the compound represented by general formula IV, and
(5) 1-50% of the compound represented by general formula V.

More preferably, the liquid crystal composition comprises the following components in percentage by mass:
(1) 5-25% of the compound represented by general formula I,
(2) 5-50% of the compound represented by general formula II,
(3) 5-30% of the compound represented by general formula III,
(4) 5-25% of the compound represented by general formula IV, and
(5) 5-50% of the compound represented by general formula V.

Further preferably, the liquid crystal composition comprises the following components in percentage by mass:
(1) 10-25% of the compound represented by general formula I,
(2) 20-50% of the compound represented by general formula II,
(3) 10-25% of the compound represented by general formula III,
(4) 5-20% of the compound represented by general formula IV, and
(5) 20-45% of the compound represented by general formula V.

Most preferably, the liquid crystal composition comprises the following components in percentage by mass:
(1) 10-20% of the compound represented by general formula I,
(2) 35-45% of the compound represented by general formula II,
(3) 10-20% of the compound represented by general formula III,
(4) 10-15% of the compound represented by general formula IV, and
(5) 20-35% of the compound represented by general formula V.

The liquid crystal composition provided by the present disclosure further comprises one or more compounds represented by general formula VI. The compound has a high elastic constant and a low rotary viscosity, which is very helpful for improving the contrast ratio.

Preferably, the compound represented by general formula VI is:

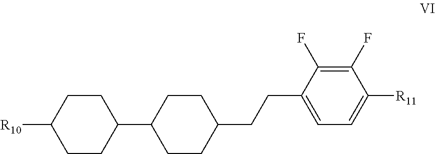

in the general formula VI, R₁₀ and R₁₁ each independently represent an alkyl group having 1-7 carbon atoms, an alkoxy group having 1-7 carbon atoms, or an alkenyl group having 2-7 carbon atoms.

In the present disclosure, the compound represented by general formula VI is an ethylene bond-containing tricyclic compound. The compound has a high elastic constant and a low rotary viscosity; when added to the liquid crystal composition, it is helpful to cooperate with the compounds represented by general formulas I-IV of the present disclosure, and can further improve the elastic constant of the liquid crystal composition.

More preferably, the compound represented by general formula VI is selected from one or more of the compounds represented by VIA1-VIA20, VIB1-VIB18, and VIC1-VIC14:

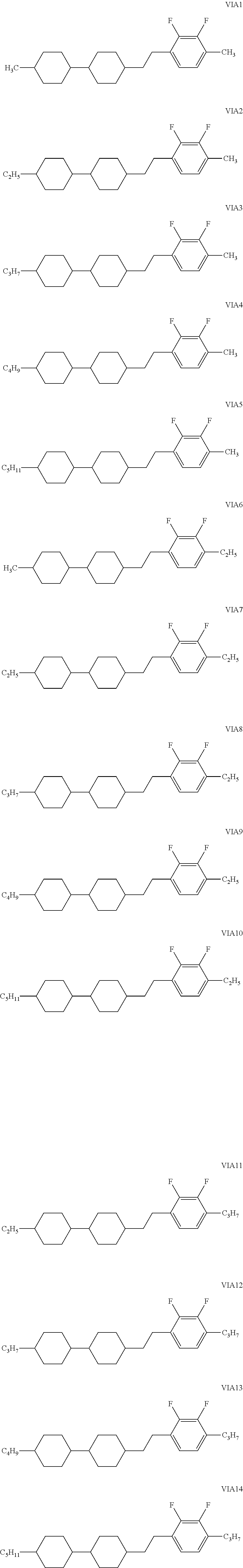

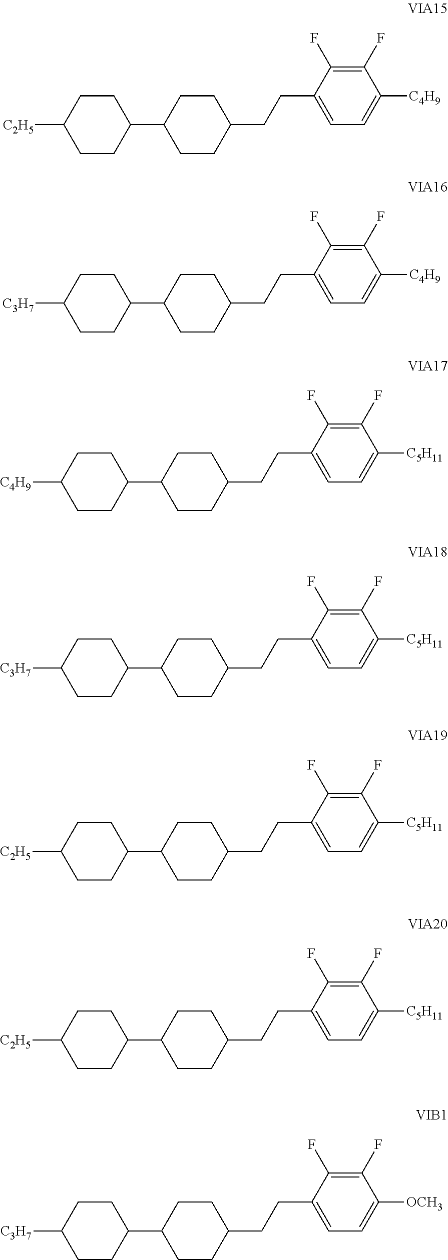

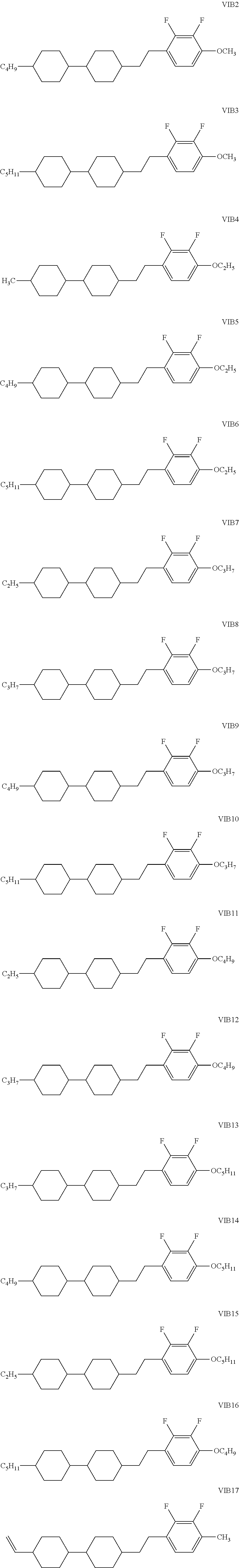

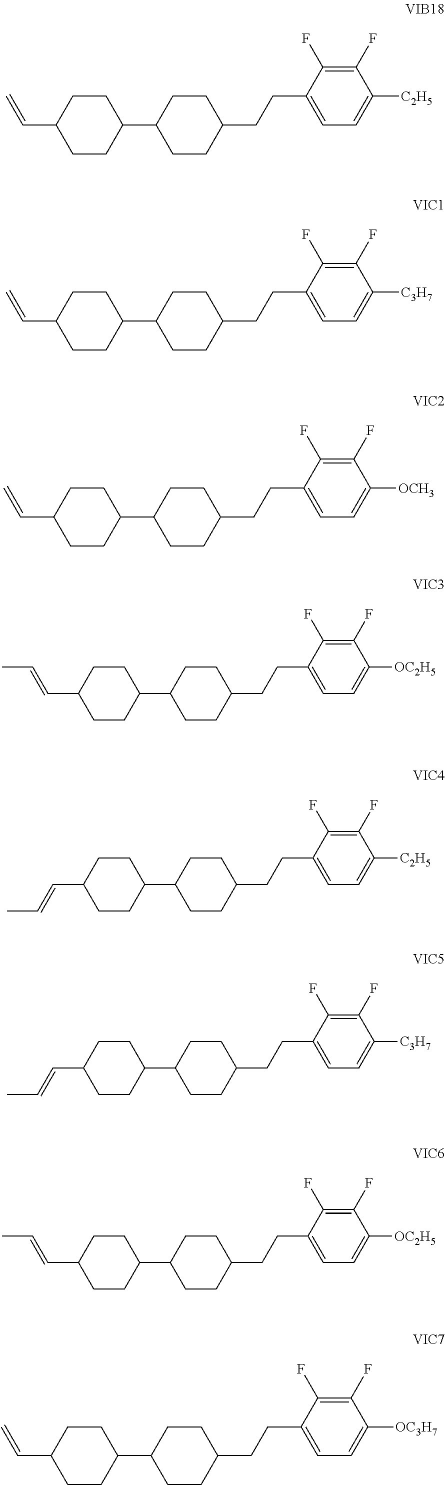

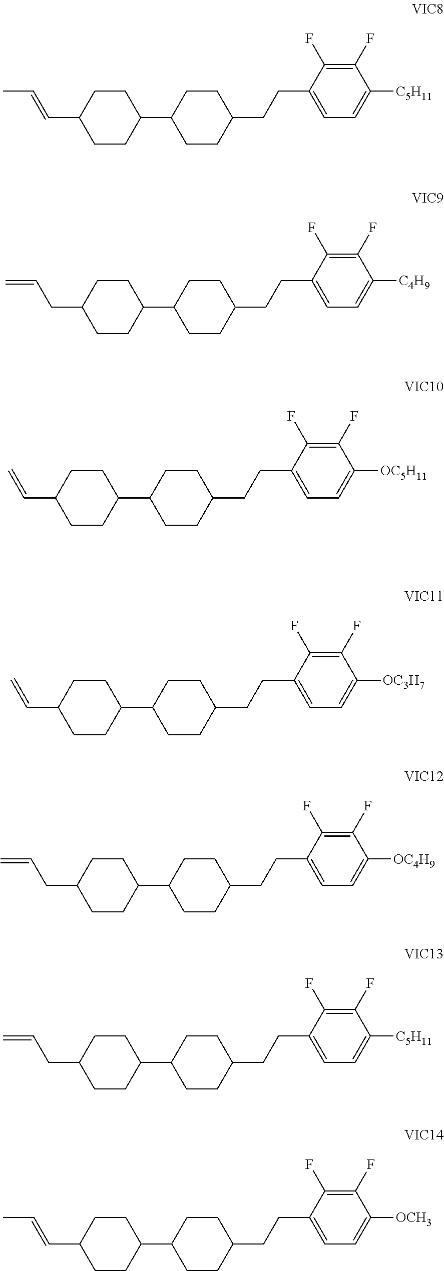

Preferably, based on the total mass percentage of all components in the liquid crystal composition being 100%, the mass content of the compound of general formula VI in the composition is 0-30%; preferably 5-25%; further preferably 10-25%; and more preferably 15-25%.

The method for producing the liquid crystal composition of the present disclosure is not particularly limited, and the liquid crystal composition can be produced by mixing two or more compounds using a conventional method, e.g., being prepared by a method of mixing and dissolving various components at a high temperature, where the liquid crystal composition is dissolved in a solvent used for the compounds and mixed, and then the solvent is distilled off under a reduced pressure; alternatively, the liquid crystal composition of the present disclosure can be prepared according to a conventional method, e.g., being obtained by dissolving components with lower contents therein into main components with higher contents at a higher temperature, or dissolving the various components in an organic solvent, such as acetone, chloroform or methanol, and then mixing the solution, followed by the removal of the solvent.

The present disclosure further provides the use of the liquid crystal composition described above in liquid crystal display devices, preferably in VA, IPS or FFS mode displays.

Based on the technical solutions described above, the present disclosure has the following beneficial effects:
the liquid crystal composition of the present disclosure has a low rotary viscosity, a high elastic constant, large optical anisotropy, good low-temperature miscibility, and a fast response speed, and can be used for fast-response liquid crystal display of various display modes. The use of the liquid crystal composition of the present disclosure in VA, IPS or FFS mode displays can significantly improve the display effect of the liquid crystal displays, and the liquid crystal composition is especially suitable for IPS and FFS mode liquid crystal displays.

### DETAILED DESCRIPTION OF EMBODIMENTS

In order to make the objects, technical solutions and advantages of the present disclosure clearer, the technical solutions in the present disclosure will be described clearly and completely below. Apparently, the described embodiments are some of, rather than all of the embodiments of the present disclosure. On the basis of the embodiments of the present disclosure, all the other embodiments obtained by those of ordinary skill in the art without creative efforts shall fall within the scope of protection of the present disclosure.

Unless otherwise indicated, the percentage in the present disclosure is percentage by weight; the temperature unit is degrees Celsius; Δn represents optical anisotropy (25° C.); Δε represents dielectric anisotropy (25° C., 1000 Hz); γ1 represents rotary viscosity (mPa·s, 25° C.); Cp represents the clearing point (° C.) of the liquid crystal composition; K11, K22 and K33 represent splay, twist and bend elastic constants (pN, 25° C.), respectively.

In each of the following examples, the group structures in the liquid crystal compound are represented by the codes shown in Table 1.

TABLE 1
group structure code of liquid crystal compound

| Group | Code | Group name |
|---|---|---|
| 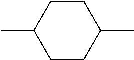 | C | 1,4-Cyclohexyl |
| 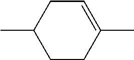 | L | 1,4-Cyclohexenyl |
| 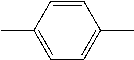 | P | 1,4-Phenylene |
| 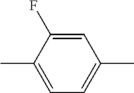 | GI | 3-Fluoro-1,4- phenylene |
| 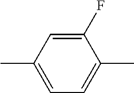 | G | 2-Fluoro-1,4- phenylene |
| 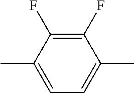 | W | 2,3-Difluoro-1,4- phenylene |
| 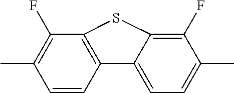 | S | 2,11-Difluoro-3,10- dibenzothiophene |
| —O— | O | Oxygen substituent |
| —F | F | Fluorine substituent |
| CₙH₂ₙ₊₁ or CₘH2ₘ₊₁ | n or m | Alkyl |
| —(CH₂)ₙ— | n | Alkylene |
| —C≡C— | T | Acetylenic bond |
| —HC═CH— | V | Alkenyl |

Taking the following compound structures as examples:

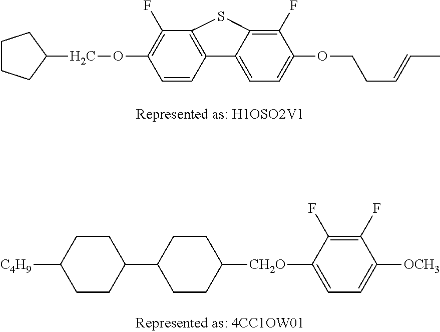

In each of the following examples, the liquid crystal compositions are all prepared by a thermal dissolution method, comprising the following steps of: weighing liquid crystal compounds in percentages by weight using a balance, wherein the order of weighing and addition is not particularly specified, and the weighing and mixing are generally carried out successively in order of the melting points of the liquid crystal compounds from high to low; heating and stirring same at 60-100° C. until the components are dissolved uniformly; then filtering same and finally performing encapsulation to obtain a target sample.

In each of the following examples, the percentages by weight of the components in the liquid crystal composition and the performance parameters of the liquid crystal composition are shown in the following tables.

### Example 1

TABLE 2
percentages by weight of components and performance
parameters of liquid crystal composition

| | Compound | Percentage by | Performance | Parameter |
|---|---|---|---|---|
| Category | code | weight (%) | parameter | value |
| I | H1OSO2V1 | 5 | Δn | 0.0998 |
| I | H1OSO2V | 10 | Δε | −3.80 |
| II | 3CCV | 20 | Cp | 115 |
| II | 3CCV1 | 4 | γ1 | 154.2 |
| II | 3CC2V1 | 6 | K11 | 25.42 |
| II | 5CC3 | 6 | K22 | 12.71 |
| III | 3CCP1 | 10 | K33 | 22.64 |
| III | 3CLP1 | 6 | | |
| IV | 3CC1OWO2 | 12 | | |
| V | 3CCWO2 | 11 | | |
| V | 3CLWO2 | 2 | | |
| V | 3CCWO1 | 6 | | |
| V | 2CLWO2 | 2 | | |

### Example 2

TABLE 3
percentages by weight of components and performance
parameters of liquid crystal composition

| | Compound | Percentage by | Performance | Parameter |
|---|---|---|---|---|
| Category | code | weight (%) | parameter | value |
| I | H1OSO2V1 | 5 | Δn | 0.0996 |
| I | H1OSO2V | 10 | Δε | −3.79 |
| II | 3CCV | 18 | Cp | 115 |
| II | 3CCV1 | 5 | γ1 | 155.4 |
| II | 3CC2V1 | 5 | K11 | 25.62 |
| II | 5CC3 | 8 | K22 | 12.81 |
| III | 3CCP1 | 10 | K33 | 22.94 |
| III | 3CLP1 | 6 | | |
| IV | 3CC1OWO2 | 12 | | |
| V | 3CCWO2 | 10 | | |
| V | 3CLWO2 | 2 | | |
| V | 3CCWO1 | 7 | | |
| V | 2CLWO2 | 2 | | |

### Example 3

TABLE 4
percentages by weight of components and performance
parameters of liquid crystal composition

| | Compound | Percentage by | Performance | Parameter |
|---|---|---|---|---|
| Category | code | weight (%) | parameter | value |
| I | H1OSO2V1 | 5 | Δn | 0.0999 |
| I | H1OSO2V | 9 | Δε | −3.78 |
| II | 3CCV | 18 | Cp | 114 |
| II | 3CCV1 | 4 | γ1 | 154.4 |
| II | 3CC2V1 | 6 | K11 | 25.40 |
| II | 5CC3 | 8 | K22 | 12.70 |
| III | 3CCP1 | 9 | K33 | 22.54 |
| III | 3CLP1 | 6 | | |
| IV | 3CC1OWO2 | 12 | | |
| V | 3CCWO2 | 8 | | |
| V | 3CLWO2 | 4 | | |
| V | 3CCWO1 | 7 | | |
| V | 2CLWO2 | 4 | | |

### Example 4

TABLE 5
percentages by weight of components and performance
parameters of liquid crystal composition

| | Compound | Percentage by | Performance | Parameter |
|---|---|---|---|---|
| Category | code | weight (%) | parameter | value |
| I | H1OSO2V1 | 5 | Δn | 0.0996 |
| I | H1OSO2V | 9 | Δε | −3.79 |
| II | 3CCV | 16 | Cp | 115 |
| II | 3CCV1 | 4 | γ1 | 150.2 |
| II | 3CC2V1 | 6 | K11 | 26.35 |
| II | 5CC3 | 10 | K22 | 13.18 |
| III | 3CCP1 | 9.5 | K33 | 24.67 |
| III | 3CLP1 | 5.5 | | |
| IV | 3CC1OWO2 | 12 | | |
| V | 3CCWO2 | 8 | | |
| V | 3CLWO2 | 4 | | |
| V | 3CCWO1 | 7 | | |
| V | 2CLWO2 | 4 | | |

### Example 5

TABLE 6
percentages by weight of components and performance
parameters of liquid crystal composition

| | Compound | Percentage by | Performance | Parameter |
|---|---|---|---|---|
| Category | code | weight (%) | parameter | value |
| I | H1OSO2V1 | 5 | Δn | 0.1004 |
| I | H1OSO2V | 9 | Δε | −3.77 |
| II | 3CCV | 18 | Cp | 115 |
| II | 3CCV1 | 4 | γ1 | 158.9 |
| II | 3CC2V1 | 6 | K11 | 25.57 |
| II | 5CC3 | 8 | K22 | 12.79 |
| III | 3CCP1 | 7 | K33 | 22.74 |
| III | 3CLP1 | 8 | | |
| IV | 3CC1OWO2 | 12 | | |
| V | 3CCWO2 | 11 | | |
| V | 3CLWO2 | 4 | | |
| V | 3CCWO1 | 6 | | |
| V | 2CLWO2 | 2 | | |

### Example 6

TABLE 7
percentages by weight of components and performance
parameters of liquid crystal composition

| | Compound | Percentage by | Performance | Parameter |
|---|---|---|---|---|
| Category | code | weight (%) | parameter | value |
| I | H1OSO2V1 | 4 | Δn | 0.0994 |
| I | H1OSO2V | 9 | Δε | −3.62 |
| II | 3CCV | 18 | Cp | 116 |
| II | 3CCV1 | 4 | γ1 | 156.4 |
| II | 3CC2V1 | 6 | K11 | 25.90 |
| II | 5CC3 | 8 | K22 | 12.95 |
| III | 3CCP1 | 7 | K33 | 22.90 |
| III | 3CLP1 | 9 | | |
| IV | 3CC1OWO2 | 12 | | |
| V | 3CCWO2 | 11 | | |
| V | 3CLWO2 | 4 | | |
| V | 3CCWO1 | 6 | | |
| V | 2CLWO2 | 2 | | |

### Example 7

TABLE 8
percentages by weight of components and performance
parameters of liquid crystal composition

| | Compound | Percentage by | Performance | Parameter |
|---|---|---|---|---|
| Category | code | weight (%) | parameter | value |
| I | H1OSO2V1 | 4 | Δn | 0.0995 |
| I | H1OSO2V | 9 | Δε | −3.64 |
| II | 3CCV | 18 | Cp | 116 |
| II | 3CCV1 | 4 | γ1 | 156.1 |
| II | 3CC2V1 | 6 | K11 | 25.63 |
| II | 5CC3 | 8 | K22 | 12.81 |
| III | 3CCP1 | 5 | K33 | 23.04 |
| III | 3CCP3 | 3 | | |
| III | 3CLP1 | 8 | | |
| IV | 3CC1OWO2 | 12 | | |
| V | 3CCWO2 | 11 | | |
| V | 3CLWO2 | 4 | | |
| V | 3CCWO1 | 6 | | |
| V | 2CLWO2 | 2 | | |

### Example 8

TABLE 9
percentages by weight of components and performance
parameters of liquid crystal composition

| | Compound | Percentage by | Performance | Parameter |
|---|---|---|---|---|
| Category | code | weight (%) | parameter | value |
| I | H1OSO2V1 | 4 | Δn | 0.0989 |
| I | H1OSO2V | 9 | Δε | −3.59 |
| II | 3CCV | 18 | Cp | 116 |
| II | 3CC2V1 | 6 | γ1 | 159.1 |
| II | 5CC3 | 8 | K11 | 25.59 |
| II | 3CCV1 | 4 | K22 | 12.80 |
| III | 3CLP1 | 8 | K33 | 22.07 |
| III | 3CCP3 | 3 | | |
| III | 3CCP1 | 5 | | |
| IV | 3CC1OWO2 | 9 | | |
| IV | 5CC1OWO2 | 4 | | |
| V | 3CCWO2 | 10 | | |
| V | 3CCWO3 | 6 | | |
| V | 3CCWO1 | 6 | | |

### Example 9

TABLE 10
percentages by weight of components and performance
parameters of liquid crystal composition

| | Compound | Percentage by | Performance | Parameter |
|---|---|---|---|---|
| Category | code | weight (%) | parameter | value |
| I | H1OSO2V1 | 4 | Δn | 0.0985 |
| II | 3CCV | 18 | Δε | −3.75 |
| II | 3CC2V1 | 6 | Cp | 120 |
| II | 5CC3 | 4 | γ1 | 162.6 |
| III | 3CCP1 | 9 | K11 | 25.08 |
| III | 3CCP3 | 4 | K22 | 12.54 |
| III | 3CLP1 | 5 | K33 | 23.41 |
| IV | 3CC1OWO2 | 11 | | |
| IV | 3C1OWO2 | 6 | | |
| V | 2CCWO2 | 4 | | |
| V | 3CCWO2 | 10 | | |
| V | 5PPWO2 | 1.5 | | |
| V | 3CCWO1 | 8 | | |
| V | 3CLWO3 | 4 | | |
| V | 3CLWO2 | 4 | | |
| V | 3PPWO4 | 1.5 | | |

### Example 10

TABLE 11
percentages by weight of components and performance
parameters of liquid crystal composition

| | Compound | Percentage by | Performance | Parameter |
|---|---|---|---|---|
| Category | code | weight (%) | parameter | value |
| I | H1OSO2V1 | 4 | Δn | 0.1000 |
| I | H1OSO2V | 8 | Δε | −3.68 |
| II | 3CCV | 21 | Cp | 110 |
| II | 3CC2V1 | 5 | γ1 | 163.8 |
| II | 5CC3 | 5 | K11 | 24.24 |
| III | 3CCP1 | 10 | K22 | 12.12 |
| III | 3CCP3 | 6 | K33 | 22.06 |
| III | 3CLP1 | 6 | | |
| IV | 2CC1OWO2 | 10 | | |
| IV | 3CC1OWO2 | 10 | | |
| IV | 3C1OWO2 | 1 | | |
| V | 3PPWO4 | 2 | | |
| VI | 3CC2WO2 | 12 | | |

### Example 11

TABLE 12
percentages by weight of components and performance
parameters of liquid crystal composition

| | Compound | Percentage by | Performance | Parameter |
|---|---|---|---|---|
| Category | code | weight (%) | parameter | value |
| I | H1OSO2V | 8 | Δn | 0.0986 |
| I | HOSO2V1 | 3 | Δε | −3.70 |
| I | H1OSO2V1 | 4 | Cp | 110 |
| II | 3CCV | 20 | γ1 | 145.6 |
| II | 3CC2V1 | 8 | K11 | 24.68 |
| II | 5CC3 | 7 | K22 | 12.34 |
| III | 3CCP1 | 9 | K33 | 21.06 |
| III | 3CCP3 | 6 | | |
| III | 3CLP1 | 5 | | |
| IV | 2CC1OWO2 | 9 | | |
| IV | 3CC1OWO2 | 10 | | |
| V | 3CCWO2 | 5 | | |
| V | 4CLWO2 | 6 | | |

### Example 12

TABLE 13
percentages by weight of components and performance
parameters of liquid crystal composition

| | Compound | Percentage by | Performance | Parameter |
|---|---|---|---|---|
| Category | code | weight (%) | parameter | value |
| I | H1OSO2V1 | 4 | Δn | 0.0995 |
| I | H1OSO2V | 9 | Δε | −3.41 |
| II | 3CCV | 20 | Cp | 114 |
| II | 3CC2V1 | 6 | γ1 | 143.0 |
| II | 5CC3 | 8 | K11 | 25.26 |
| II | 3CCV1 | 3 | K22 | 12.63 |
| III | 3CLP1 | 8 | K33 | 22.02 |
| III | 3CCP1 | 10 | | |
| IV | 3CC1OWO2 | 11 | | |
| V | 3CCWO2 | 7 | | |
| V | 3CCWO1 | 4 | | |
| V | 3CLWO2 | 4 | | |
| V | 2CLWO2 | 4 | | |
| V | 3CLWO3 | 2 | | |

### Example 13

TABLE 14
percentages by weight of components and performance
parameters of liquid crystal composition

| | Compound | Percentage by | Performance | Parameter |
|---|---|---|---|---|
| Category | code | weight (%) | parameter | value |
| I | H1OSO2V1 | 4 | Δn | 0.0999 |
| I | H1OSO2V | 9 | Δε | −3.42 |
| II | 3CCV | 20 | Cp | 113 |
| II | 3CC2V1 | 6 | γ1 | 145.0 |
| II | 5CC3 | 6 | K11 | 25.38 |
| II | 3CCV1 | 5 | K22 | 12.69 |
| III | 3CLP1 | 9 | K33 | 22.32 |
| III | 3CCP1 | 9 | | |
| IV | 3CC1OWO2 | 11 | | |
| V | 3CCWO2 | 8 | | |
| V | 3CCWO1 | 3 | | |
| V | 3CLWO2 | 5 | | |
| V | 2CLWO2 | 3 | | |
| V | 3CLWO3 | 2 | | |

### Example 14

TABLE 15
percentages by weight of components and performance
parameters of liquid crystal composition

| | Compound | Percentage by | Performance | Parameter |
|---|---|---|---|---|
| Category | code | weight (%) | parameter | value |
| I | H1OSO2V1 | 4 | Δn | 0.0991 |
| I | H1OSO2V | 9 | Δε | −3.46 |
| II | 3CCV | 20 | Cp | 114 |
| II | 3CC2V1 | 6 | γ1 | 144.0 |
| II | 5CC3 | 8 | K11 | 25.46 |
| II | 3CCV1 | 3.5 | K22 | 12.73 |
| III | 3CLP1 | 8 | K33 | 22.22 |
| III | 3CCP1 | 8 | | |
| IV | 3CC1OWO2 | 11 | | |
| V | 3CCWO2 | 8.5 | | |
| V | 3CCWO1 | 4 | | |
| V | 3CLWO2 | 4 | | |
| V | 2CLWO2 | 4 | | |
| V | 3CLWO3 | 2 | | |

### Example 15

TABLE 16
percentages by weight of components and performance
parameters of liquid crystal composition

| | Compound | Percentage by | Performance | Parameter |
|---|---|---|---|---|
| Category | code | weight (%) | parameter | value |
| I | H1OSO2V1 | 4 | Δn | 0.0994 |
| I | H1OSO2V | 9 | Δε | −3.30 |
| II | 3CCV | 20 | Cp | 114 |
| II | 3CC2V1 | 8 | γ1 | 146.4 |
| II | 5CC3 | 10 | K11 | 25.24 |
| III | 3CLP1 | 8 | K22 | 12.62 |
| III | 3CCP1 | 9 | K33 | 22.11 |
| IV | 3CC1OWO2 | 12 | | |
| V | 3CCWO2 | 10 | | |
| V | 3CCWO1 | 8 | | |
| V | 3PPWO4 | 2 | | |

### Example 16

TABLE 17
percentages by weight of components and performance
parameters of liquid crystal composition

| | Compound | Percentage by | Performance | Parameter |
|---|---|---|---|---|
| Category | code | weight (%) | parameter | value |
| I | H1OSO2V1 | 4 | Δn | 0.1000 |
| I | H1OSO2V | 9 | Δε | −3.25 |
| II | 3CCV | 20 | Cp | 114 |
| II | 3CC2V1 | 8 | γ1 | 147.2 |
| II | 5CC3 | 10 | K11 | 25.70 |
| III | 3CLP1 | 9 | K22 | 12.85 |
| III | 3CCP1 | 8 | K33 | 22.30 |
| IV | 3CC1OWO2 | 11 | | |
| V | 3CCWO2 | 10 | | |
| V | 3CCWO1 | 7 | | |
| V | 5CCWO2 | 2 | | |
| V | 3PPWO4 | 2 | | |

### Example 17

TABLE 18
percentages by weight of components and performance
parameters of liquid crystal composition

| | Compound | Percentage by | Performance | Parameter |
|---|---|---|---|---|
| Category | code | weight (%) | parameter | value |
| I | H1OSO2V1 | 4 | Δn | 0.0992 |
| I | H1OSO2V | 9 | Δε | −3.26 |
| II | 3CCV | 20 | Cp | 114 |
| II | 3CC2V1 | 8 | γ1 | 144.4 |
| II | 5CC3 | 10 | K11 | 25.44 |
| III | 3CLP1 | 8 | K22 | 12.72 |
| III | 3CCP3 | 3 | K33 | 22.39 |
| III | 3CCP1 | 6 | | |
| IV | 3CC1OWO2 | 11 | | |
| V | 3CCWO2 | 10 | | |
| V | 3CCWO1 | 7 | | |
| V | 5CCWO2 | 2 | | |
| V | 3PPWO4 | 2 | | |

### Example 18

TABLE 19
percentages by weight of components and performance
parameters of liquid crystal composition

| | Compound | Percentage by | Performance | Parameter |
|---|---|---|---|---|
| Category | code | weight (%) | parameter | value |
| I | H1OSO2V1 | 4 | Δn | 0.0987 |
| I | H1OSO2V | 9 | Δε | −3.18 |
| II | 3CCV | 20 | Cp | 115 |
| II | 3CC2V1 | 8 | γ1 | 147.1 |
| II | 5CC3 | 10 | K11 | 24.95 |
| III | 3CLP1 | 8 | K22 | 12.47 |
| III | 3CPP1 | 3 | K33 | 22.13 |
| III | 3CCP1 | 6 | | |
| IV | 3CC1OWO2 | 9 | | |
| V | 3CCWO2 | 10 | | |
| V | 3CCWO1 | 8 | | |
| V | 5CCWO2 | 5 | | |

### Example 19

TABLE 20
percentages by weight of components and performance
parameters of liquid crystal composition

| | Compound | Percentage by | Performance | Parameter |
|---|---|---|---|---|
| Category | code | weight (%) | parameter | value |
| I | H1OSO2V1 | 4 | Δn | 0.0991 |
| I | H1OSO2V | 9 | Δε | −3.13 |
| II | 3CCV | 20 | Cp | 114 |
| II | 3CC2V1 | 8 | γ1 | 143.9 |
| II | 5CC3 | 10 | K11 | 25.80 |
| III | 3CLP1 | 8 | K22 | 12.90 |
| III | 3CCP3 | 3 | K33 | 22.68 |
| III | 3CCP1 | 7 | | |
| IV | 3CC1OWO2 | 10.5 | | |
| V | 3CCWO2 | 9 | | |
| V | 3CCWO1 | 6 | | |
| V | 5CCWO2 | 3.5 | | |
| V | 3PPWO4 | 2 | | |

### Example 20

TABLE 21
percentages by weight of components and performance
parameters of liquid crystal composition

| | Compound | Percentage by | Performance | Parameter |
|---|---|---|---|---|
| Category | code | weight (%) | parameter | value |
| I | H1OSO2V1 | 4 | Δn | 0.1015 |
| I | H1OSO2V | 8 | Δε | −3.43 |
| II | 3CCV | 22 | Cp | 110 |
| II | 3CC2V1 | 6 | γ1 | 153.4 |
| II | 5CC3 | 6 | K11 | 24.30 |
| III | 3CCP1 | 9 | K22 | 12.15 |
| III | 3CCP3 | 4 | K33 | 22.36 |
| III | 3CLP1 | 5 | | |
| IV | 3CC1OWO2 | 10 | | |
| IV | 3C1OWO2 | 3 | | |
| V | 3PPWO4 | 2 | | |
| V | 5PPWO2 | 2 | | |
| VI | 2CC2WO2 | 9 | | |
| VI | 3CC2WO2 | 10 | | |

### Example 21

TABLE 22
percentages by weight of components and performance
parameters of liquid crystal composition

| | Compound | Percentage by | Performance | Parameter |
|---|---|---|---|---|
| Category | code | weight (%) | parameter | value |
| I | H1OSO2V1 | 4 | Δn | 0.0992 |
| I | H1OSO2V | 9 | Δε | −3.19 |
| II | 3CCV | 20 | Cp | 114 |
| II | 3CC2V1 | 8 | γ1 | 144.0 |
| II | 5CC3 | 10 | K11 | 25.94 |
| III | 3CLP1 | 8 | K22 | 12.97 |
| III | 3CCP3 | 3 | K33 | 22.68 |
| III | 3CCP1 | 6 | | |
| IV | 3CC1OWO2 | 9 | | |
| V | 3CCWO2 | 10 | | |
| V | 3CCWO1 | 6 | | |
| V | 5CCWO2 | 5 | | |
| V | 3PPWO4 | 2 | | |

### Example 22

TABLE 23
percentages by weight of components and performance
parameters of liquid crystal composition

| | Compound | Percentage by | Performance | Parameter |
|---|---|---|---|---|
| Category | code | weight (%) | parameter | value |
| I | HOSO2V1 | 3 | Δn | 0.1006 |
| I | H1OSO2V1 | 4 | Δε | −3.22 |
| I | H1OSO2V | 9 | Cp | 110 |
| II | 3CCV | 17 | γ1 | 154.8 |
| II | 3CCV1 | 5 | K11 | 25.74 |
| II | 3CC2V1 | 6 | K22 | 12.87 |
| II | 5CC3 | 10 | K33 | 22.58 |
| III | 3CCP1 | 6 | | |
| III | 3CLP1 | 6 | | |
| III | 5CLP1 | 6 | | |
| IV | 3CC1OWO2 | 8 | | |
| VI | 2CC2WO2 | 8 | | |
| VI | 3CC2WO2 | 12 | | |

### Example 23

TABLE 24
percentages by weight of components and performance
parameters of liquid crystal composition

| | Compound | Percentage by | Performance | Parameter |
|---|---|---|---|---|
| Category | code | weight (%) | parameter | value |
| I | H1OSO2V1 | 4 | Δn | 0.1007 |
| I | H1OSO2V | 9 | Δε | −3.32 |
| I | HOSO2V1 | 4 | Cp | 110 |
| II | 3CCV | 18.5 | γ1 | 148.7 |
| II | 3CCV1 | 5 | K11 | 25.78 |
| II | 3CC2V1 | 6 | K22 | 12.89 |
| II | 5CC3 | 8 | K33 | 22.32 |
| III | 3CLP1 | 6 | | |
| III | 5CLP1 | 6 | | |
| III | 3CCP1 | 6 | | |
| IV | 3CC1OWO2 | 8.5 | | |
| VI | 2CC2WO2 | 7 | | |
| VI | 3CC2WO2 | 12 | | |

### Example 24

TABLE 25
percentages by weight of components and performance
parameters of liquid crystal composition

| | Compound | Percentage by | Performance | Parameter |
|---|---|---|---|---|
| Category | code | weight (%) | parameter | value |
| I | H1OSO2V1 | 4 | Δn | 0.1000 |
| I | H1OSO2V | 9 | Δε | −3.34 |
| I | HOSO2V1 | 4 | Cp | 108 |
| II | 3CCV | 20 | γ1 | 142.7 |
| II | 3CCV1 | 5 | K11 | 25.00 |
| II | 3CC2V1 | 6 | K22 | 12.50 |
| II | 5CC3 | 8 | K33 | 21.62 |
| III | 3CLP1 | 6 | | |
| III | 5CLP1 | 6 | | |
| III | 3CCP1 | 4 | | |
| IV | 3CC1OWO2 | 9 | | |
| VI | 2CC2WO2 | 7 | | |
| VI | 3CC2WO2 | 12 | | |

### Comparative Example 1

TABLE 26
percentages by weight of components and performance
parameters of liquid crystal composition

| Compound | Percentage | Performance | Parameter |
|---|---|---|---|
| code | by weight (%) | parameter | value |
| 3CCWO1 | 8 | Δn | 0.0998 |
| 3CCV | 23 | Δε | −3.77 |
| 5CWO2 | 8 | Cp | 114 |
| 3CWO2 | 4 | γ1 | 160.7 |
| 3CCWO2 | 8 | K11 | 18.96 |
| VCCWO1 | 8 | K22 | 9.48 |
| 2CCWO2 | 8 | K33 | 21.20 |
| 3CLP1 | 6 | | |
| 3CLWO3 | 3.5 | | |
| 2PGIWO4 | 2 | | |
| VCCWO2 | 9 | | |
| 3CCP1 | 4.5 | | |
| 3CPP1 | 6 | | |
| 3CPWO2 | 2 | | |

### Comparative Example 2

TABLE 27
percentages by weight of components and performance
parameters of liquid crystal composition

| Compound | Percentage | Performance | Parameter |
|---|---|---|---|
| code | by weight (%) | parameter | value |
| 3CCWO1 | 8 | Δn | 0.0998 |
| 3CCV | 22 | Δε | −3.41 |
| 5CWO2 | 2 | Cp | 113 |
| 3CWO2 | 10 | γ1 | 147.3 |
| 3CCWO2 | 8.5 | K11 | 18.52 |
| VCCWO1 | 8 | K22 | 9.26 |
| 2CCWO2 | 8 | K33 | 20.72 |
| 3CLP1 | 6 | | |
| 2PGIWO4 | 2 | | |
| VCCWO2 | 9 | | |
| 3CCP1 | 10.5 | | |
| 3CPP1 | 6 | | |

By comparison, it can be seen that the examples of the present application have a better display effect than the comparative examples; for example, the values of the performance parameters of the liquid crystal compositions obtained in Example 1 and Comparative Example 1, and Example 12 and Comparative Example 2 are compared, and reference can be made to Table 28.

TABLE 28
comparison of performance parameters
of liquid crystal compositions

| | Cp | Δn | Δε | K11 | γ1 |
|---|---|---|---|---|---|
| Example 1 | 115 | 0.0998 | −3.80 | 25.42 | 154.2 |
| Comparative | 114 | 0.0998 | −3.77 | 18.96 | 160.7 |
| Example 1 | | | | | |
| Example 12 | 114 | 0.0995 | −3.41 | 25.26 | 143.0 |
| Comparative | 113 | 0.0998 | −3.41 | 18.52 | 147.3 |
| Example 2 | | | | | |

Upon comparison, it can be seen that the comparison between Example 1 and Comparative Example 1, and Example 12 and Comparative Example 2 reveals that the dielectric anisotropy (Δε), clearing point (Cp), optical anisotropy (Δn) and rotary viscosity (71) of the liquid crystal mixtures are substantially the same. On this basis, the liquid crystal mixtures provided in Examples 1 and 12 exhibit a higher elastic constant (K11), indicating that, under similar driving voltage and other conditions, the liquid crystals provided by the present disclosure have a higher contrast ratio and a faster response speed.

Relative to Examples 1 and 12, the amount of the compound represented by general formula I is reduced in Comparative Examples 1 and 2, and Examples 1 and 12 have higher elastic constants than Comparative Examples 1 and 2, thus indicating that there is a synergistic relationship among the components in the liquid crystal composition, and the compound of general formula I is one of the essential components of the liquid crystal composition provided by the present disclosure.

As can be seen from the above examples, the liquid crystal composition provided by the present disclosure has a high elastic constant, high resistivity, suitable optical anisotropy, good low-temperature miscibility, low rotary viscosity and excellent light stability and thermal stability, and can reduce the response time of the liquid crystal display, thereby solving the problem of slow response speed of the liquid crystal display. Therefore, the liquid crystal compositions provided by the present disclosure are suitable for fast-response VA, IPS and FFS mode TFT liquid crystal display devices, especially for IPS and FFS liquid crystal display devices.

It should be finally noted that the above embodiments are merely used for illustrating rather than limiting the technical solution of the present disclosure; although the present disclosure is illustrated in detail with reference to the foregoing embodiments, persons of ordinary skill in the art should understand that they can still make modifications to the technical solution recorded in the foregoing embodiments or make equivalent replacements for some of the technical features thereof; and the modifications or substitutions do not make the essence of the corresponding technical solutions depart from the spirit and scope of the technical solutions of the embodiments of the present disclosure.

### INDUSTRIAL APPLICABILITY

In the liquid crystal composition provided by the present disclosure, the compound represented by general formula I is a compound containing dibenzothiophene, which has a high dielectric constant and a low rotary viscosity; the compound represented by general formula II is a bicyclohexane compound, which has a low rotary viscosity and excellent miscibility characteristics, and is an essential component for a fast-response liquid crystal display; the compound of general formula III is a tricyclic neutral compound, which has a high clearing point and can effectively increase the clearing point of the liquid crystal composition; the compound represented by general formula IV is a methoxy-bridged dielectric anisotropic compound, which has large dielectric anisotropy and can effectively reduce the driving voltage of the liquid crystal panel; and the compound of general formula V is a negative compound; when added to the liquid crystal composition, the compound is helpful to cooperate with the compounds represented by general formulas I-IV of the present disclosure and can further improve the dielectric anisotropy of the liquid crystal composition. Therefore, the liquid crystal composition of the present disclosure has a low rotary viscosity, a high elastic constant, large optical anisotropy, good low-temperature miscibility and a high response speed, and is suitable for fast-response VA, IPS and FFS mode TFT liquid crystal display devices, especially for IPS and FFS liquid crystal display devices.

1. A liquid crystal composition, comprising at least one or more compounds represented by general formula I, one or more compounds represented by general formula II, and one or more compounds represented by general formula III, wherein
the compound represented by general formula I has the following structure: 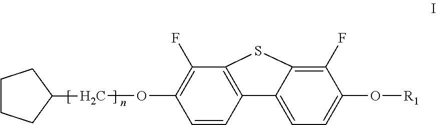
wherein in the general formula I, R₁ represents an alkyl group having 1-7 carbon atoms, or an alkenyl group having 2-7 carbon atoms, and n represents 0, 1 or 2;
the compound represented by general formula II has the following structure: 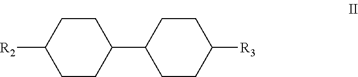
wherein in the general formula II, R₂ and R₃ each independently represent an alkyl group having 1-7 carbon atoms, an alkoxy group having 1-7 carbon atoms, or an alkenyl group having 2-7 carbon atoms; and
the compound represented by general formula III has the following structure: 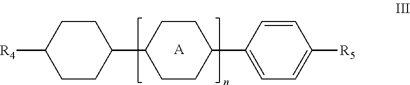
wherein in the general formula III, R₄ and R₅ each independently represent an alkyl group having 1-7 carbon atoms, an alkoxy group having 1-7 carbon atoms, or an alkenyl group having 2-7 carbon atoms, n represents 1 or 2, and 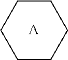
represents one or more of

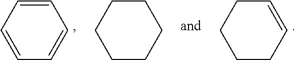

2. The liquid crystal composition according to claim 1, wherein the compound represented by general formula I is selected from one or more of the compounds represented by formulas IA1-IA10 and IB1-IB10:

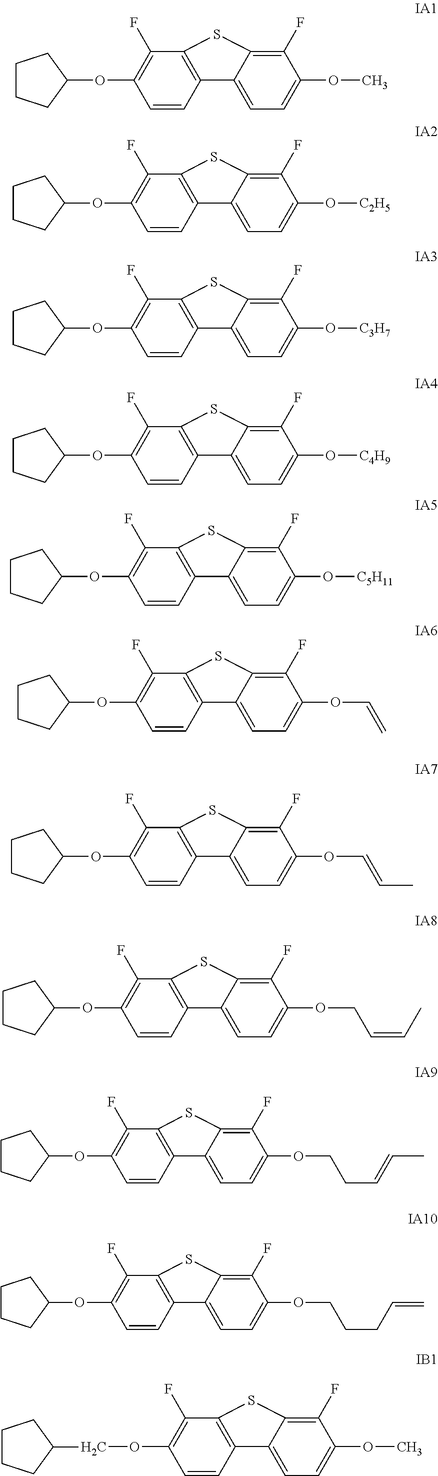

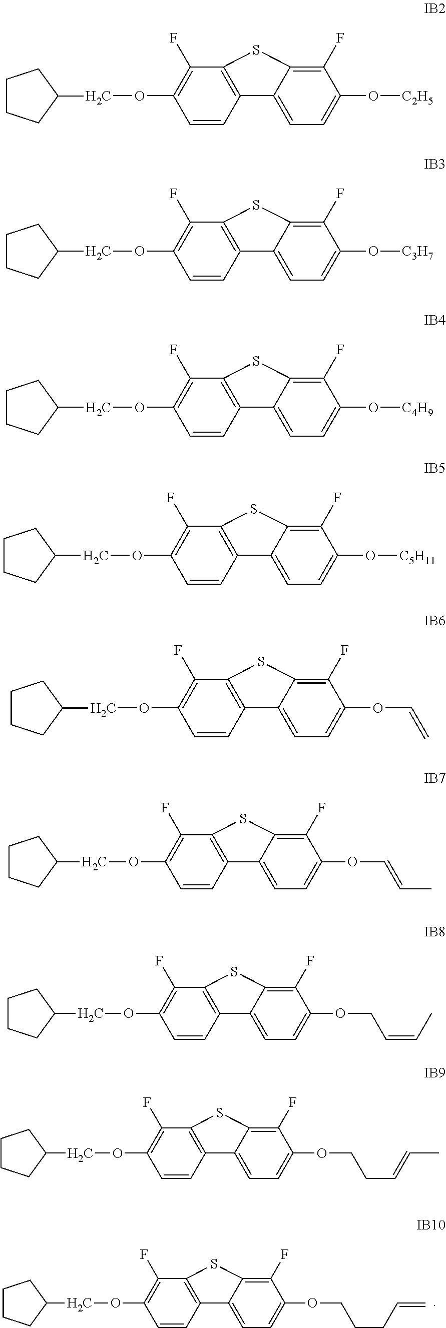

3. The liquid crystal composition according to claim 1, wherein the compound represented by the general formula II is selected from one or more of the compounds represented by IIA1-IIA12, IIB1-IIB14, and IIC1-IIC4;

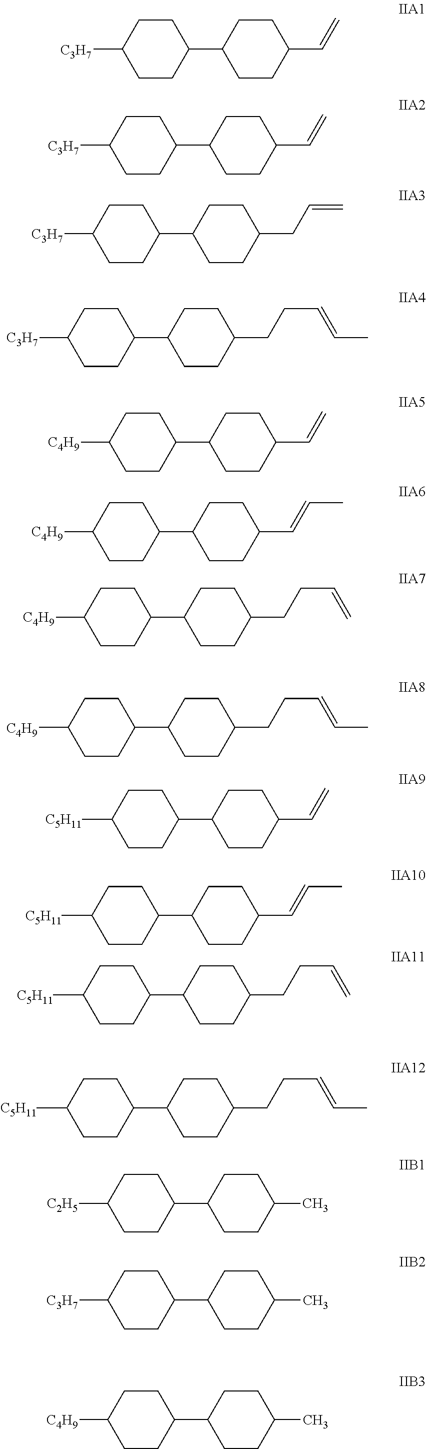

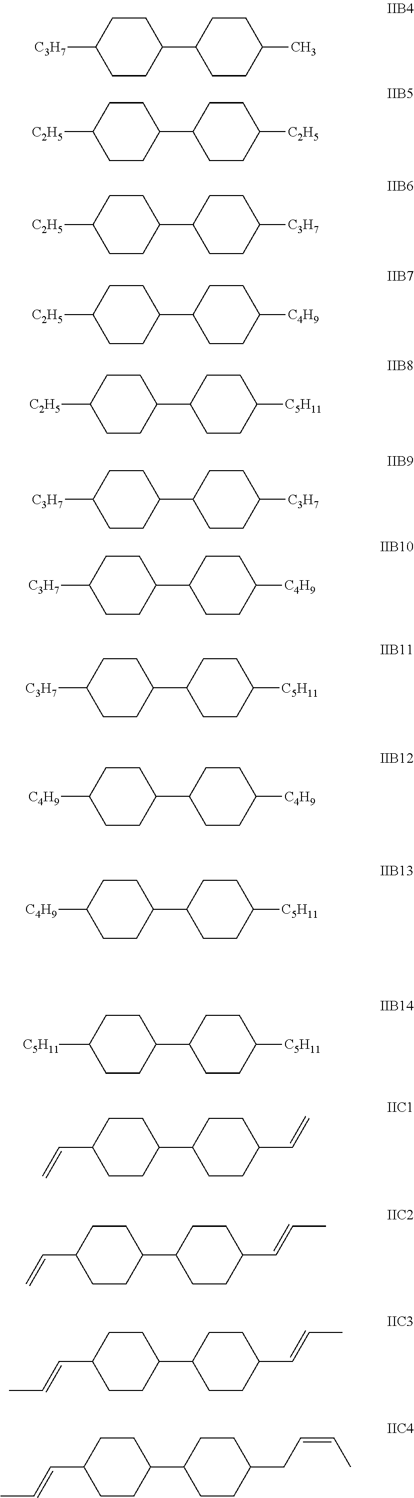

4. The liquid crystal composition according to claim 1, wherein the compound represented by general formula III is selected from one or more of the compounds represented by IIIA1-IIIA48, IIIB1-IIIB48, and IIIC1-IIIC48:

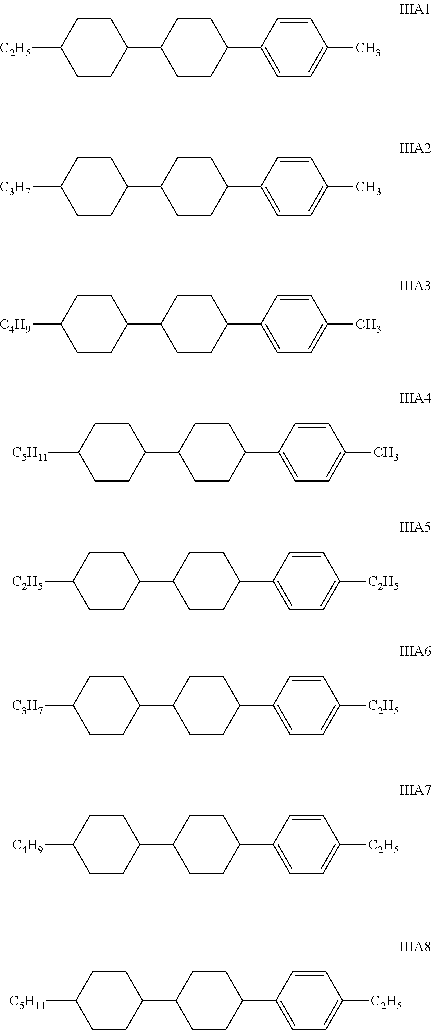

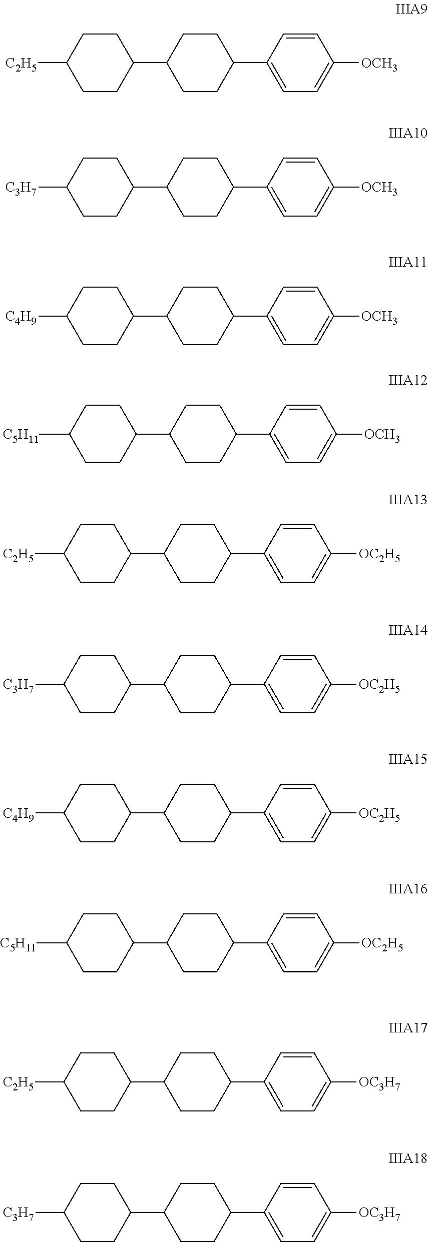

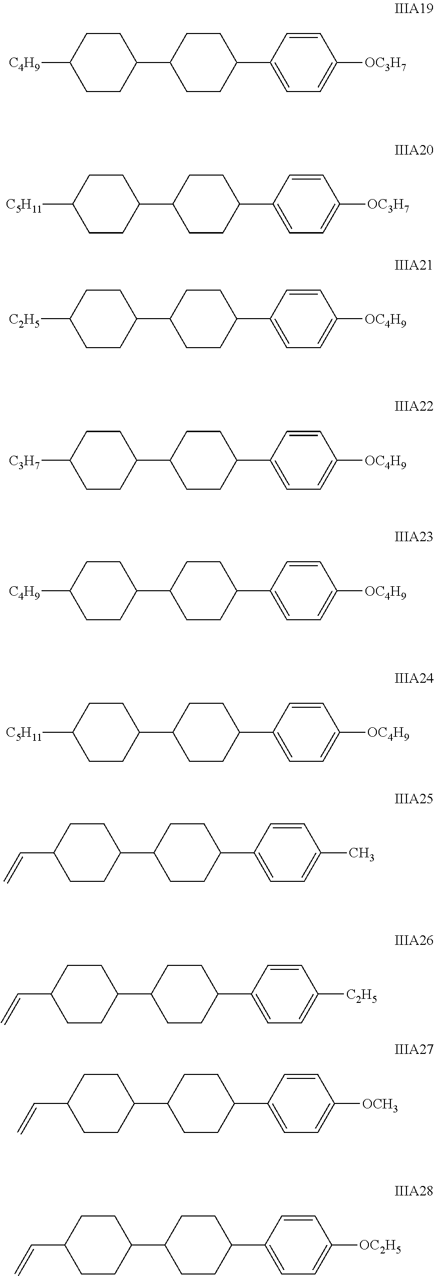

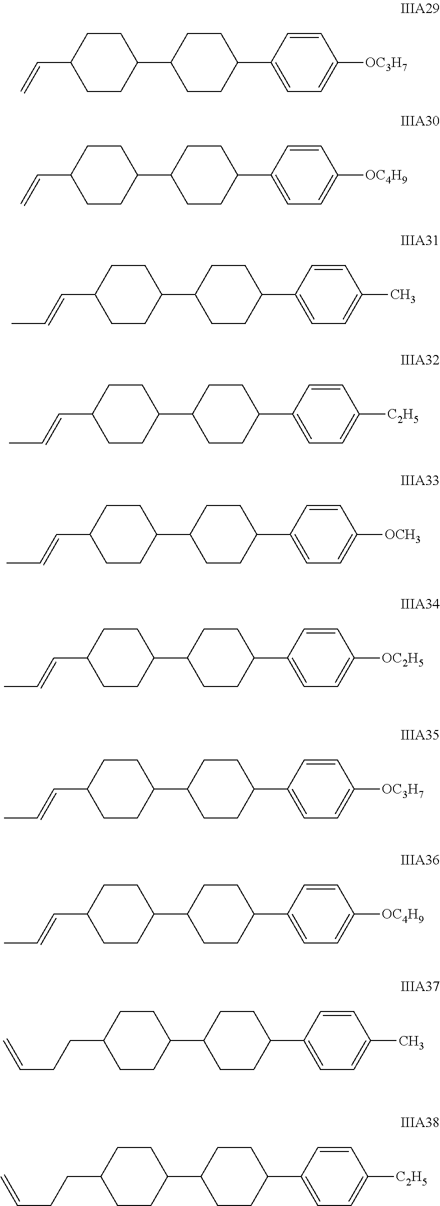

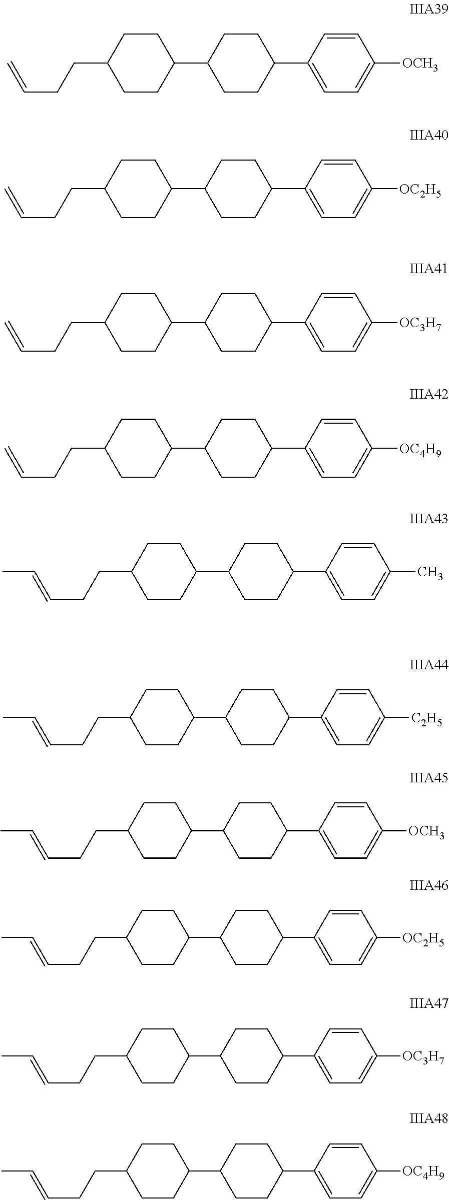

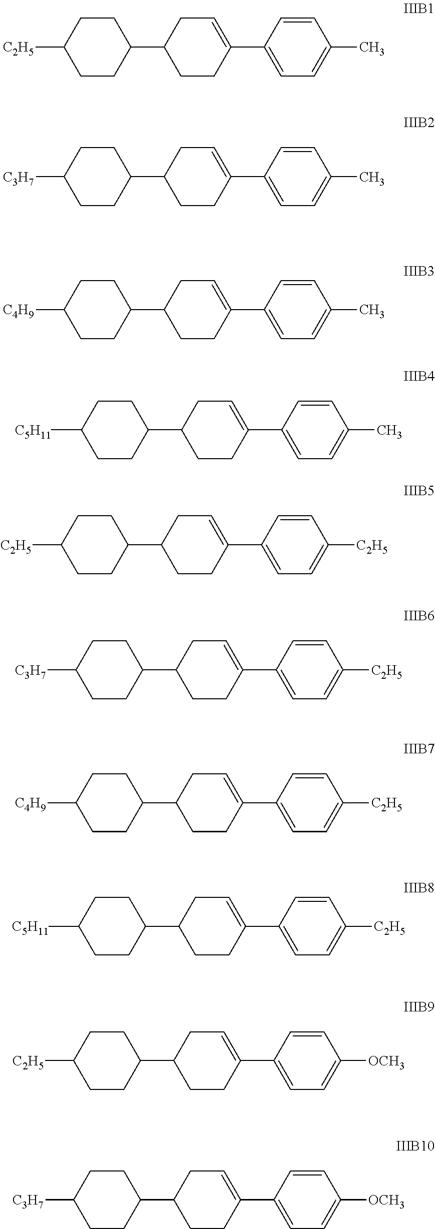

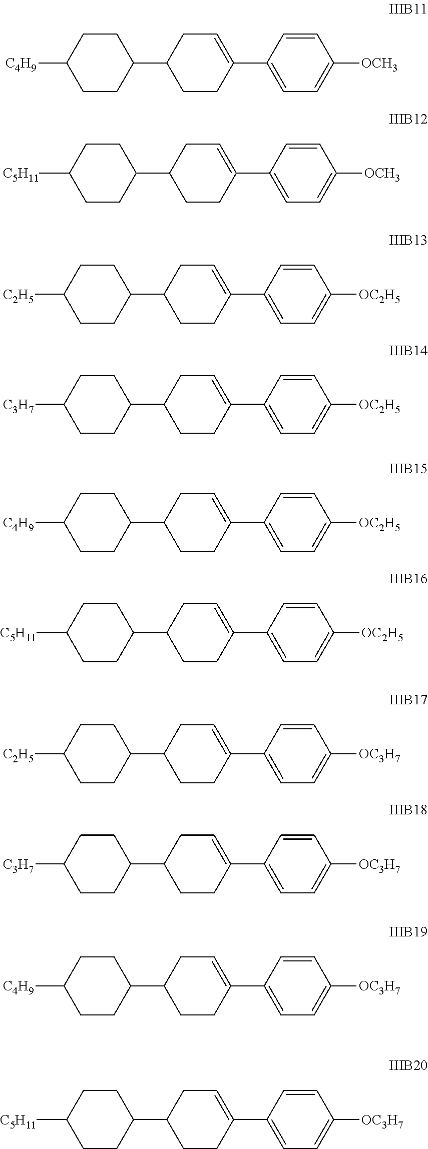

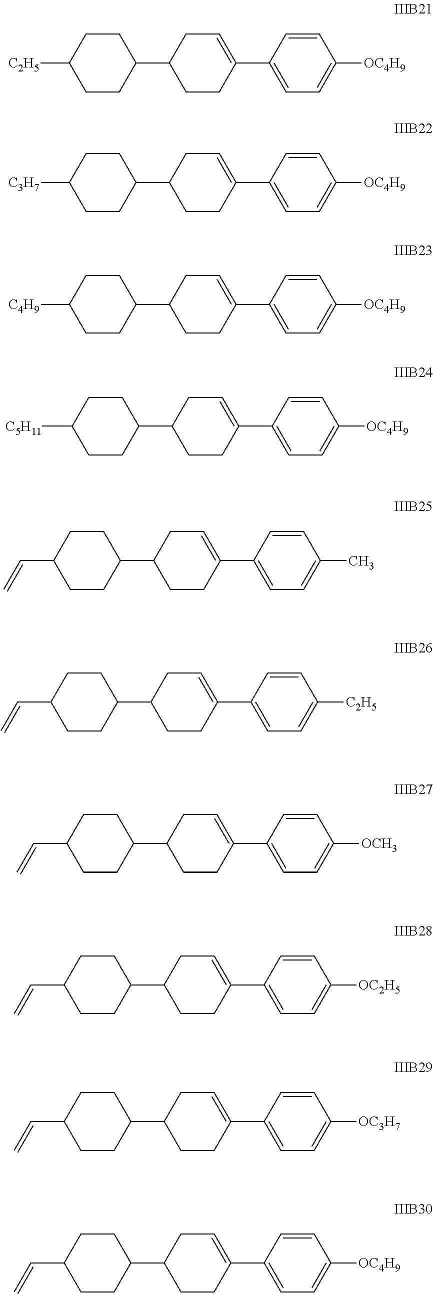

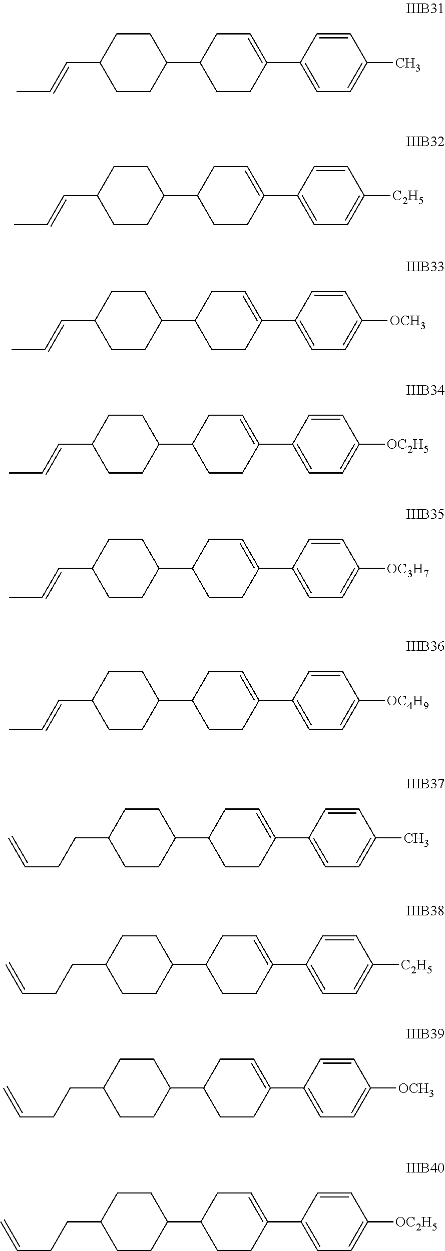

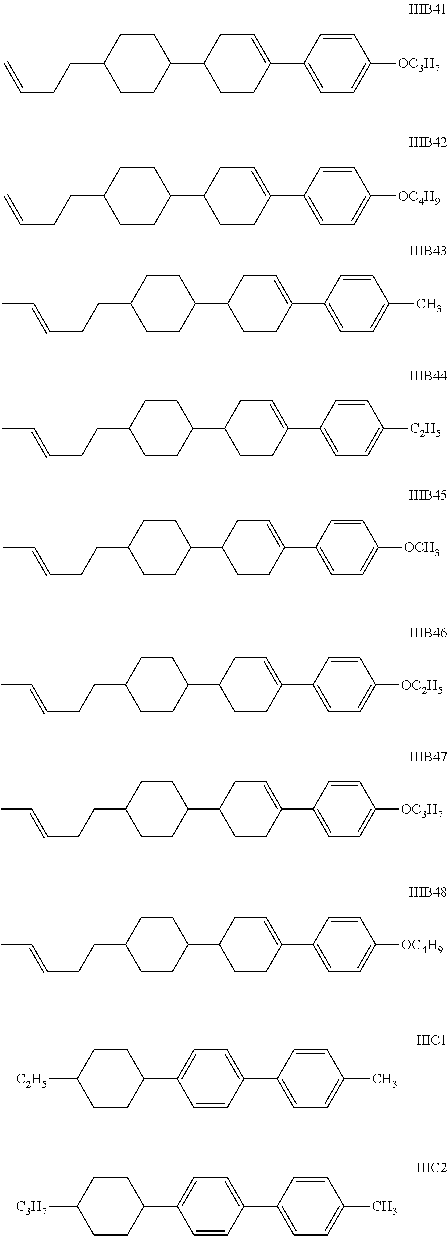

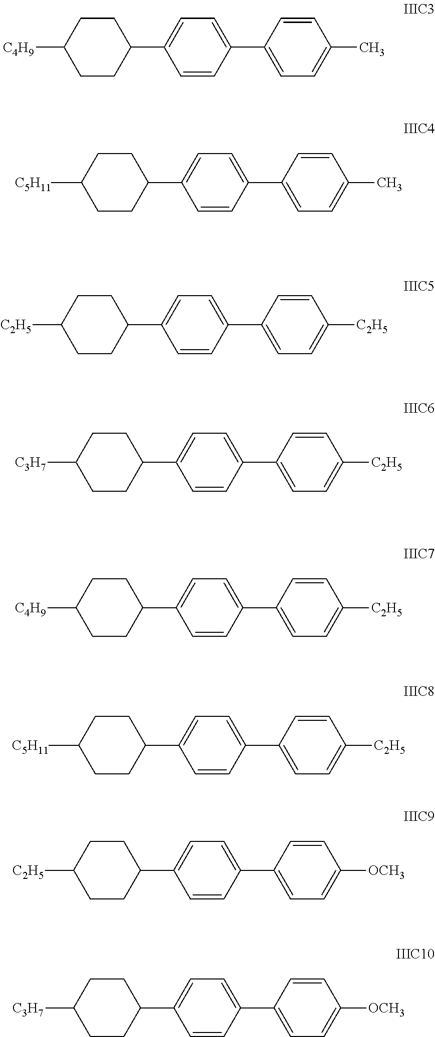

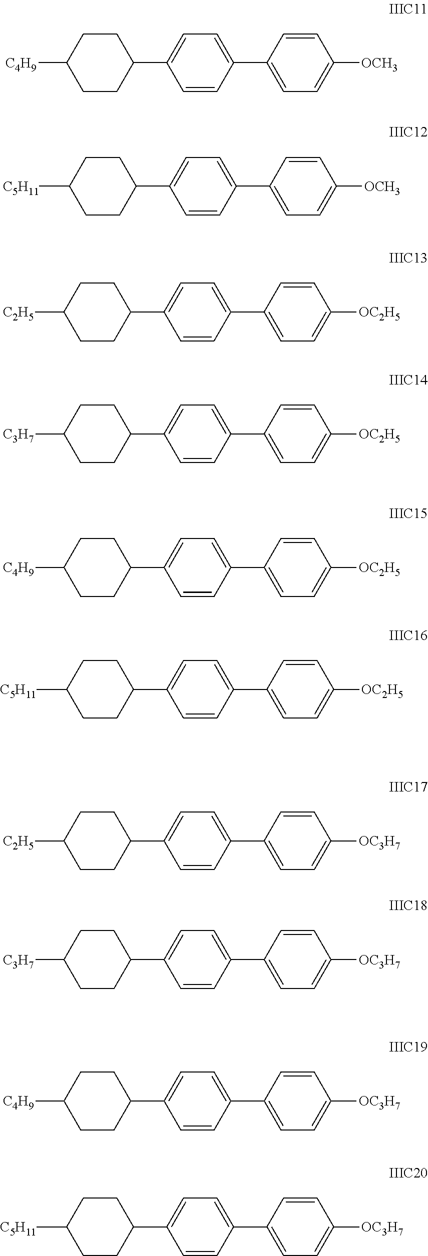

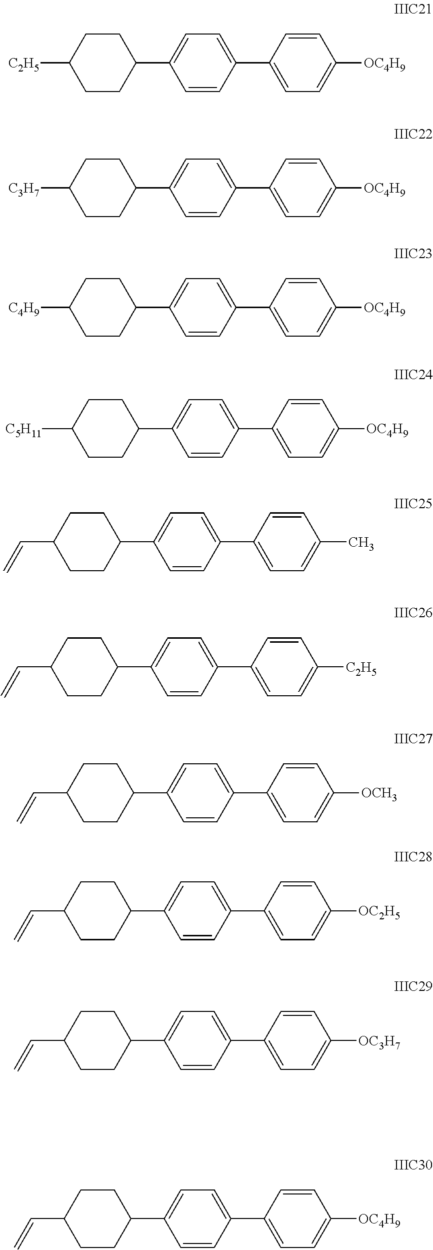

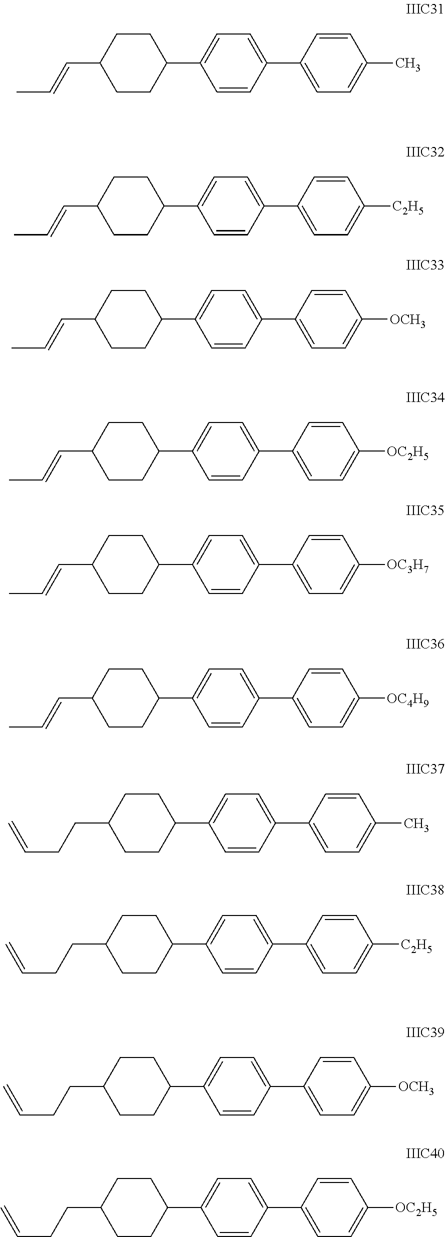

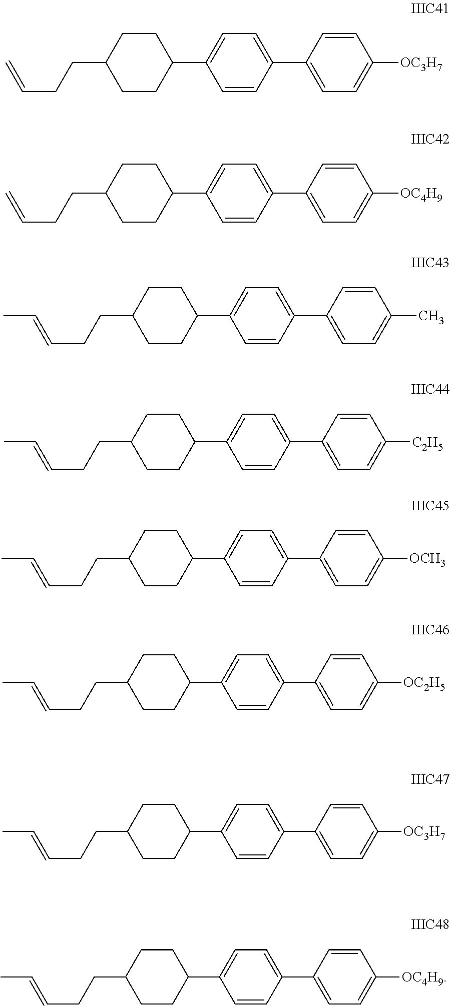

5. The liquid crystal composition according to claim 1, wherein the liquid crystal composition further comprises a compound represented by general formula IV: 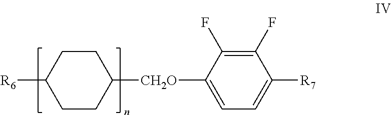
wherein in the general formula IV, R₆ and R₇ each independently represent an alkyl group having 1-7 carbon atoms, an alkoxy group having 1-7 carbon atoms, or an alkenyl group having 2-7 carbon atoms, and n represents 1 or 2; and
preferably, the compound represented by general formula IV is selected from one or more of the compounds represented by IVA1-IVA12, IVB1-IVB12, IVC1-IVC12, and IVD1-IVD12:

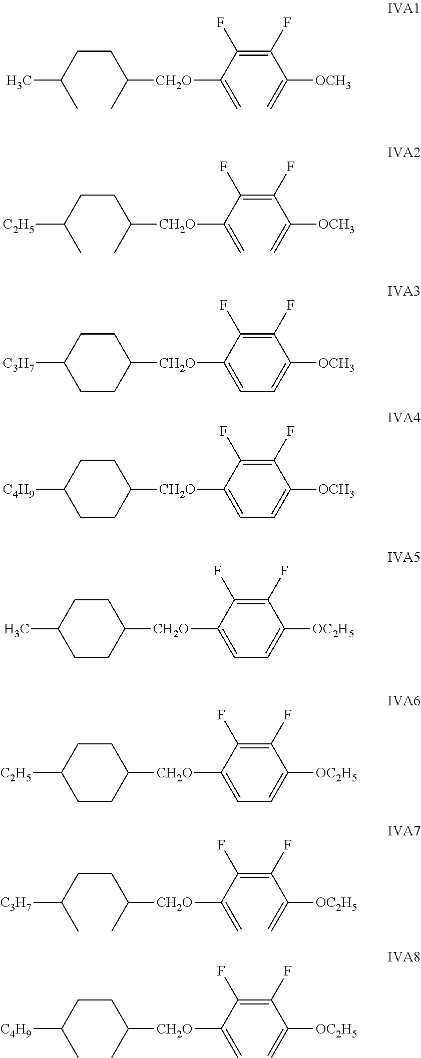

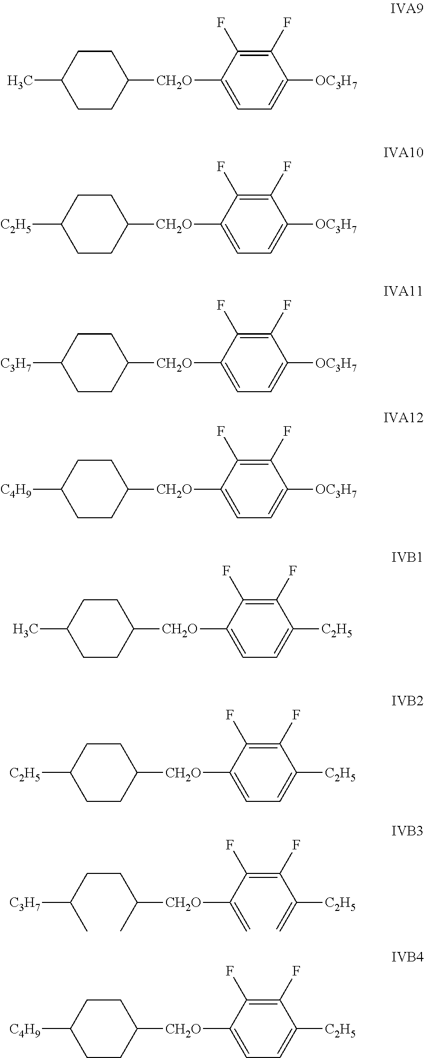

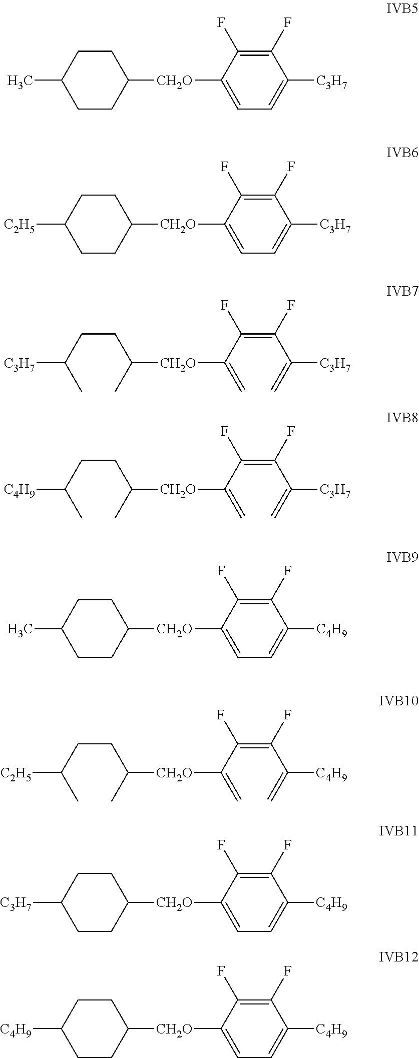

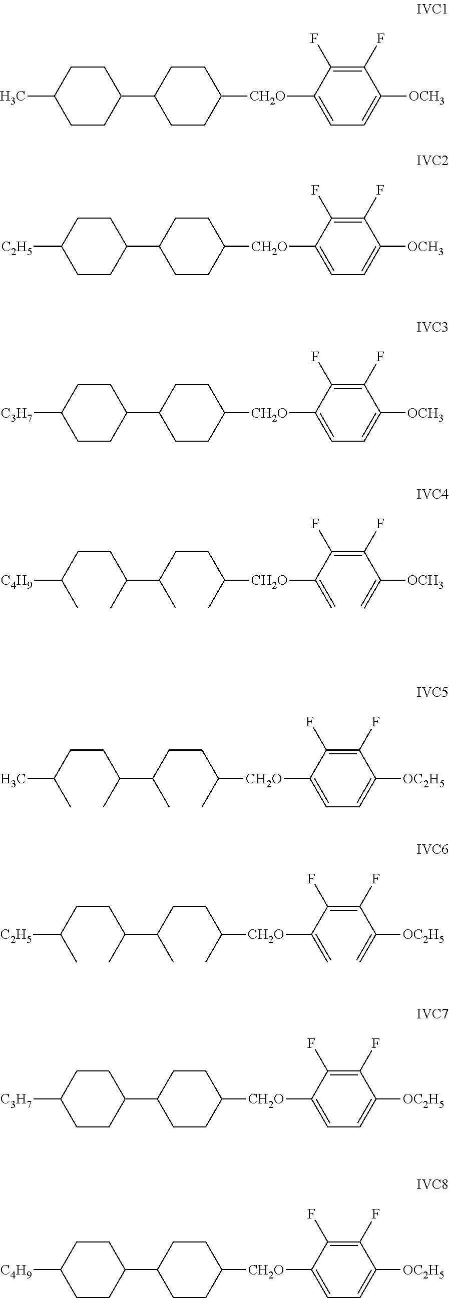

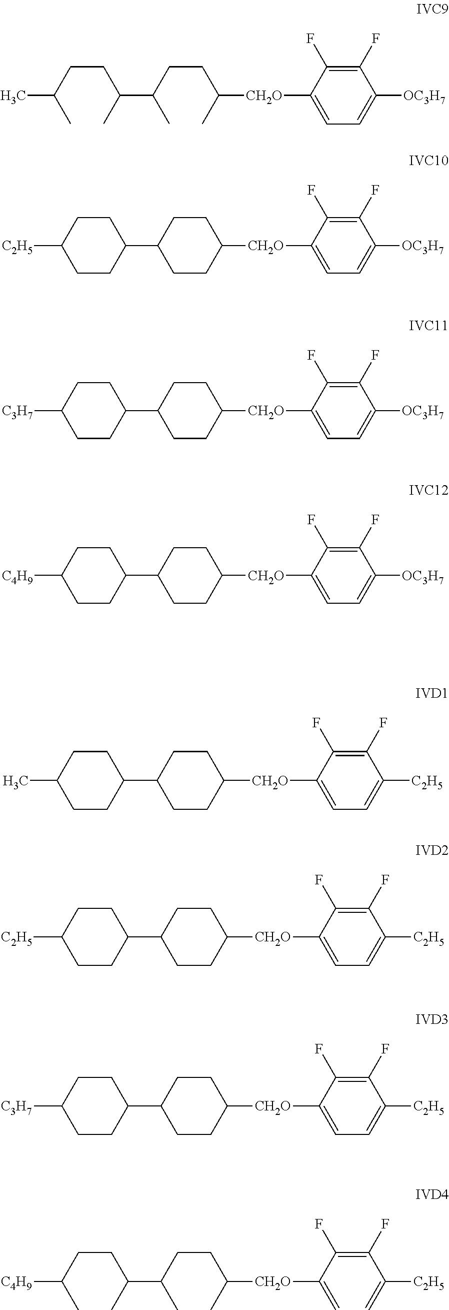

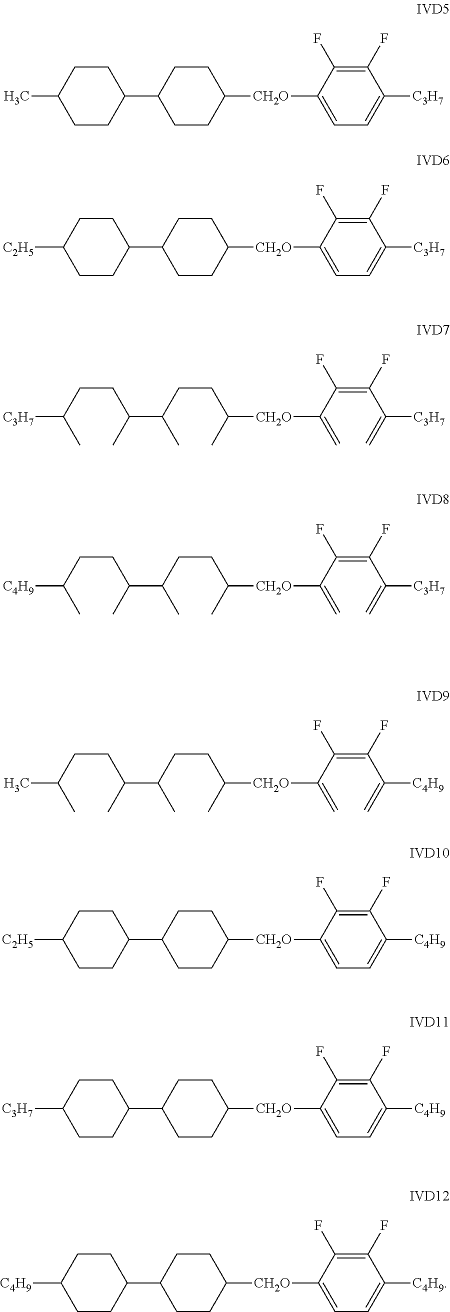

6. The liquid crystal composition according to claim 1, wherein the liquid crystal composition further comprises a compound represented by general formula V, and the compound represented by general formula V is selected from one or more of the compounds represented by formulas VA1-VA48, VB1-VB48, VC1-VC48, VD1-VD48, VE1-VE48, and VF1-VF8:

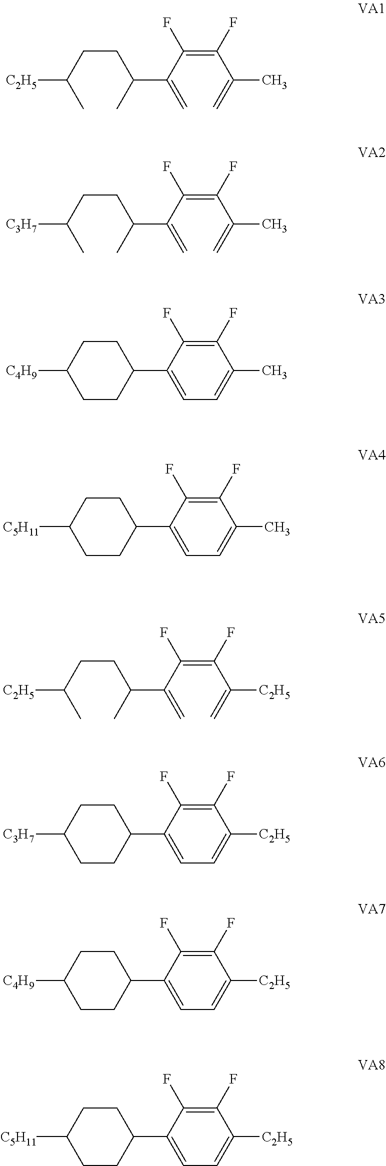

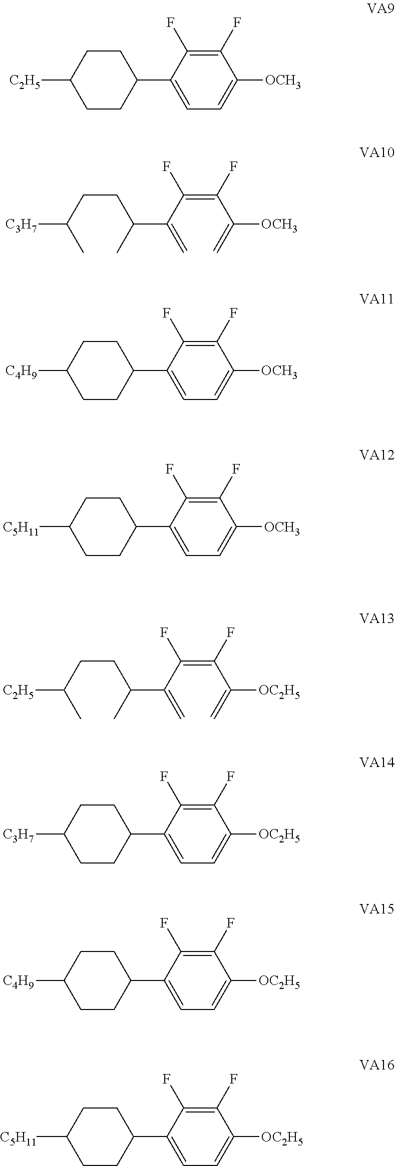

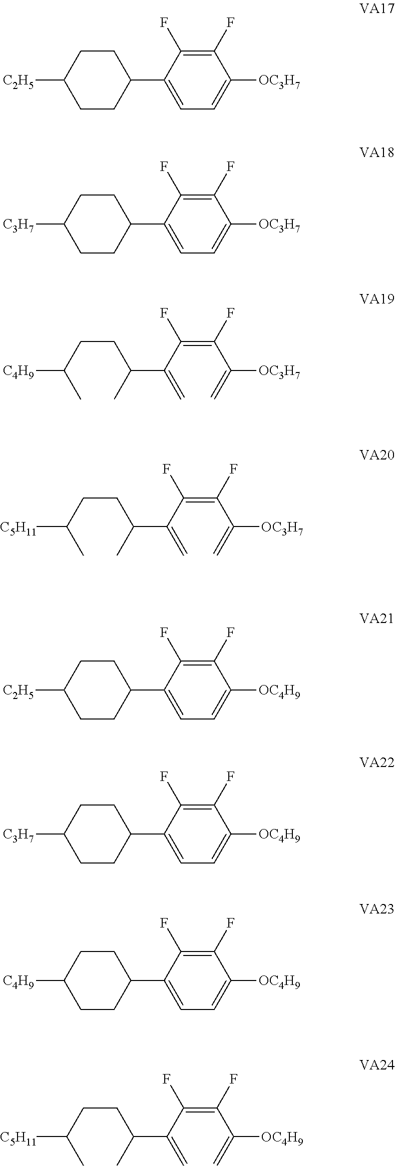

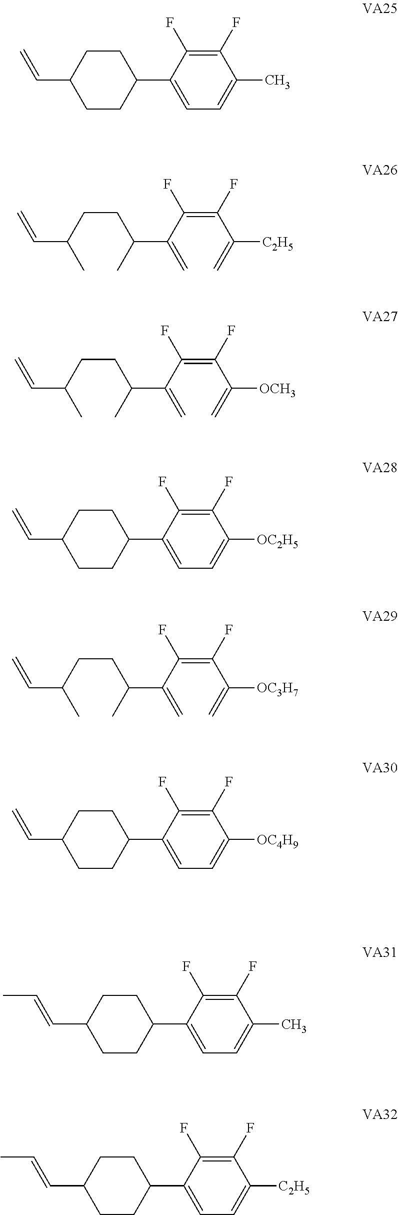

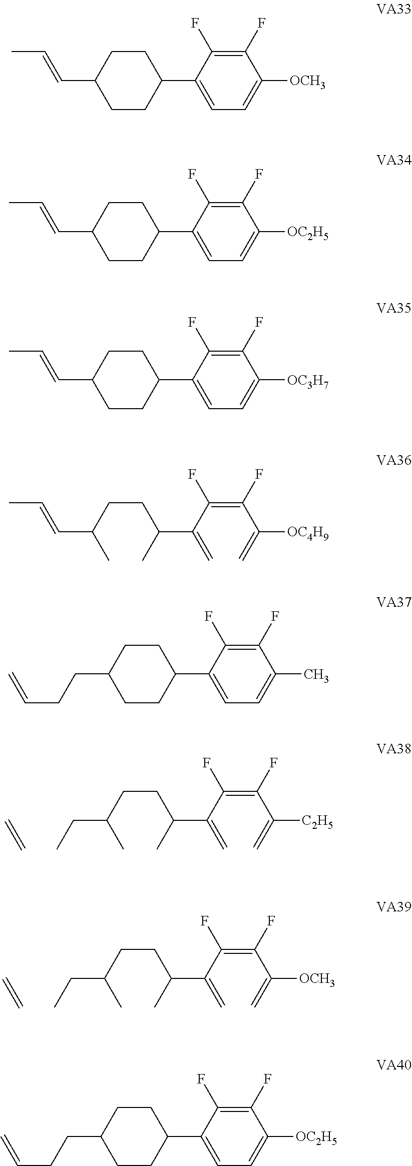

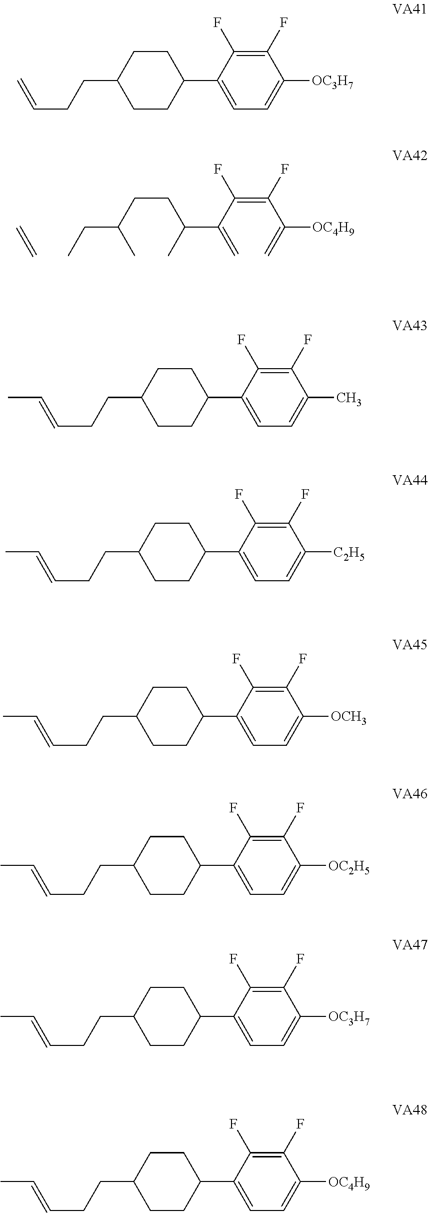

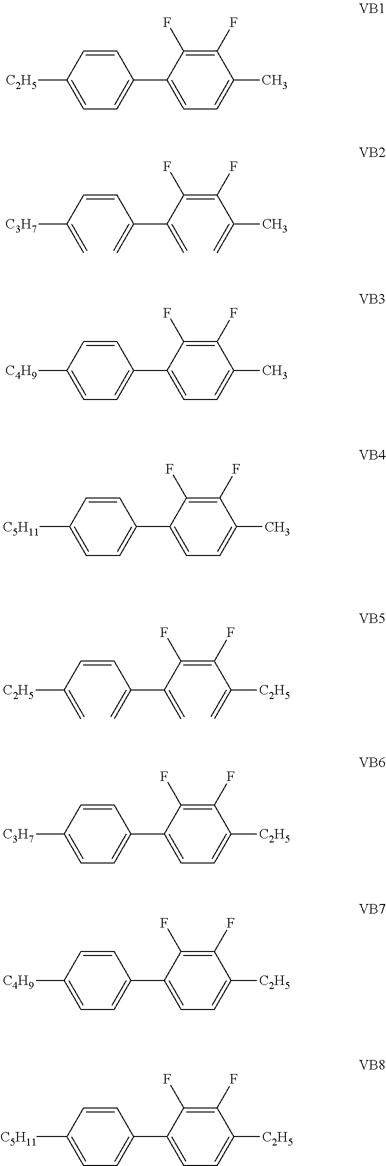

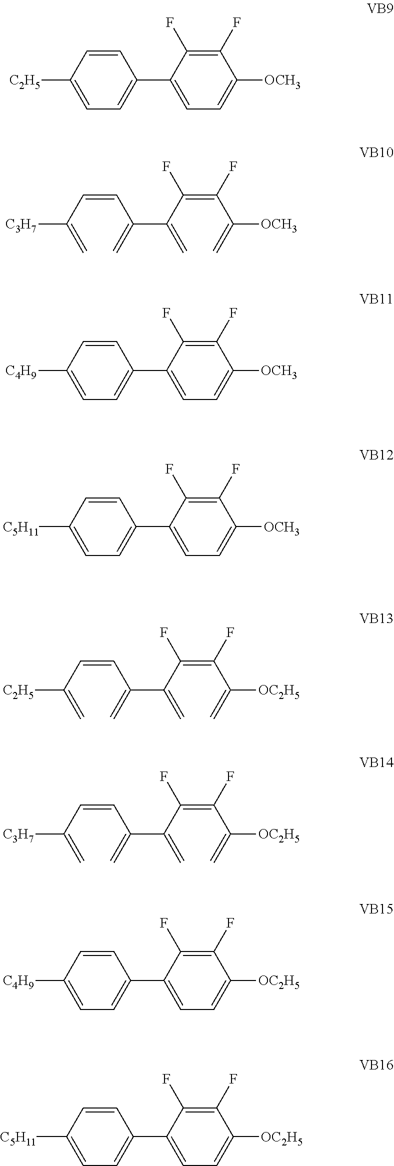

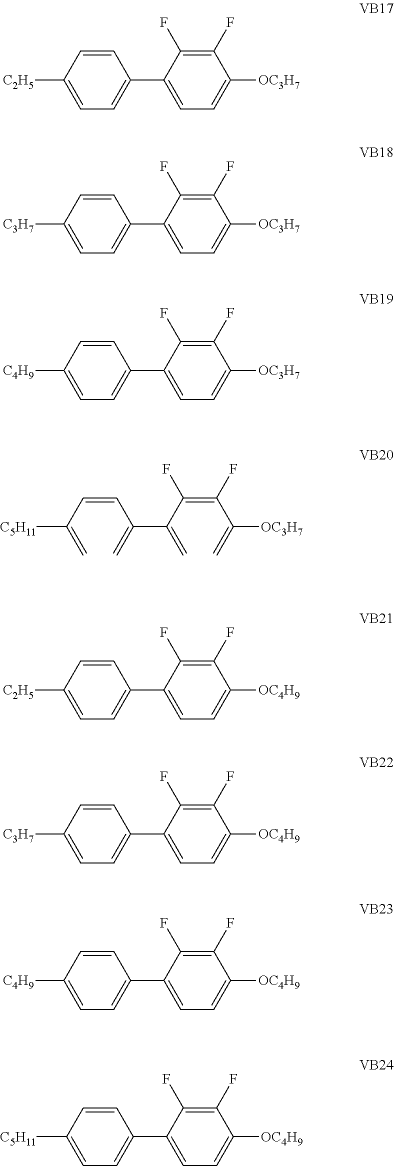

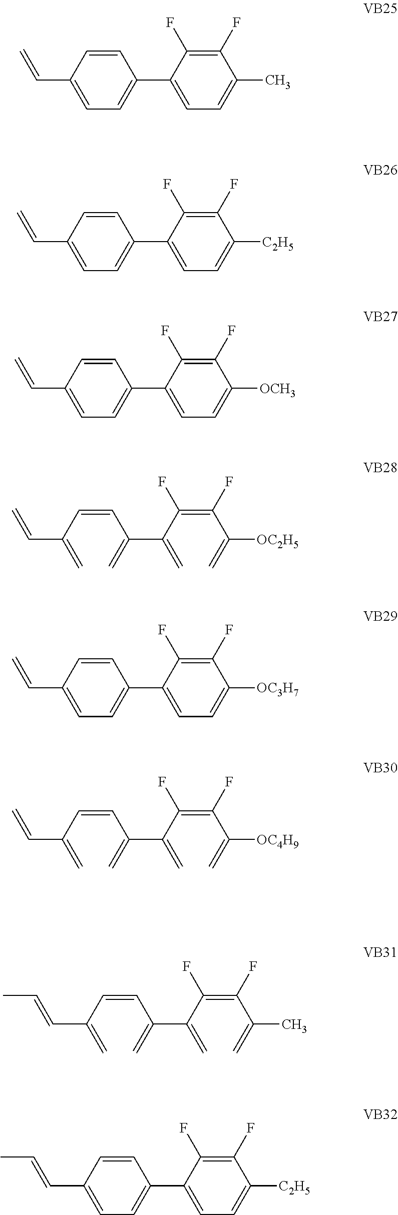

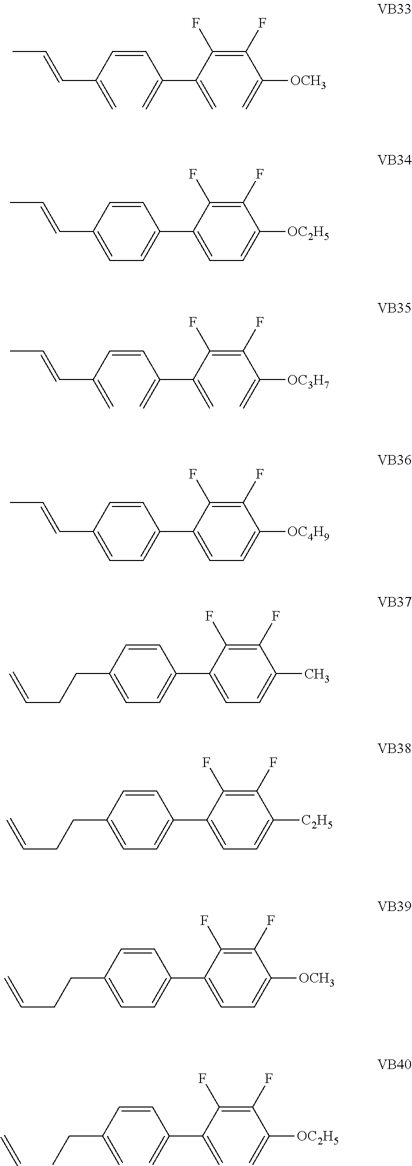

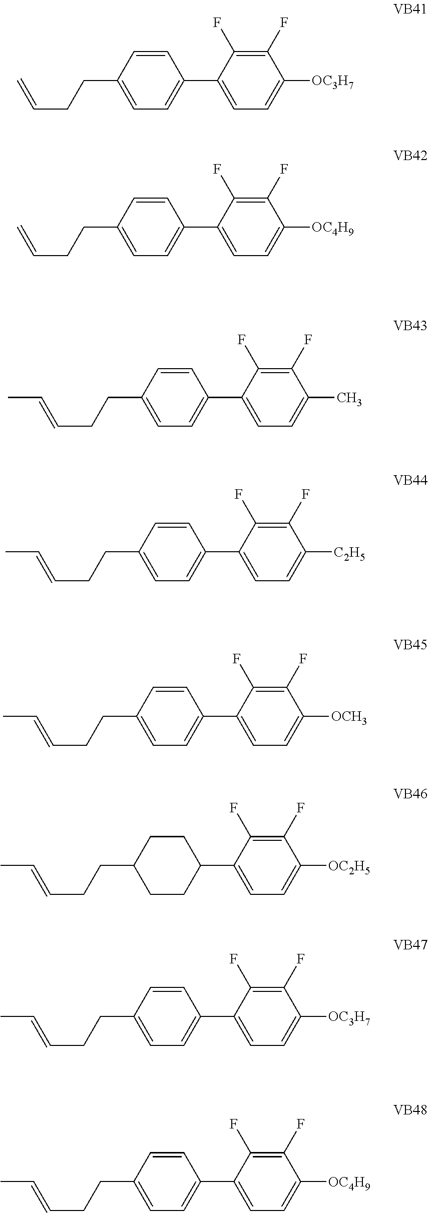

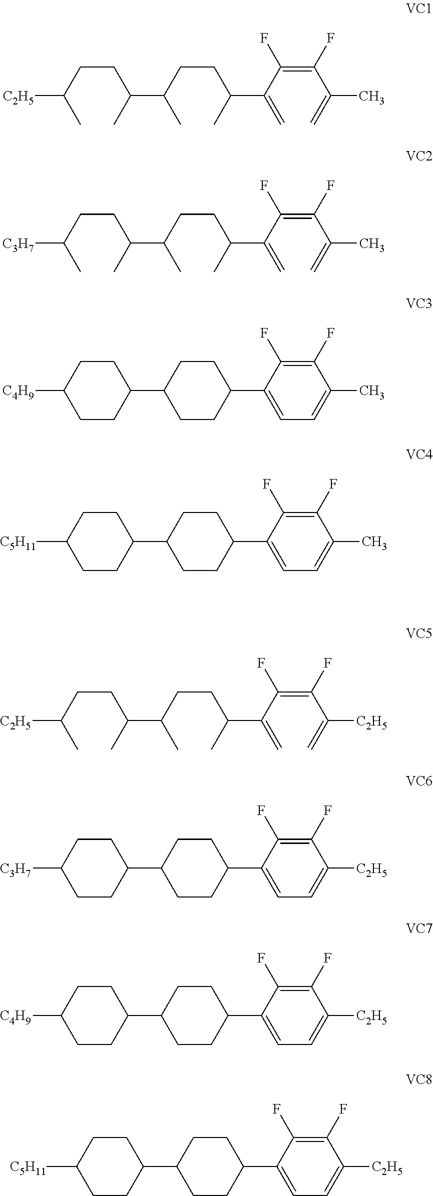

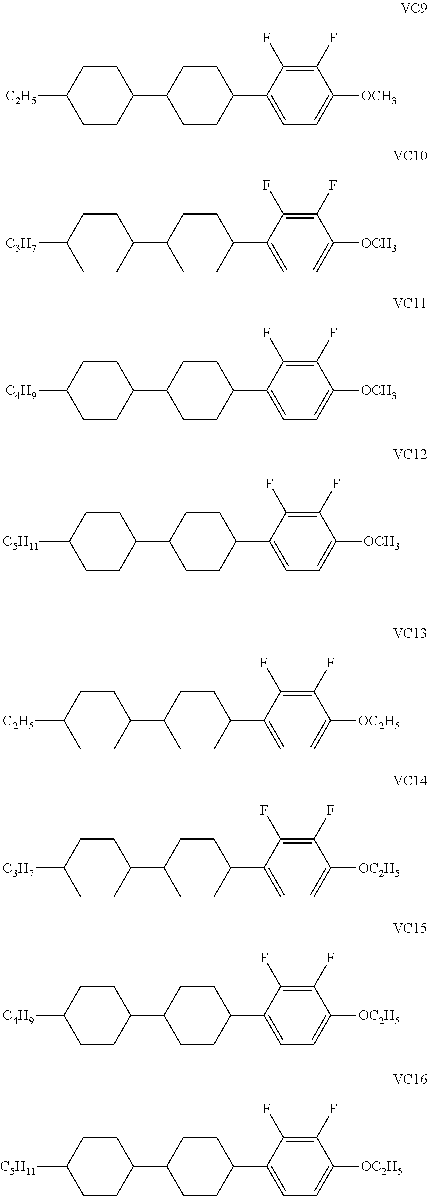

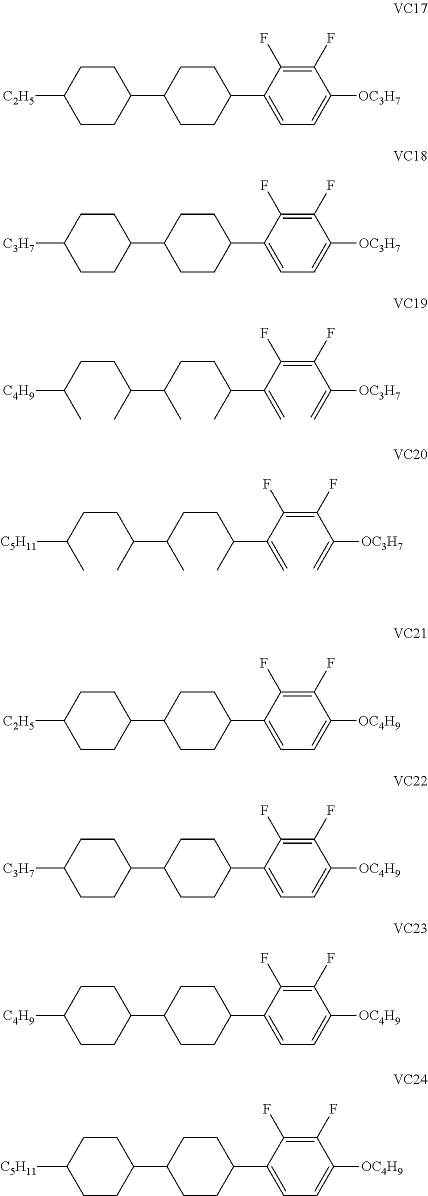

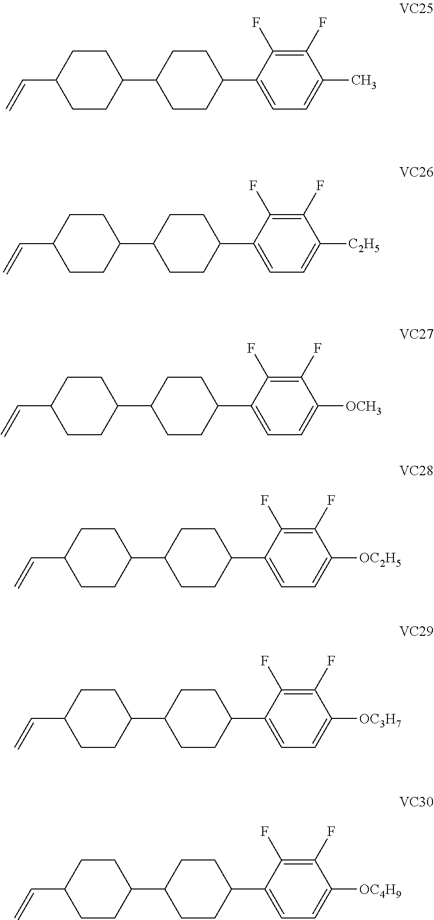

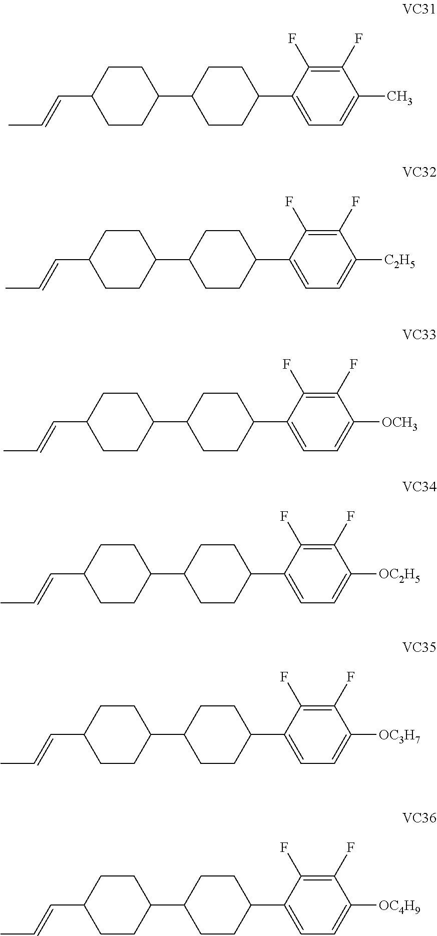

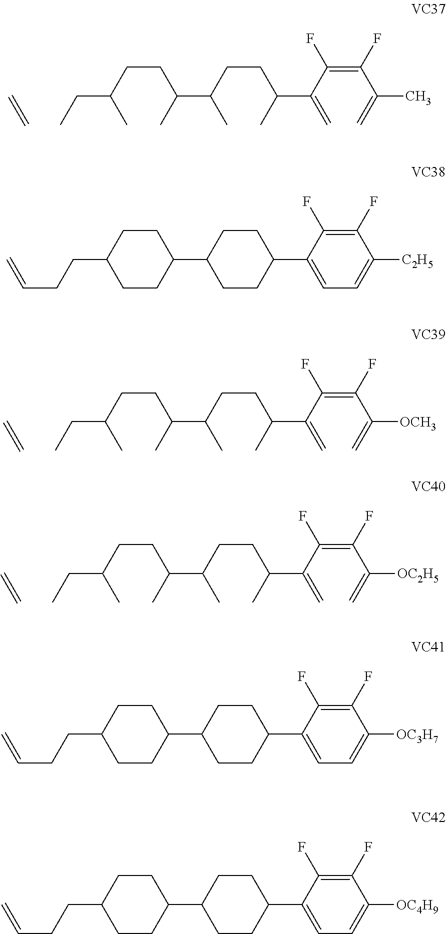

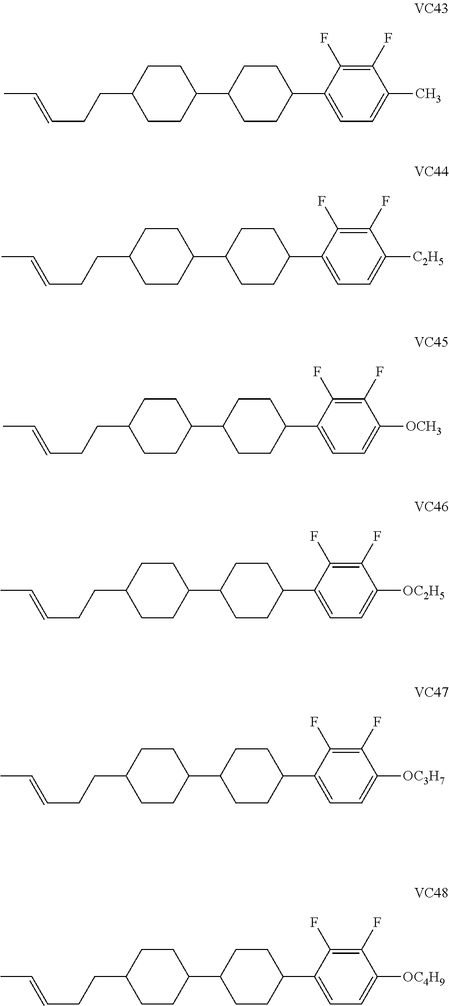

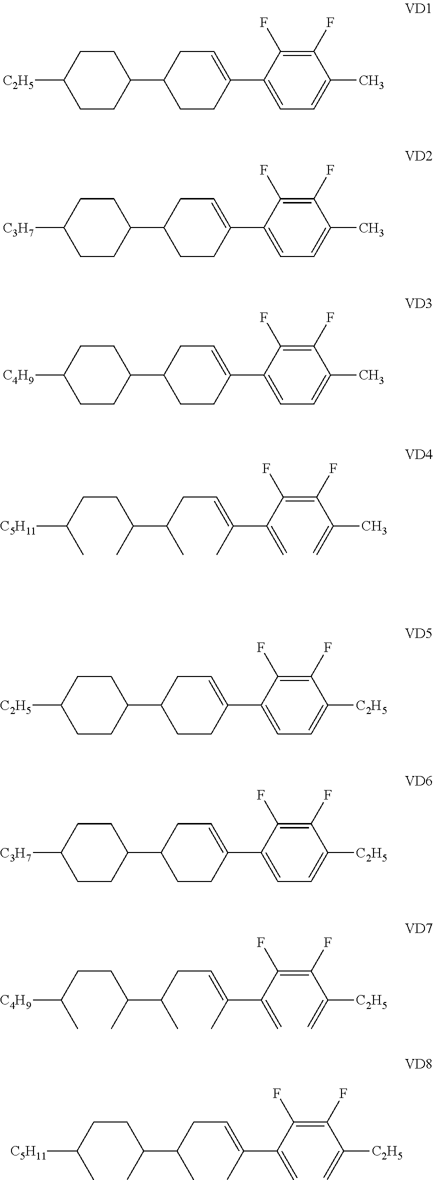

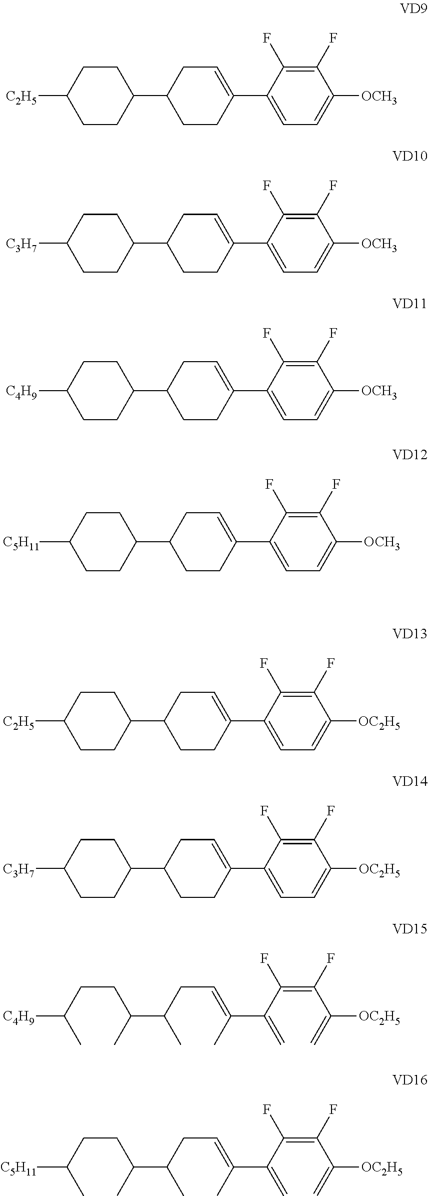

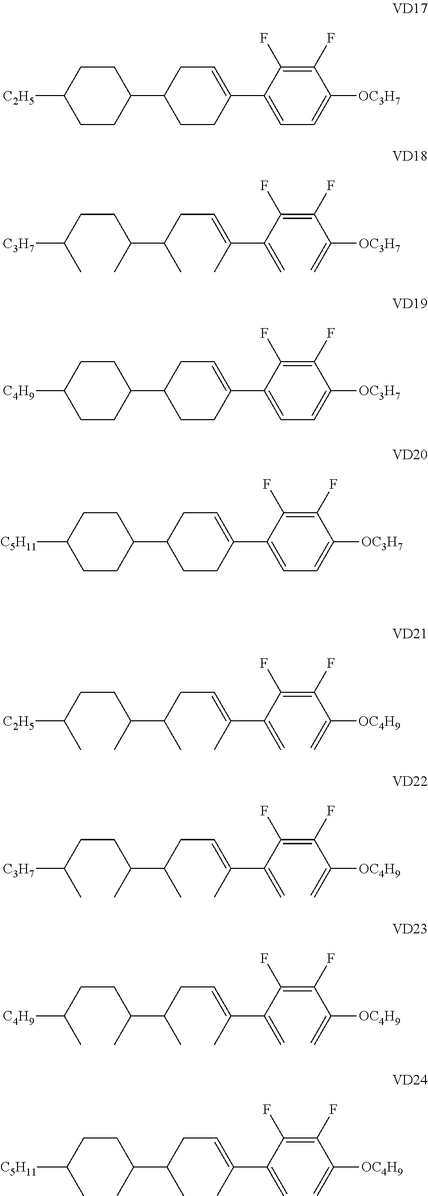

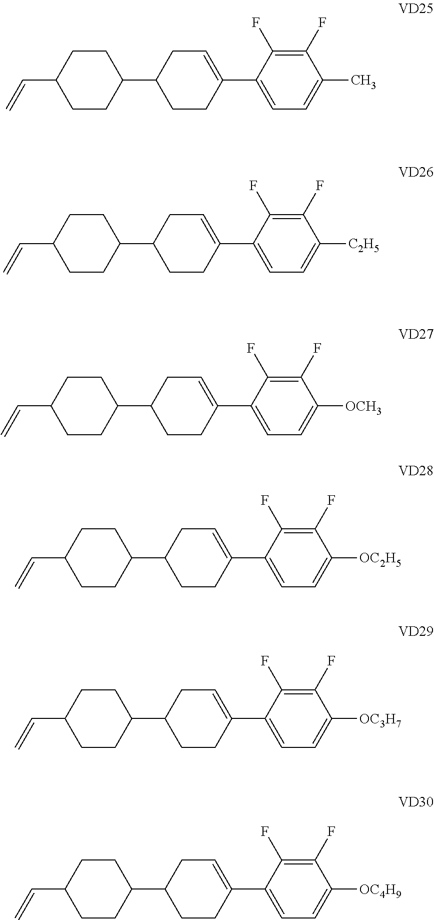

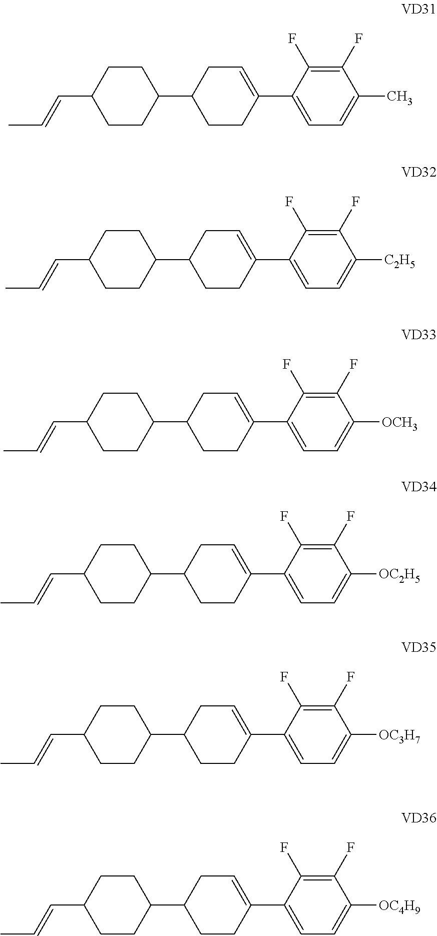

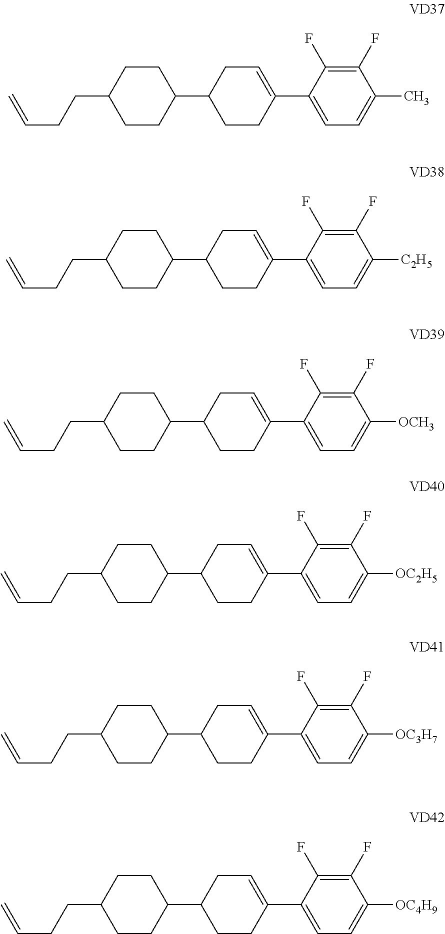

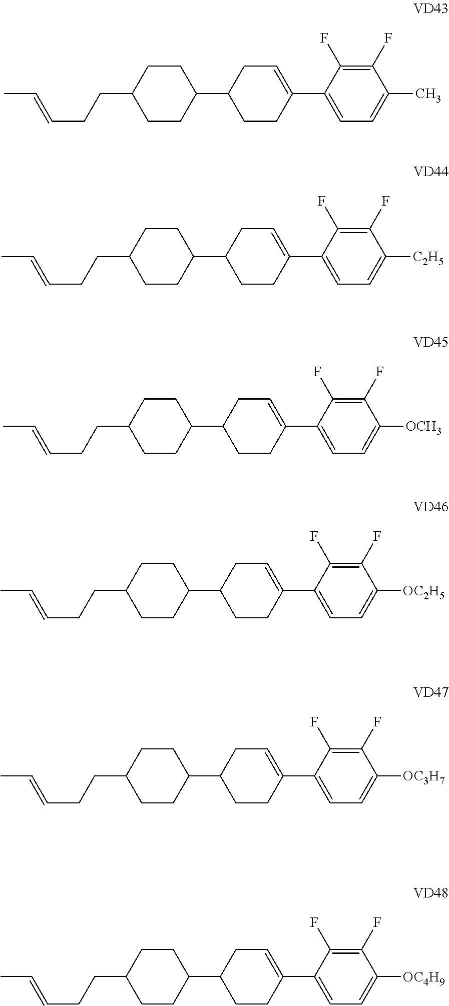

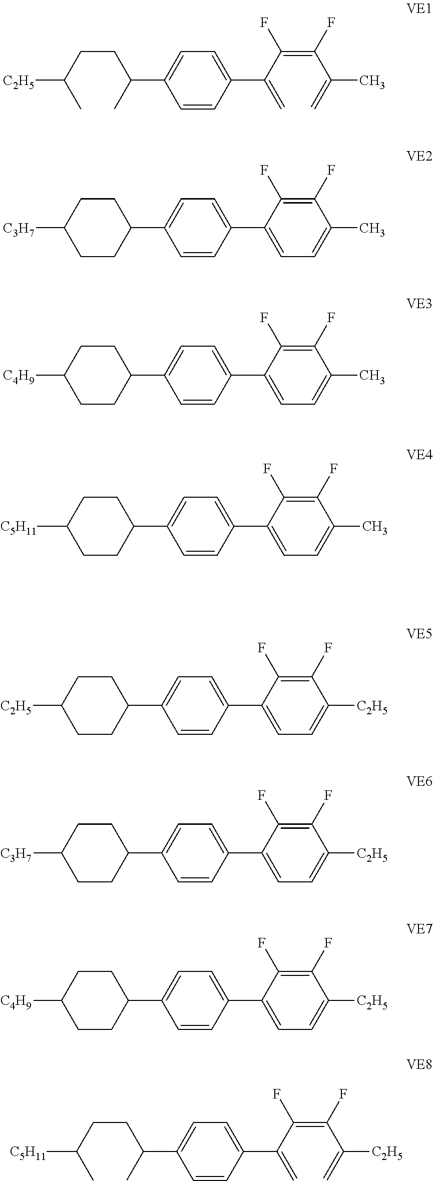

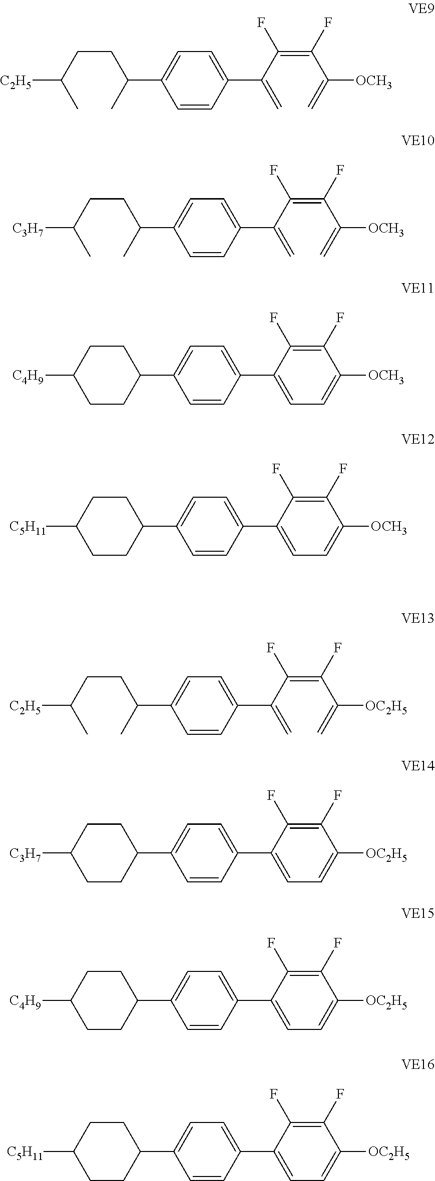

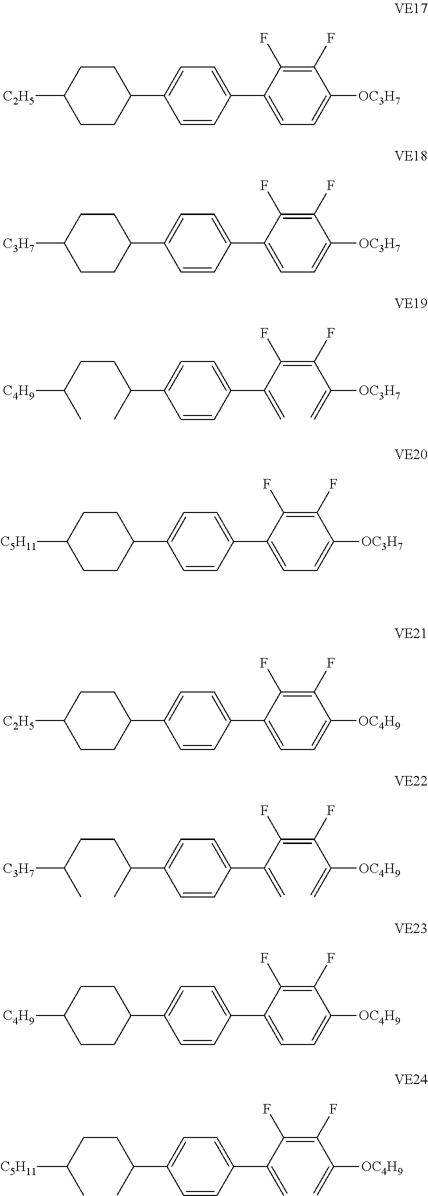

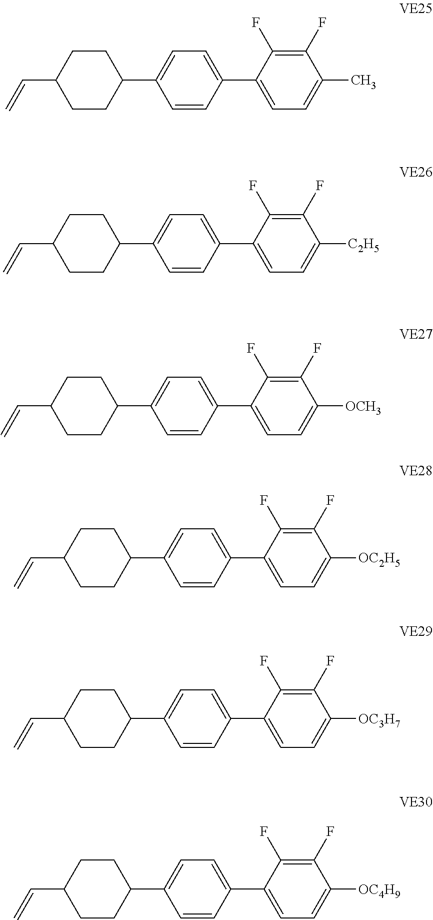

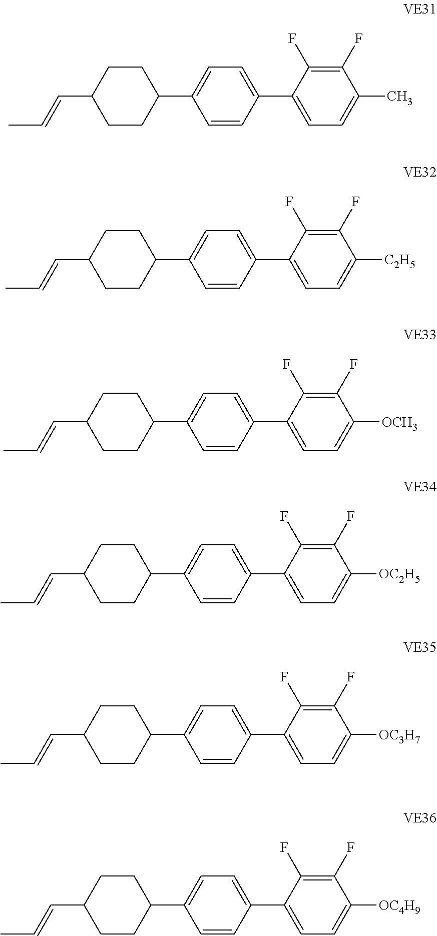

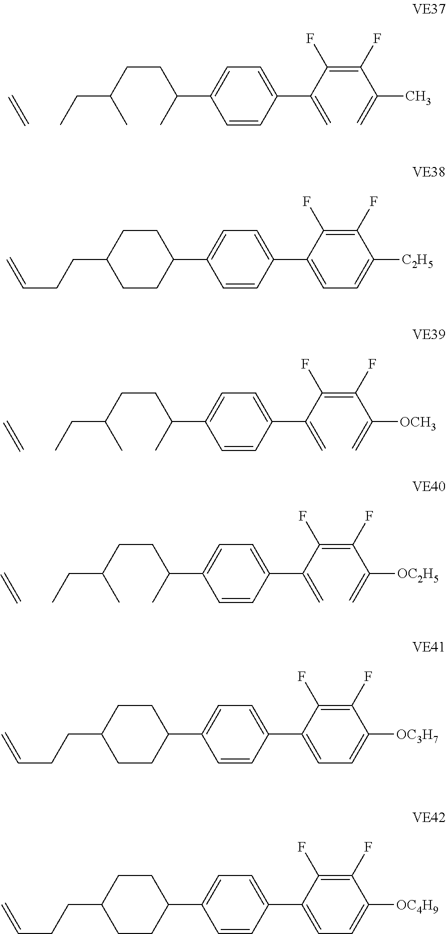

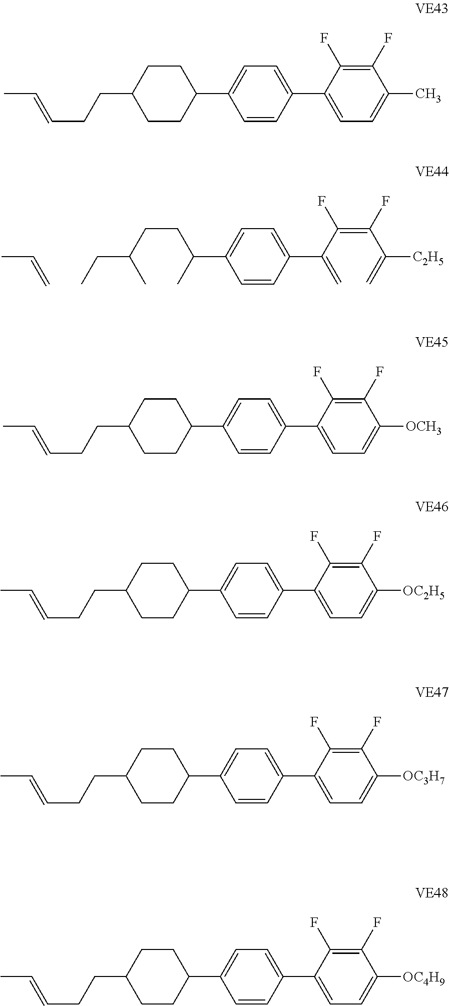

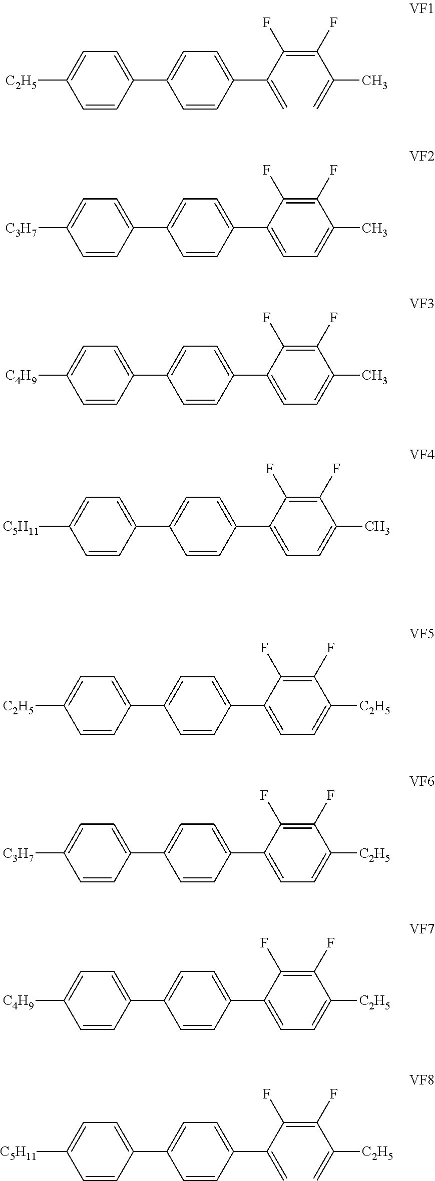

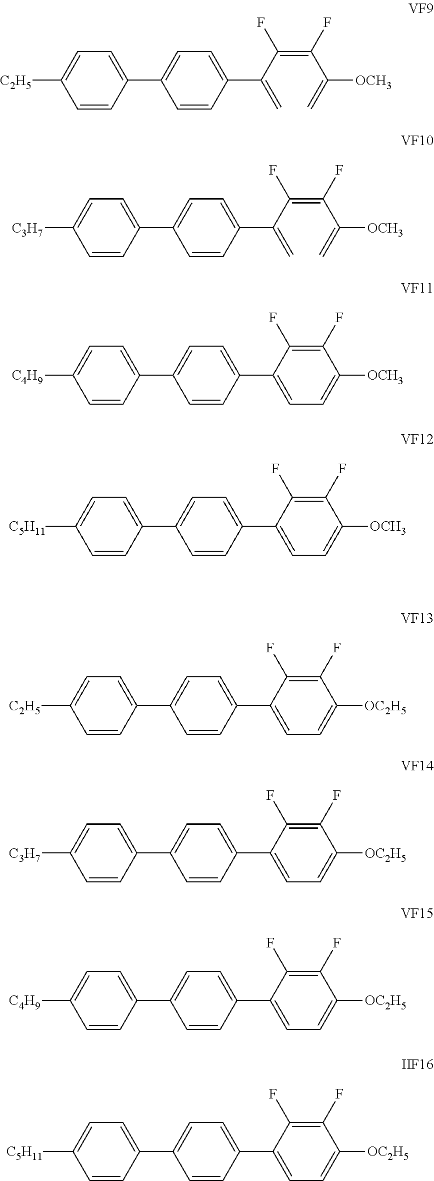

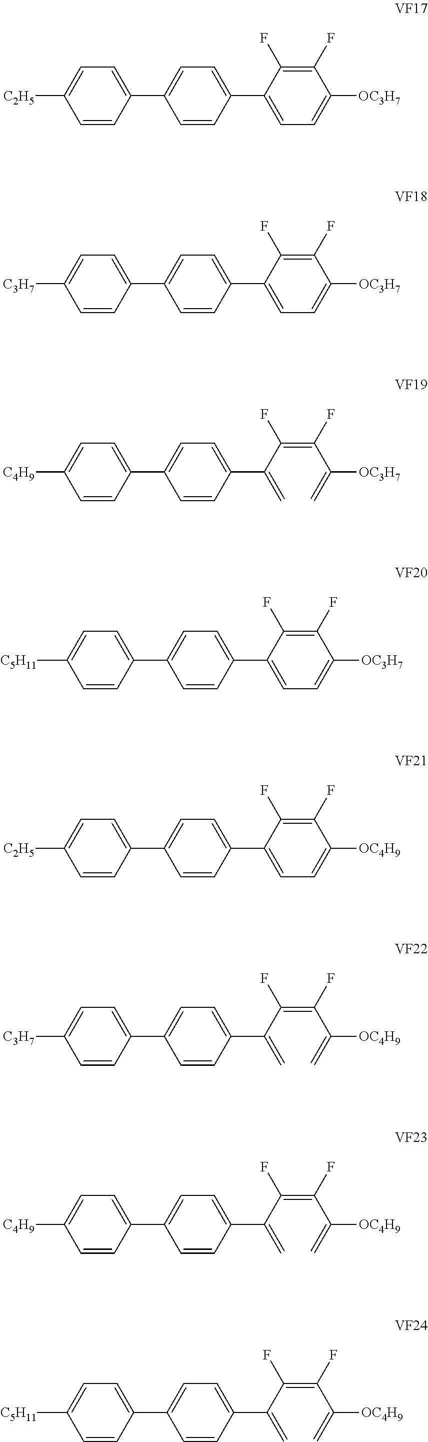

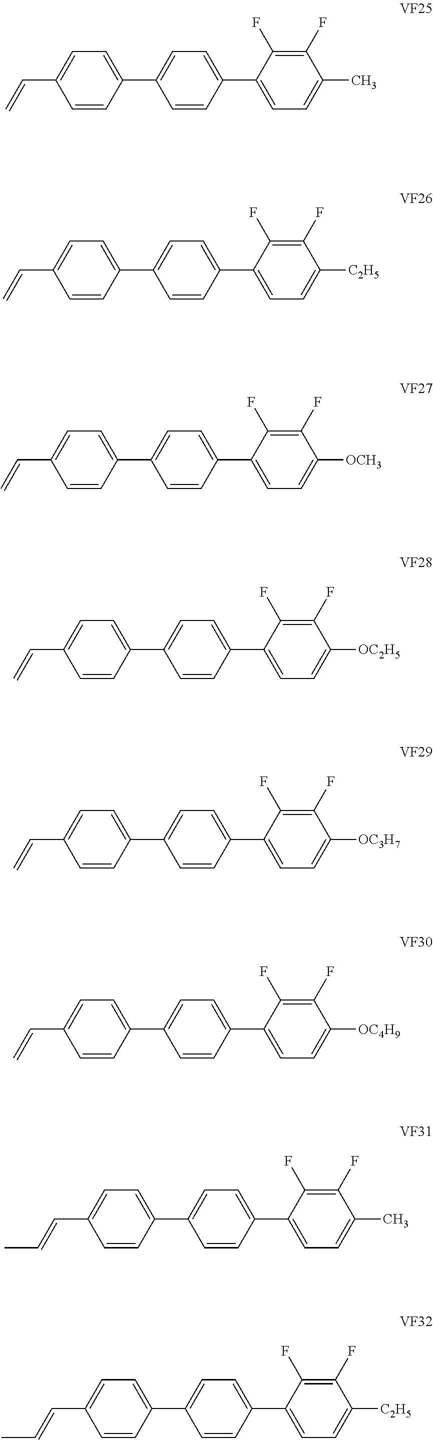

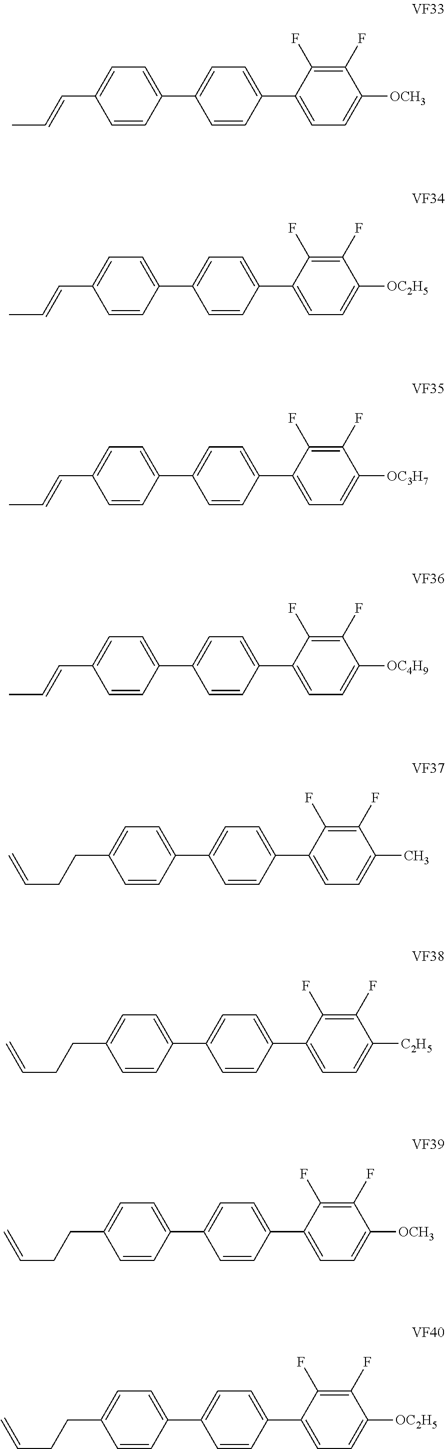

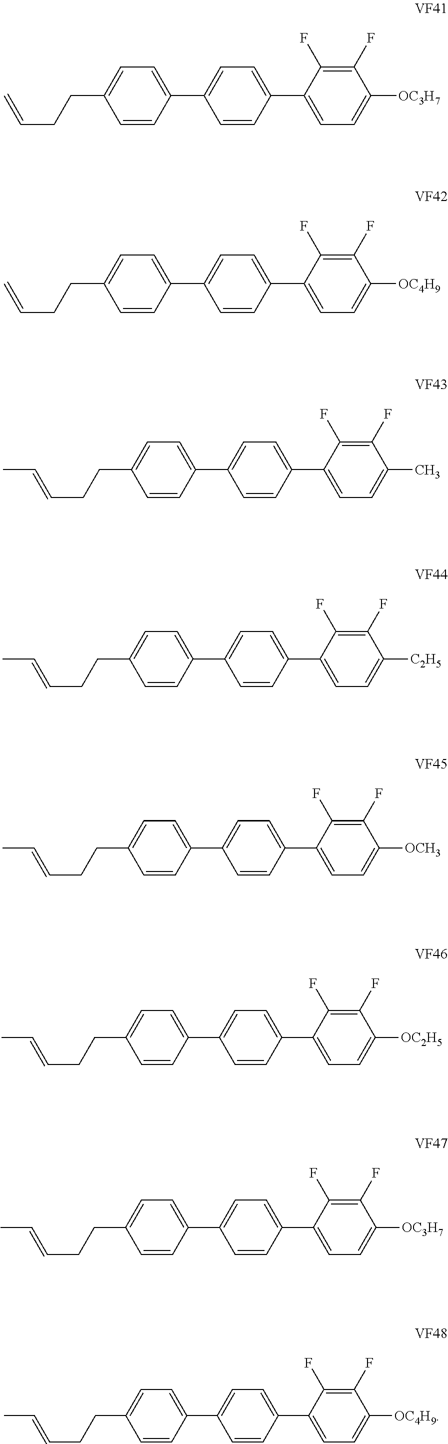

7. The liquid crystal composition according to claim 1, wherein the liquid crystal composition comprises the following components in percentage by mass:
(1) 1-30% of the compound represented by general formula I,
(2) 1-50% of the compound represented by general formula II,
(3) 1-30% of the compound represented by general formula III,
(4) 1-25% of the compound represented by general formula IV, and
(5) 1-50% of the compound represented by general formula V;
preferably, the liquid crystal composition comprises the following components in percentage by mass:
(1) 5-25% of the compound represented by general formula I,
(2) 5-50% of the compound represented by general formula II,
(3) 5-30% of the compound represented by general formula III,
(4) 5-25% of the compound represented by general formula IV, and
(5) 5-50% of the compound represented by general formula V;
further preferably, the liquid crystal composition comprises the following components in percentage by mass:
(1) 10-25% of the compound represented by general formula I,
(2) 20-50% of the compound represented by general formula II,
(3) 10-25% of the compound represented by general formula III,
(4) 5-20% of the compound represented by general formula IV, and
(5) 20-45% of the compound represented by general formula V; and
more preferably, the liquid crystal composition comprises the following components in percentage by mass:
(1) 10-20% of the compound represented by general formula I,
(2) 35-45% of the compound represented by general formula II,
(3) 10-20% of the compound represented by general formula III,
(4) 10-15% of the compound represented by general formula IV, and
(5) 20-35% of the compound represented by general formula V.

8. The liquid crystal composition according to claim 1, wherein the liquid crystal composition further comprises a compound represented by general formula VI: 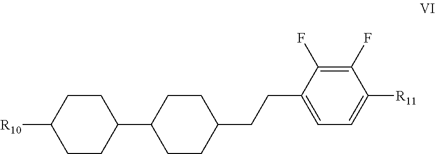
wherein in the general formula VI, R₁₀ and Ru each independently represent an alkyl group having 1-7 carbon atoms, an alkoxy group having 1-7 carbon atoms, or an alkenyl group having 2-7 carbon atoms; and
preferably, the compound represented by general formula VI is selected from one or more of the compounds represented by VIA1-VIA20, VIB1-VIB18, and VIC1-VIC14:

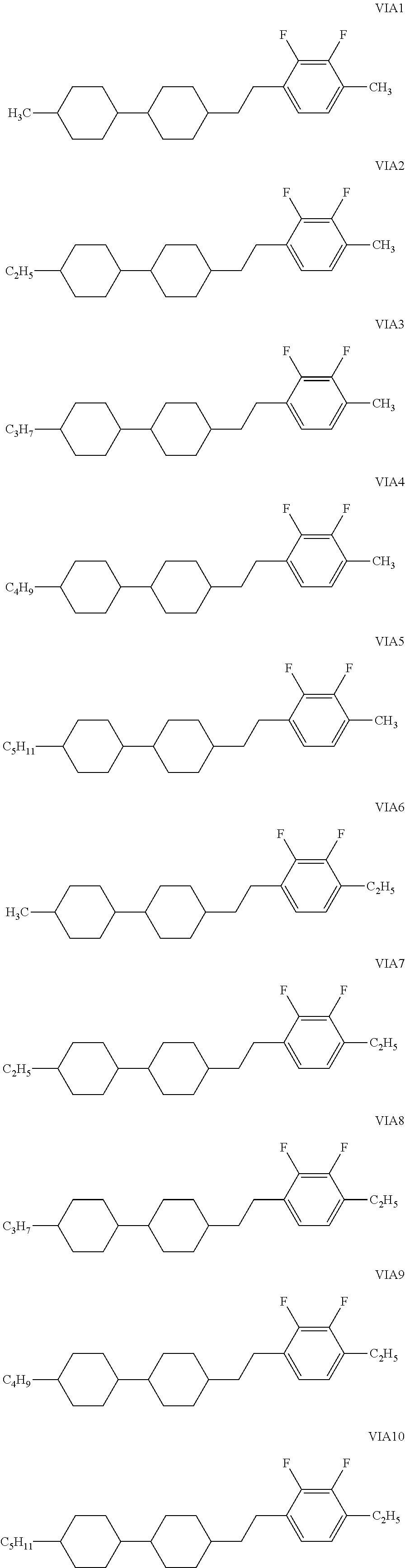

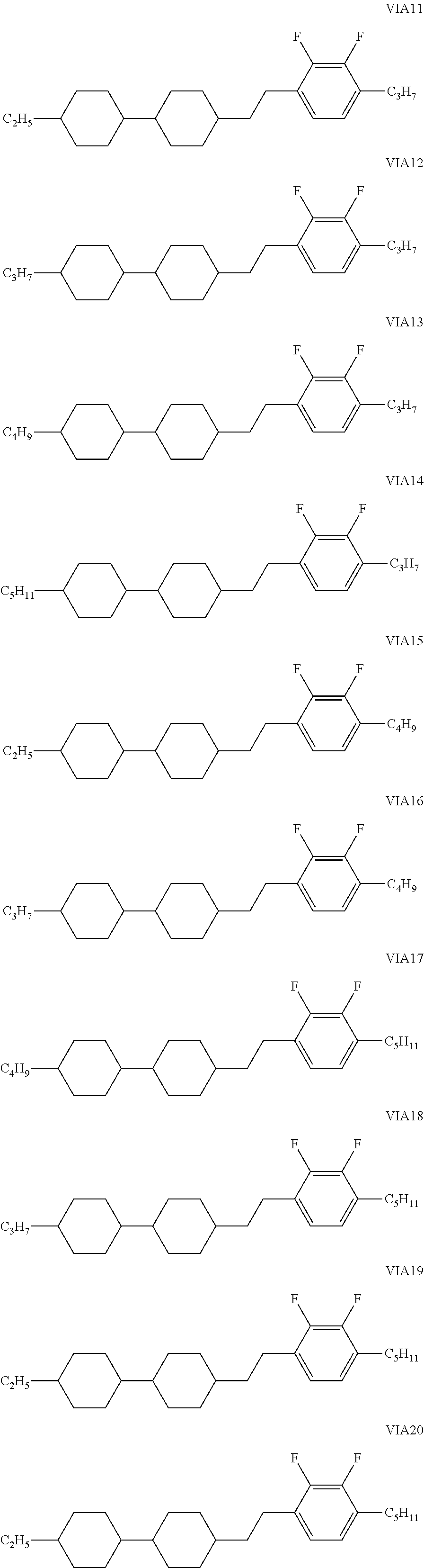

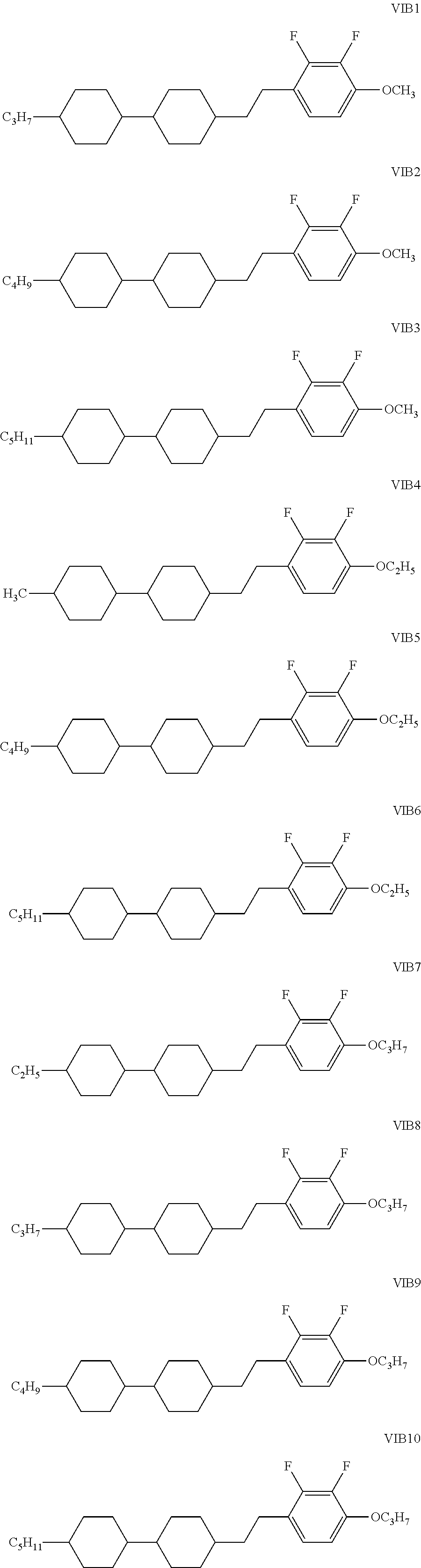

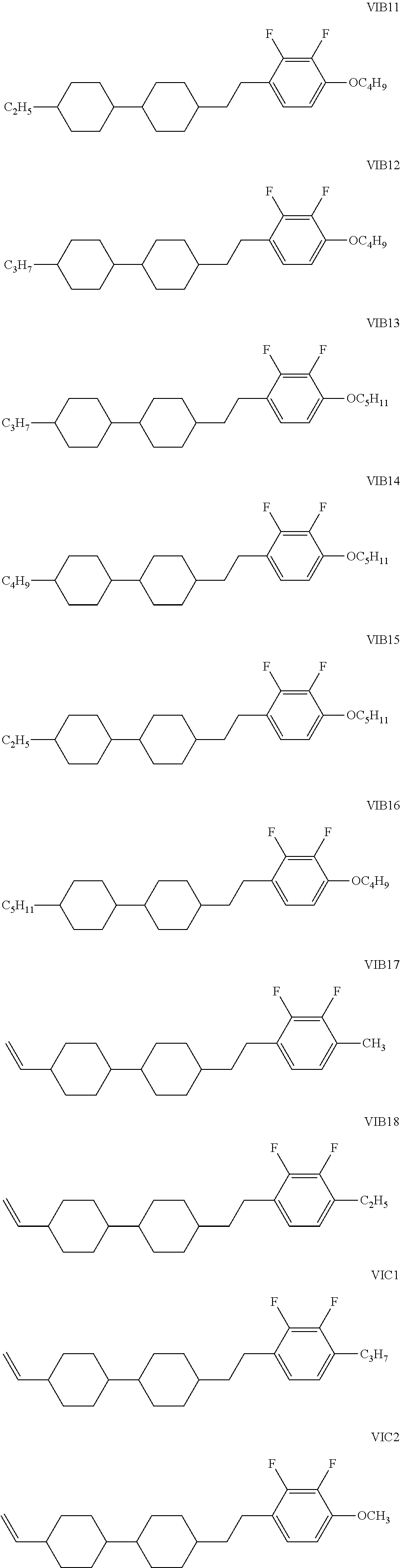

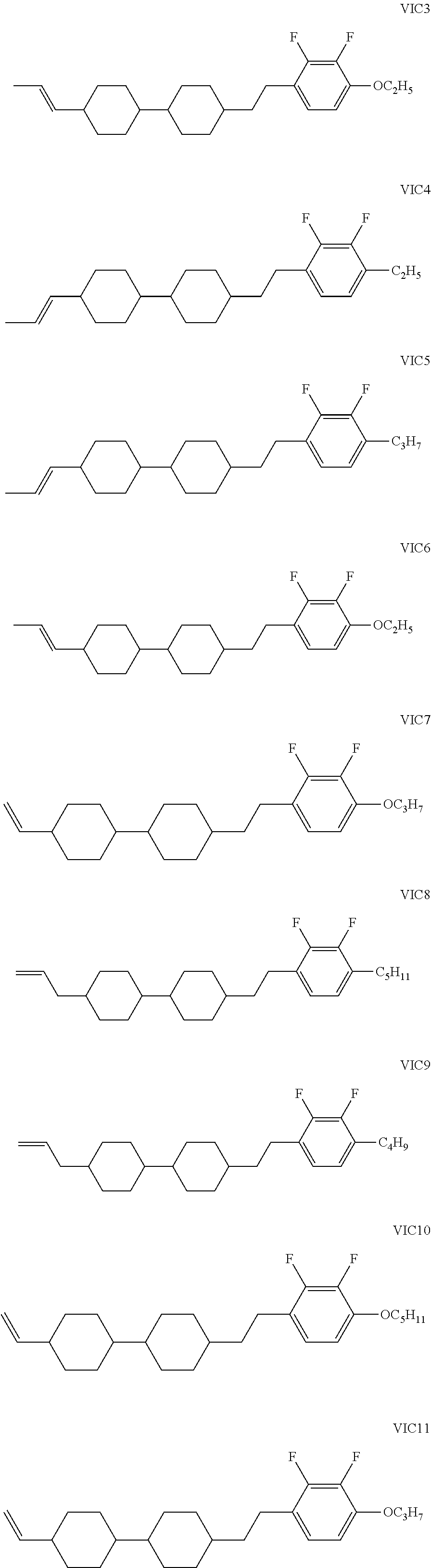

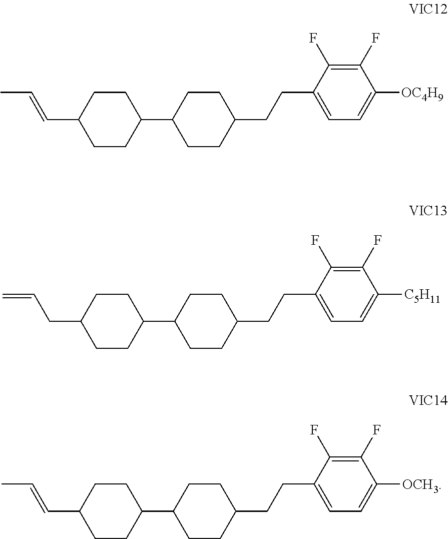

9. The liquid crystal composition according to claim 8, wherein based on the total mass percentage of all components in the liquid crystal composition being 100%, the mass content of the compound of general formula VI in the composition is 0-30%; preferably 5-25%; further preferably 10-25%; and more preferably 15-25%.

10. Use of the liquid crystal composition according to claim 1 in liquid crystal display devices, preferably in VA, IPS or FFS mode displays.
